(19) United States
(12) Patent Application Publication
(10) Pub. No.: US 2026/0270571 A1
(43) Pub. Date: Sep. 10, 2026

(54) VISION SENSOR CHIP

(71) Applicant: TSINGHUA UNIVERSITY, Beijing (CN)

(72) Inventors: Rong ZHAO, Beijing (CN); Yuguo CHEN, Beijing (CN); Taoyi WANG, Beijing (CN); Yihan LIN, Beijing (CN); Luping SHI, Beijing (CN)

(21) Appl. No.: 19/664,119

(22) Filed: Apr. 30, 2026

Related U.S. Application Data
(63) Continuation-in-part of application No. PCT/CN2024/117269, filed on Sep. 5, 2024.
(63) Continuation-in-part of application No. PCT/CN2024/117270, filed on Sep. 5, 2024.
(63) Continuation-in-part of application No. PCT/CN2024/116907, filed on Sep. 4, 2024.
(63) Continuation-in-part of application No. PCT/CN2024/116923, filed on Sep. 4, 2024.

(30) Foreign Application Priority Data
Oct. 30, 2023 (CN) 202311420669.1
Oct. 30, 2023 (CN) 202311420670.4
Oct. 30, 2023 (CN) 202311420671.9
Oct. 30, 2023 (CN) 202311420673.8

(51) Int. Cl. H04N 25/46; H04N 25/11; H04N 25/53; H04N 25/76; H04N 25/771; H04N 25/79

(52) U.S. Cl. CPC H04N 25/46; H04N 25/11; H04N 25/53; H04N 25/771; H04N 25/7795; H04N 25/79

(57) ABSTRACT

The present application provides a visual sensor chip. The visual sensor chip comprises a pixel array consisting of pixel units, among which each pixel unit has a corresponding time differential path and space differential path or has a corresponding intensity path, time differential path and space differential path. The present application fuses the dual-path feature of a human vision system into existing visual sensor chips, so that the capabilities of the visual sensor chips sensing spatio-temporal dynamic information can be greatly improved, allowing for high-precision, high-frame-rate, high-dynamic-range and high-efficiently robust visual representations.

### CROSS-REFERENCES TO RELATED APPLICATIONS

The present application is a Continuation in Part of International Patent Application No. PCT/CN2024/117269, filed on Sep. 5, 2024, which claims priority to and the benefit of Chinese Patent Application No. 202311420671.9, filed on Oct. 30, 2023, is a Continuation in Part of International Patent Application No. PCT/CN2024/117270, filed on Sep. 5, 2024, which claims priority to and the benefit of Chinese Patent Application No. 202311420673.8, filed on Oct. 30, 2023, is a Continuation in Part of International Patent Application No. PCT/CN2024/116907, filed on Sep. 4, 2024, which claims priority to and the benefit of Chinese Patent Application No. 202311420670.4, filed on Oct. 30, 2023, and is a Continuation in Part of International Patent Application No. PCT/CN2024/116923, filed on Sep. 4, 2024, which claims priority to and the benefit of Chinese Patent Application No. 202311420669.1, filed on Oct. 30, 2023, which are hereby incorporated by reference in their entireties herein.

### FIELD

The present application relates to the field of optoelectronic imaging, and in more particular, to vision sensor chips.

### BACKGROUND

A vision sensor is a device capable of perceiving visible light information within an environment and converting the visible light information into electrical signals and is widely applied in digital cameras and other electronic-optical devices.

The most common type of vision sensor is a frame-based complementary metal-oxide-semiconductor (CMOS) image sensor (CIS). The CIS integrates transistors within each pixel to enable high-performance charge-to-voltage conversion and is also referred to as an active pixel sensor (APS). The CIS captures video through a frame-based sampling principle, that is, outputs of all pixels within a pixel array are recorded in every frame of image of the CIS, and each frame is captured at equal time intervals. Furthermore, the CIS perceives visible light of different wavelengths through covering the pixel array with a color filter array (CFA), generating color images. It can be said that the CIS offers distinct advantages, including high pixel array resolution, high degree of color reproduction, and superior image quality. However, the CIS suffers from the drawback of slow capture speeds. This limitation originates from the fact that a CIS retains all pixel information within every single frame, resulting in an excessive volume of data that makes it difficult to increase capture speeds at a limited bandwidth. To overcome this drawback, the dynamic vision sensor (DVS) was developed. Unlike CIS pixels recording intensity values of incident light, each pixel in the DVS records a change in intensity values of the incident light at its specific location and outputs a positive or negative pulse (indicating a decrease or increase in light intensity, respectively) only in case that the change exceeds a certain threshold. The DVS is capable of asynchronously outputting signals; that is, immediately outputs a signal, even while other pixels remain inactive as soon as a specific pixel satisfies the conditions for emitting a pulse. This mechanism significantly reduces data volume, minimizes data redundancy, and enables extremely high temporal resolution. Moreover, given its inherent characteristics of sensitivity to change and high-speed recording capabilities, the DVS is naturally well-suited for tasks such as motion detection. However, a standalone DVS merely perceives changes in light intensity and sacrifices a substantial amount of color information while boasting extremely low data redundancy. Furthermore, the pixel precision of the DVS is somewhat limited as it is capable of outputting only positive or negative pulses and cannot perceive degree of the change in light intensity. Additionally, due to the complexity of the circuitry involved, the physical area occupied by a single DVS pixel is significantly larger than that of a CIS pixel, making it difficult to achieve high spatial resolution.

Therefore, there is an urgent need for the present application to provide an improved visual sensor.

### BRIEF SUMMARY

To address the aforementioned problems, according to the present application, there is provided a vision sensor chip that bins dual-pathway characteristics of a human visual system into a traditional vision sensor chip to significantly enhances capability of the vision sensor chip to perceive temporal-spatial dynamic information and enable high-precision, high-frame-rate, high-dynamic-range, efficient and robust visual representation.

According to the present application, there is provided a vision sensor chip, including a pixel array composed of pixels;
for each pixel, the pixel is provided with a temporal difference pathway and a spatial difference pathway corresponding to each pixel;
the temporal difference pathway is configured to output a temporal difference value of the pixel;
the spatial difference pathway is configured to output a spatial difference value of the pixel;
the temporal difference value is a result obtained by performing difference and quantization operations on output values of a photoreceptive subunit within the pixel at a current time and at a previous time;
the spatial difference value is a result obtained by performing difference and quantization operations on an output value of the photoreceptive subunit at the current time and an output value of the target photoreceptive subunit at the current time; and
a pixel where the target photoreceptive subunit is located is any pixel among the pixel array other than the pixel.

According to the vision sensor chip of the present application, the temporal difference pathway includes the photoreceptive subunit, a differential storage subunit and a temporal differentiator and quantizer provided inside the pixel;
the spatial difference pathway includes the photoreceptive subunit, the differential storage subunit, and a spatial differentiator and quantizer;
where the temporal differentiator and quantizer is provided inside the pixel, or is provided outside the pixel and shared by the pixel and other pixels located in a same column;
the spatial differentiator and quantizer is provided inside the pixel, or is provided outside the pixel and shared by the pixel and other pixels located in a same column;
the photoreceptive subunit is configured to convert intensity of light incident at the pixel at the current time into an electrical signal and output the electrical signal;
the differential storage subunit is configured to write the output value of the photoreceptive subunit at the current time; where the differential storage subunit includes a first storage node and a second storage node, and is configured to write the output value of the photoreceptive subunit at the current time into the second storage node or the first storage node in case that the output value of the photoreceptive subunit at the previous time is stored in the first storage node or the second storage node;
the temporal differentiator and quantizer is configured to calculate and output the temporal difference value; and
the spatial differentiator and quantizer is configured to calculate and output the spatial difference value based on the output value of the target photoreceptive subunit at the current time.

According to the vision sensor chip of the present application, each pixel of the pixel array is provided with one trigger pulse generator; or
all pixels in the pixel array are collectively connected to one trigger pulse generator; or
the pixel array is partitioned into a plurality of sub-regions and all pixels in each sub-region are collectively connected to one trigger pulse generator;
where the trigger pulse generator is configured to generate a trigger signal at a fixed time interval, or at adaptive, programmable, and variable intervals to control a start exposure time and an exposure duration of a corresponding photoreceptive subunit.

According to the vision sensor chip of the present application, pixels connected to a same trigger pulse generator perform synchronous exposure, and pixels connected to different trigger pulse generators perform either synchronous or asynchronous exposure.

According to the vision sensor chip of the present application, an exposure mode for each pixel of a pixel array is a global shutter or a rolling shutter.

According to the present application, there is provided a vision sensor chip including the pixel array composed of pixels;
for each pixel, the pixel is provided with an intensity pathway, a temporal difference pathway and a spatial difference pathway corresponding to each pixel;
the intensity pathway is configured to output a quantized value of an output value of a photoreceptive subunit inside the pixel at a current time;
the temporal difference pathway is configured to output a temporal difference value of the pixel;
the spatial difference pathway is configured to output a spatial difference value of the pixel;
the temporal difference value is a result obtained by performing difference and quantization operations on output values of a photoreceptive subunit within the pixel at a current time and at a previous time;
the spatial difference value is a result obtained by performing difference and quantization operations on an output value of the photoreceptive subunit at the current time and an output value of the target photoreceptive subunit at the current time; and
a pixel where the target photoreceptive subunit is located is any pixel among the pixel array other than the pixel.

According to the vision sensor chip of the present application, the intensity pathway includes the photoreceptive subunit, a first unit and an intensity quantizer provided inside the pixel, or includes the photoreceptive subunit, a differential storage subunit provided inside the pixel, a frequency-division strober, and an intensity quantizer provided inside the pixel;
the temporal difference pathway includes the photoreceptive subunit, the differential storage subunit, and a temporal differentiator and quantizer;
the spatial difference pathway includes the photoreceptive subunit, the differential storage subunit, and a spatial differentiator and quantizer;
where the temporal differentiator and quantizer is provided inside the pixel, or is provided outside the pixel and shared by the pixel and other pixels located in a same column;
the spatial differentiator and quantizer is provided inside the pixel, or is provided outside the pixel and shared by the pixel and other pixels located in a same column;
the intensity quantizer is provided inside the pixel, or is provided outside the pixel and shared by the pixel and other pixels located in a same column;
the photoreceptive subunit is configured to convert intensity of light incident at the pixel at the current time into an electrical signal and output the electrical signal;
the differential storage subunit is configured to write the output value of the photoreceptive subunit at the current time; where the differential storage subunit includes a first storage node and a second storage node, and is configured to write the output value of the photoreceptive subunit at the current time into the second storage node or the first storage node in case that the output value of the photoreceptive subunit at the previous time is stored in the first storage node or the second storage node;
the first unit is configured to send, in case that the photoreceptive subunit uses the rolling shutter, the output value of the photoreceptive subunit at the current time into an intensity quantizer; and buffer and output, in case that the photoreceptive subunit does not use the rolling shutter, the current output value of the photoreceptive subunit at the current time.
the frequency-division strober is configured to perform low-frequency sampling on the current output value of the photoreceptive subunit written by the differential storage subunit;
the intensity quantizer is configured to quantize and output an output value of the first unit;
the temporal differentiator and quantizer is configured to calculate and output the temporal difference value; and
the spatial differentiator and quantizer is configured to calculate and output the spatial difference value based on the output value of the target photoreceptive subunit at the current time.

According to the vision sensor chip of the present application, an output of the intensity pathway is a grayscale value or a color value;
in case that the output of the intensity pathway is the color value, an externally programmable demosaicer is embedded within the temporal differentiator and quantizer or the spatial differentiator and quantizer and is configured to determine output values of all color pathways of the pixel based on color values output from intensity pathways inside the pixel and surrounding pixels before the temporal difference value or the spatial difference value is calculated.

According to the vision sensor chip of the present application, each pixel of the pixel array is provided with a trigger pulse generator; or
all pixels in the pixel array are collectively connected to one trigger pulse generator; or
the pixel array is partitioned into a plurality of sub-regions and all pixels in each sub-region are collectively connected to one trigger pulse generator;
where the trigger pulse generator is configured to generate a trigger signal at a fixed time interval, or at adaptive, programmable, and variable intervals to control a start exposure time and an exposure duration of a corresponding photoreceptive subunit.

According to the vision sensor chip of the present application, pixels connected to a same trigger pulse generator perform synchronous exposure, and pixels connected to different trigger pulse generators perform either synchronous or asynchronous exposure.

According to the vision sensor chip of the present application, an exposure mode for each pixel of the pixel array is a global shutter or a rolling shutter.

According to the vision sensor chip of the present application, each pixel of the vision sensor chip includes a temporal difference pathway and a spatial difference pathway uniquely corresponding to each pixel, or includes a light intensity quantization pathway, a temporal difference pathway, and a spatial difference pathway uniquely corresponding to each pixel. In the present application, dual-pathway characteristics of a human visual system are binned into a traditional vision sensor chip to significantly enhances chip's capability to perceive temporal-spatial dynamic information and enable high-precision, high-frame-rate, high-dynamic-range, efficient and robust visual representation.

According to the present application, there is provided a vision sensor chip based on a hybrid array, including a pixel array and a vision sensing pathway corresponding to the pixel array; where the vision sensing pathway includes an intensity pathway, a temporal difference pathway, and a spatial difference pathway; and the pixel array includes a plurality of multiplexed pixels and a plurality of single pixels; the plurality of multiplexed pixels are pixels multiplexing two elements selected from intensity, temporal difference and spatial difference; the plurality of single pixels are pixels with an element different from the two elements of the multiplexed pixels; the intensity pathway is configured to determine a quantized value of an electrical signal converted from intensity of incident light at a position of a current pixel at a current time; the temporal difference pathway is configured to perform temporal difference and quantization operations in a charge domain, an analog domain, or a digital domain on a signal at the position of the current pixel at the current time and a signal at the position of the current pixel at a previous time to obtain a temporal difference value; the spatial difference pathway is configured to perform spatial difference and quantization operations in the charge domain, the analog domain, or the digital domain on the signal at the position of the current pixel at the current time and a signal at a position of a spatially associated pixel at the current time to obtain a spatial difference value, where the spatially associated pixel refers to any one or more pixels within the pixel array other than the current pixel.

According to the vision sensor chip based on the hybrid array of the present application, the plurality of multiplexed pixels are pixels multiplexing temporal difference and spatial difference, and the plurality of single pixels are intensity pixels; the intensity pathway corresponds to the intensity pixels, while the temporal difference pathway and the spatial difference pathway correspond to the pixels multiplexing temporal difference and spatial difference, respectively.

According to the vision sensor chip based on the hybrid array of the present application, an intensity pathway includes an intensity storage and an intensity quantizer; the intensity storage is configured to store an electrical signal converted from intensity of incident light at a position of a current pixel at a current time; the intensity quantizer is configured to perform an analog-to-digital conversion on the electrical signal converted from the intensity of incident light at the position of the current pixel at the current time to obtain the quantized value of the electrical signal converted from the intensity of incident light at the position of the current pixel at the current time; a temporal difference pathway includes a temporally differential storage and a temporal differentiator and quantizer; the temporally differential storage is configured to store electrical signals at the position of the current pixel at different times using a ping-pong buffering mode; the temporally differential storage includes a first temporally differential storage node and a second temporally differential storage node; the ping-pong buffering mode is configured to store the electrical signal at the position of the current pixel at the current time in the second temporally differential storage node or the first temporally differential storage node in case that an electrical signal at the position of the current pixel at a previous time is stored in the first temporally differential storage node or the second temporally differential storage node; the temporal differentiator and quantizer is configured to perform temporal difference and quantization operations on the electrical signal at the position of the current pixel at the current time and the electrical signal at the position of the current pixel at the previous time to obtain a temporal difference value; a spatial difference pathway includes a spatially differential storage node multiplexing the first temporally differential storage node and a spatial differentiator and quantizer; the spatially differential storage node is configured to store the electrical signal at the position of the current pixel at the current time; and the spatial differentiator and quantizer is configured to perform difference and quantization operations on the electrical signal at the position of the current pixel at the current time and an electrical signal at a spatially associated pixel position at the current time to obtain a spatial difference value.

According to the vision sensor chip based on the hybrid array of the present application, the intensity quantizer is provided inside the intensity pixel and uses a pixel-level signal readout mode; or the intensity quantizer is provided outside the intensity pixel and shared by another intensity pixel located in a same column and uses a column-level signal readout mode; the temporal differentiator and quantizer is provided inside a pixel multiplexing the temporal difference and the spatial difference and uses the pixel-level signal readout mode; or the temporal differentiator and quantizer is provided outside the pixel multiplexing the temporal difference and the spatial difference, and shared by a pixel multiplexing the temporal difference and the spatial difference located in a same column and uses the column-level signal readout mode; and the spatial differentiator and quantizer is provided inside a pixel multiplexing the temporal difference and the spatial difference and uses the pixel-level signal readout mode; or is provided outside a pixel multiplexing the temporal difference and the spatial difference, and shared by a pixel multiplexing the temporal difference and the spatial difference located in a same column and uses the column-level signal readout mode.

According to the vision sensor chip based on the hybrid array of the present application, each pixel of the pixel array is provided with a pulse generator; or all pixels in the pixel array are collectively connected to one pulse generator; or the pixel array is partitioned into a plurality of sub-regions and all pixels in each sub-region are collectively connected to one pulse generator; where the pulse generator is configured to generate a trigger signal at a fixed time interval, or at adaptive, programmable, and variable intervals to control a start exposure time and an exposure duration of a photoreceptor; pixels connected to a same pulse generator perform synchronous exposure, and pixels connected to different pulse generators perform either synchronous or asynchronous exposure; where the photoreceptor is provided inside the pixel and is configured to convert a light signal received at the position of the current pixel into an analog electrical signal.

According to the vision sensor chip based on the hybrid array of the present application, an exposure mode for each pixel of the pixel array is a global shutter or a rolling shutter.

According to the vision sensor chip based on the hybrid array of the present application, an output color type of a pathway corresponding to the pixel is a color value in case that the pixel is provided with a color filter and an output color type of a pathway corresponding to the pixel is a grayscale value in case that the pixel is not provided with a color filter.

According to the present application, there is further provided a vision sensor chip based on a hybrid array, including a pixel array and a vision sensing pathway corresponding to the pixel array; where the vision sensing pathway includes an intensity pathway, a temporal difference pathway, and a spatial difference pathway; the pixel array includes an intensity pixel, a temporal difference pixel, and a spatial difference pixel; the intensity pathway corresponds to the intensity pixel, the temporal difference pathway corresponds to the temporal difference pixel, and the spatial difference pathway corresponds to the spatial difference pixel; the intensity pathway is configured to determine a quantized value of an electrical signal converted from intensity of incident light at a position of a current intensity pixel at a current time; the temporal difference pathway is configured to perform temporal difference and quantization operations in a charge domain, an analog domain, or a digital domain on a signal at the position of the current temporal difference pixel at the current time and a signal at the position of the current temporal difference pixel at a previous time to obtain a temporal difference value; the spatial difference pathway is configured to perform spatial difference and quantization operations in the charge domain, the analog domain, or the digital domain on the signal at the position of the current spatial difference pixel at the current time and a signal at a position of a spatially associated spatial difference pixel at the current time to obtain a spatial difference value, where the spatially associated pixel refers to any one or more pixels within the pixel array other than the current spatial difference pixel.

According to the vision sensor chip based on the hybrid array of the present application, an intensity pathway includes an intensity storage and an intensity quantizer; the intensity storage is configured to store an electrical signal converted from intensity of incident light at a position of a current intensity pixel at a current time; the intensity quantizer is configured to perform an analog-to-digital conversion on the electrical signal converted from the intensity of incident light at the position of the current intensity pixel at the current time to obtain the quantized value of the electrical signal converted from the intensity of incident light at the position of the current intensity pixel at the current time; a temporal difference pathway includes a temporally differential storage and a temporal differentiator and quantizer; the temporally differential storage is configured to store electrical signals at the position of the current temporal difference pixel at different times using a ping-pong buffering mode; the temporally differential storage includes a first temporally differential storage node and a second temporally differential storage node; the ping-pong buffering mode is configured to store the electrical signal at the position of the current temporal difference pixel at the current time in the second temporally differential storage node or the first temporally differential storage node in case that an electrical signal at the position of the current temporal difference pixel at a previous time is stored in the first temporally differential storage node or the second temporally differential storage node; the temporal differentiator and quantizer is configured to perform temporal difference and quantization operations on the electrical signal at the position of the current temporal difference pixel at the current time and the electrical signal at the position of the current pixel at the previous time to obtain a temporal difference value; a spatial difference pathway includes a spatially differential storage node and a spatial differentiator and quantizer; the spatially differential storage node is configured to store the electrical signal at the position of the current spatial difference pixel at the current time; and the spatial differentiator and quantizer is configured to perform difference and quantization operations on the electrical signal at the position of the current spatial difference pixel at the current time and an electrical signal at a spatially associated pixel position at the current time to obtain a spatial difference value.

According to the vision sensor chip based on the hybrid array of the present application, the intensity quantizer is provided inside the intensity pixel and uses a pixel-level signal readout mode; or the intensity quantizer is provided outside the intensity pixel and shared by another intensity pixel located in a same column and uses a column-level signal readout mode; the temporal differentiator and quantizer is provided inside a pixel multiplexing the temporal difference and the spatial difference and uses the pixel-level signal readout mode; or the temporal differentiator and quantizer is provided outside the pixel multiplexing the temporal difference and the spatial difference, and shared by a pixel multiplexing the temporal difference and the spatial difference located in a same column and uses the column-level signal readout mode; and the spatial differentiator and quantizer is provided inside a pixel multiplexing the temporal difference and the spatial difference and uses the pixel-level signal readout mode; or is provided outside a pixel multiplexing the temporal difference and the spatial difference, and shared by a pixel multiplexing the temporal difference and the spatial difference located in a same column and uses the column-level signal readout mode.

According to the vision sensor chip based on the hybrid array of the present application, each pixel of the pixel array is provided with a pulse generator; or all pixels in the pixel array are collectively connected to one pulse generator; or the pixel array is partitioned into a plurality of sub-regions and all pixels in each sub-region are collectively connected to one pulse generator; where the pulse generator is configured to generate a trigger signal at a fixed time interval, or at adaptive, programmable, and variable intervals to control a start exposure time and an exposure duration of a photoreceptor; pixels connected to a same pulse generator perform synchronous exposure, and pixels connected to different pulse generators perform either synchronous or asynchronous exposure; where the photoreceptor is provided inside the pixel and is configured to convert a light signal received at the position of the current pixel into an analog electrical signal.

According to the vision sensor chip based on the hybrid array of the present application, an exposure mode for each pixel of the pixel array is a global shutter or a rolling shutter.

According to the vision sensor chip based on the hybrid array of the present application, an output color type of a pathway corresponding to the pixel is a color value in case that the pixel is provided with a color filter and an output color type of a pathway corresponding to the pixel is a grayscale value in case that the pixel is not provided with a color filter.

According to the vision sensor chip based on the hybrid array of the present application, the vision sensor chip includes a pixel array and a vision sensing pathway corresponding to the pixel array; where the vision sensing pathway includes an intensity pathway, a temporal difference pathway, and a spatial difference pathway; and the pixel array includes a plurality of multiplexed pixels and a plurality of single pixels; the plurality of multiplexed pixels are pixels multiplexing two elements selected from intensity, temporal difference and spatial difference; the plurality of single pixels are pixels with an element different from the two elements of the multiplexed pixels; the intensity pathway is configured to determine a quantized value of an electrical signal converted from intensity of incident light; the temporal difference pathway is configured to determine a temporal difference value; the spatial difference pathway is configured to determine a spatial difference value. In the present application, by using a tri-pathway vision sensor chip architecture based on the hybrid array, the capability of the vision sensor chip to perceive temporal-spatial dynamic information is significantly enhanced and high-precision, high-frame-rate, high-dynamic-range, efficient and robust visual representation are enabled.

According to the present application, there is further provided a vision sensor chip based on a pixel binning technology, including a pixel array, an intensity pathway, a temporal difference pathway, and a spatial difference pathway, where the pixel array includes a plurality of pixels; the binning technology is configured to bin signals of the plurality of pixels within a range of a binned pixel into a single signal and output the single signal; the intensity pathway is configured to determine a quantized value of an electrical signal converted from intensity of incident light at a binned pixel; the temporal difference pathway is configured to perform temporal difference, binning, and quantization operations in a charge domain, an analog domain, or a digital domain on a signal at a position of a current binned pixel at a current time and a signal at the position of the current binned pixel at the previous time to obtain a temporal difference value of the binned pixel; a signal of the binned pixel is a binned signal of the plurality of pixels within the range of the binned pixel; the spatial difference pathway is configured to perform spatial difference, binning, and quantization operations in the charge domain, the analog domain, or the digital domain on the signal at the position of the current binned pixel at the current time and the signal at a position of a spatially associated binned pixel at the current time to obtain a spatial difference value of the binned pixel; and the spatially associated binned pixel refers to any one or more binned pixels within the pixel array other than the current binned pixel.

According to the vision sensor chip based on the pixel binning technology of the present application, an intensity pathway includes a first intensity binner and a first intensity quantizer; the first intensity binner is configured to bin analog signals of the plurality of pixels at the position of the current binned pixel at the current time to obtain a first intensity binned signal; and the first intensity quantizer is configured to perform analog-to-digital conversion on the first intensity binned signal to obtain a quantized value of an electrical signal converted from intensity of incident light at the binned pixel.

According to the vision sensor chip based on the pixel binning technology of the present application, the intensity pathway includes a second intensity quantizer and a second intensity binner; the second intensity quantizer is configured to perform analog-to-digital conversion on analog signals of the plurality of pixels at the position of the current binned pixel at the current time to obtain a quantized value of an electrical signal converted from intensity of incident light at each of the pixels; and the second intensity binner is configured to bin quantized values of intensities of incident light at the plurality of pixels to obtain a quantized value of the electrical signal converted from intensity of incident light of the binned pixel.

According to the vision sensor chip based on the pixel binning technology of the present application, the temporal difference pathway includes a first temporally differential binner, a first temporal differentiator, and a first temporal quantizer; the first temporally differential binner is configured to bin electrical signals of the plurality of the pixels to obtain first temporally differential binned signals at the position of the current binned pixel at different times; the first temporal differentiator is configured to perform temporal difference operation on a first temporally differential binned signal at the position of the current binned pixel at the current time and a first temporally differential binned signal at the position of the current binned pixel at the previous time to obtain a temporal difference value of the binned pixel; and analog-to-digital signal conversion is performed by the first temporal quantizer during the binning and temporal difference processes.

According to the vision sensor chip based on the pixel binning technology of the present application, the temporal difference pathway includes a second temporal differentiator, a second temporal quantizer, and a second temporally differential binner; the second temporal differentiator is configured to determine a temporal difference value of each of the plurality of pixels; the temporal difference value of each of the pixels is obtained by performing a temporal difference operation on an electrical signal at a position of a current pixel at a current time and an electrical signal at the position of the current pixel at a previous time; and the second temporally differential binner is configured to bin temporal difference values of the plurality of pixels to obtain a temporal difference value of the binned pixel; and analog-to-digital signal conversion is performed by the second temporal quantizer during the binning and temporal difference processes.

According to the vision sensor chip based on the pixel binning technology of the present application, the spatial difference pathway includes a first spatially differential binner, a first spatial differentiator, and a first spatial quantizer; where the first spatially differential binner is configured to bin electrical signals of the plurality of pixels to obtain first spatially differential binned signals at a position of a current binned pixel at the current time; the first spatial differentiator is configured to perform spatial difference operation on a first spatially differential binned signal at the position of the current binned pixel at the current time and a first spatially differential binned signal at a position of a spatially associated binned pixel at the current time to obtain a spatial difference value of the binned pixel; and analog-to-digital signal conversion is performed by the first spatial quantizer during the binning and spatial difference processes.

According to the vision sensor chip based on the pixel binning technology of the present application, the spatial difference pathway includes a second spatial differentiator, a second spatial quantizer, and a second spatially differential binner; the second spatial differentiator is configured to determine a spatial difference value of each of the pixels; the spatial difference value of each of the pixels is obtained by performing spatial difference operation on an electrical signal at a position of a current pixel at a current time and an electrical signal at a position of a spatially associated binned pixel at the current time; and the second spatially differential binner is configured to bin spatial difference values of the plurality of pixels to obtain a spatial difference value of the binned pixel; and analog-to-digital signal conversion is performed by the second spatial quantizer during the binning and spatial difference processes.

According to the vision sensor chip based on the pixel binning technology of the present application, each pixel of the pixel array is provided with a pulse generator; or all pixels in the pixel array are collectively connected to one pulse generator; or the pixel array is partitioned into a plurality of sub-regions and all pixels in each sub-region are collectively connected to one pulse generator; where the pulse generator is configured to generate a trigger signal at a fixed time interval, or at adaptive, programmable, and variable intervals to control a start exposure time and an exposure duration of a photoreceptor; pixels connected to a same pulse generator perform synchronous exposure, and pixels connected to different pulse generators perform either synchronous or asynchronous exposure; where the photoreceptor is provided inside the pixel and is configured to convert a light signal received at the position of the current pixel into an analog electrical signal.

According to the vision sensor chip based on the pixel binning technology of the present application, an exposure mode for each pixel of the pixel array is a global shutter or a rolling shutter.

According to the vision sensor chip based on the pixel binning technology of the present application, an output color type of a pathway corresponding to the pixel is a color value in case that the pixel is provided with a color filter and an output color type of a pathway corresponding to the pixel is a grayscale value in case that the pixel is not provided with a color filter.

According to the present application, there is further provided a vision sensor chip based on a pixel binning technology, including a pixel array, an intensity pathway, a temporal difference pathway, and a spatial difference pathway, where the pixel array includes a plurality of pixels; the binning technology is configured to bin signals of the plurality of pixels within a range of a binned pixel into a single signal and output the single signal; the intensity pathway is configured to determine a quantized value of an electrical signal converted from intensity of incident light at a binned pixel; the temporal difference pathway is configured to perform differentiation, binning, and quantization operations in a charge domain, an analog domain, or a digital domain on a signal at a position of a current binned pixel at a current time and a signal at the position of the current binned pixel at the previous time; the spatial difference pathway is configured to perform differentiation, binning, and quantization operations in the charge domain, the analog domain, or the digital domain on the signal at the position of the current binned pixel at the current time and the signal at a position of an associated adjacent binned pixel at the current time. The pixel binning technology is introduced into a tri-pathway visual sensor chip architecture can enhance an output signal-to-noise ratio and reduce the volume of transmitted data, alleviating pressure on bandwidths.

According to the present application, there is further provided a spatiotemporal difference vision sensor chip based on a 3D stacking technology, including a pixel array, a storage circuit, and a spatiotemporal difference and quantization circuit; the pixel array is provided at a top wafer, the spatiotemporal difference and quantization circuit is provided at a same bottom wafer, the top wafer and the bottom wafer are connected through a 3D stacking mode; the pixel array includes a plurality of pixels; a photoreceptive circuit is provided inside the pixel array; the photoreceptive circuit is configured to convert obtained light signals of the plurality of pixels into analog electrical signals of the plurality of pixels; the storage circuit is configured to store the analog or digital electrical signals of the plurality of pixels; the spatiotemporal difference and quantization circuit is configured to perform spatiotemporal difference and quantization operations on the analog electrical signals of the plurality of pixels to obtain a digital spatiotemporal difference electrical signals of each of the plurality of pixels; or the spatiotemporal difference and quantization circuit is configured to quantize the analog electrical signals of the plurality of pixels to obtain digital electrical signals of the plurality of pixels, and subsequently perform spatiotemporal difference operation on the digital electrical signals to obtain a digital spatiotemporal difference electrical signal of each of the plurality of pixels.

According to the spatiotemporal difference vision sensor chip based on the 3D stacking technology of the present application, the storage circuit includes a plurality of storage nodes, the plurality of storage nodes are configured to store analog electrical signals of the pixels at different locations and different times using a multi-node random-access buffering mode; the spatiotemporal difference and quantization circuit includes a temporal difference and quantization unit and a spatial difference and quantization unit; the temporal difference and quantization unit is configured to perform temporal difference and quantization operations on the analog electrical signals of the plurality of pixels at different times to obtain temporal difference values at a position of a current pixel at different times; the spatial difference and quantization unit is configured to perform spatial difference and quantization operations on the analog electrical signals of pixels at different locations to obtain spatial differential values of the pixel at the position of the current pixel and adjacent pixels at the current time.

According to the spatiotemporal difference vision sensor chip based on the 3D stacking technology of the present application, the spatiotemporal difference vision sensor chip further includes a pulse signal generator configured to control exposure of the photoreceptive circuit.

According to the spatiotemporal difference vision sensor chip based on the 3D stacking technology of the present application, a single pulse signal generator is provided inside each of the plurality of pixels, and the digital spatiotemporal difference electrical signals of the plurality of pixels are output at a same time interval or at an adaptive and programmable time interval.

According to the spatiotemporal difference vision sensor chip based on the 3D stacking technology of the present application, the plurality of the pixels share a single pulse signal generator, and the digital spatiotemporal difference electrical signals of the plurality of pixels are output at a same time interval.

According to the spatiotemporal difference vision sensor chip based on the 3D stacking technology of the present application, the spatiotemporal difference and quantization circuit is provided outside the plurality of pixels and uses a column-level signal readout mode.

According to the spatiotemporal difference vision sensor chip based on the 3D stacking technology of the present application, the spatiotemporal difference and quantization circuit is provided inside each of the plurality of pixels and uses a pixel-level signal readout mode.

According to the spatiotemporal difference vision sensor chip based on the 3D stacking technology of the present application, the digital electrical signals of the plurality of pixels are quantized and read out in a multi-valued mode.

According to the spatiotemporal difference vision sensor chip based on the 3D stacking technology of the present application, the spatiotemporal difference vision sensor chip further includes a binning circuit configured to bin the analog electrical signals of a plurality of the pixels to obtain a binned analog electrical signal; the spatiotemporal difference and quantization circuit is further configured to perform spatiotemporal difference and quantization operations on the binned analog electrical signal to obtain a binned digital spatiotemporal difference electrical signal.

According to the present application, there is further provided an imaging system including the aforementioned spatiotemporal difference vision sensor chip based on the 3D stacking technology.

According to the spatiotemporal difference vision sensor chip based on the 3D stacking technology and the imaging system of the present application, the chip includes a pixel array, a storage circuit, and a spatiotemporal difference and quantization circuit. The pixel array includes a plurality of pixels, and a photoreceptive circuit is provided inside the pixel array. By providing the pixel array at the top wafer and the spatiotemporal difference and quantization circuit the same bottom wafer using the 3D stacking mode, a level of integration is significantly enhanced, an area of the chip is effectively reduced, and pressure on output bandwidths is simultaneously alleviated. The photoreceptive circuit converts obtained optical signals of pixels into analog electrical signals of the pixels; the storage circuit stores either the analog electrical signals or the digital electrical signals of the pixels; and the spatiotemporal difference and quantization circuit performs spatiotemporal difference and quantization operations on the analog electrical signals of the pixels to obtain digital spatiotemporal difference electrical signals of the pixels, enabling the simultaneous acquisition of both the temporal and spatial variations of visual signals to form an efficient and robust visual representation.

### BRIEF DESCRIPTION OF THE DRAWINGS

To illustrate solutions of the present application or in the related art more clearly, accompanying drawings that needs to be used in the description of the embodiments or the related art are briefly described below. The drawings described below are only some embodiments of the present application. For those skilled in the art, other drawings may also be obtained based on these drawings without creative effort.

FIG. 1 is a first schematic structural diagram of a vision sensor chip according to the present application;

FIG. 2 is a structural block diagram of ping-pong buffering according to the present application;

FIG. 3 is a circuit design diagram of ping-pong buffering according to the present application;

FIG. 4 is a first schematic structural diagram of a pixel inside which both a temporal differentiator and quantizer and a spatial differentiator and quantizer are provided according to the present application;

FIG. 5 is a second schematic structural diagram of a pixel inside which both a temporal differentiator and quantizer and a spatial differentiator and quantizer are provided according to the present application;

FIG. 6 is a schematic diagram of communication connections among pixels within a chip according to the present application;

FIG. 7 is a first schematic structural diagram of a pixel outside which both a temporal differentiator and quantizer and a spatial differentiator and quantizer are provided according to the present application;

FIG. 8 is a schematic diagram of a trigger pulse signal according to the present application.

FIG. 9 is a second schematic structural diagram of a vision sensor chip according to the present application;

FIG. 10 is a first schematic structural diagram of a pixel inside which all a temporal differentiator and quantizer, a spatial differentiator and quantizer and an intensity quantizer are provided according to the present application;

FIG. 11 is a second schematic structural diagram of a pixel inside which all a temporal differentiator and quantizer, a spatial differentiator and quantizer and an intensity quantizer are provided according to the present application;

FIG. 12 is a schematic structural diagram of a pixel outside which both a temporal differentiator and quantizer and a spatial differentiator and quantizer are provided and inside which an intensity quantizer is provided according to the present application;

FIG. 13 is a third schematic structural diagram of a pixel inside which all a temporal differentiator and quantizer, a spatial differentiator and quantizer and an intensity quantizer are provided according to the present application;

FIG. 14 is a fourth schematic structural diagram of a pixel inside which all a temporal differentiator and quantizer, a spatial differentiator and quantizer and an intensity quantizer are provided according to the present application;

FIG. 15 is a first schematic architecture diagram of a vision sensor chip based on a hybrid array according to the present application;

FIG. 16 is a schematic principle diagram of reading out a quantized value of an electrical signal converted from intensity of incident light of an intensity pixel according to the present application;

FIG. 17 is a first schematic principle diagram of reading out a temporal difference value of a spatiotemporal difference pixel according to the present application;

FIG. 18 is a first schematic principle diagram of reading out a spatial difference value of a spatiotemporal difference pixel according to the present application;

FIG. 19 is a second schematic principle diagram of reading out a spatial difference value of a spatiotemporal difference pixel according to the present application;

FIG. 20 is a specific schematic principle diagram of reading out a temporal difference value of a spatiotemporal difference pixel according to the present application;

FIG. 21 is a specific schematic principle diagram of reading out a spatial difference value of a spatiotemporal difference pixel according to the present application;

FIG. 22 is a second schematic architecture diagram of a vision sensor chip based on a hybrid array according to the present application;

FIG. 23 is a third schematic architecture diagram of a vision sensor chip based on a hybrid array according to the present application;

FIG. 24 is a third schematic principle diagram of reading out a temporal difference value and a spatial difference value of a spatiotemporal difference pixel according to the present application;

FIG. 25 is a fourth schematic principle diagram of reading out a temporal difference value and a spatial difference value of a spatiotemporal difference pixel according to the present application;

FIG. 26 is a fourth schematic architecture diagram of a vision sensor chip based on a hybrid array according to the present application;

FIG. 27 is a fifth schematic architecture diagram of a vision sensor chip based on a hybrid array according to the present application;

FIG. 28 is a first schematic principle diagram of a vision sensor chip based on a pixel binning technology according to the present application;

FIG. 29 is a first schematic principle diagram of pixel binning according to the present application;

FIG. 30 is a second schematic principle diagram of pixel binning according to the present application;

FIG. 31 is a schematic structural diagram of a tri-pathway vision sensor using multiplexed pixels according to the present application;

FIG. 32 is a schematic structural diagram of a vision sensor chip based on a hybrid pixel according to the present application;

FIG. 33 is a second schematic principle diagram of a vision sensor chip based on a pixel binning technology according to the present application;

FIG. 34 is a third schematic principle diagram of a vision sensor chip based on a pixel binning technology according to the present application;

FIG. 35 is a schematic principle diagram of difference in a diagonal direction according to the present application;

FIG. 36 is a schematic principle diagram of difference in x and y directions according to the present application;

FIG. 37 is a flowchart of signal processing of spatiotemporal difference vision sensor chip based on a 3D stacking technology according to the present application;

FIG. 38 is a schematic diagram of a synchronization trigger signal according to the present application.

FIG. 39 is an internal block diagram of a pixel meeting spatiotemporal difference output requirements according to the present application;

FIG. 40 is a circuit diagram of a pixel meeting spatiotemporal difference output requirements according to the present application;

FIG. 41 is an architecture diagram of pathways of a spatiotemporal difference vision sensor chip based on a 3D stacking technology according to the present application;

FIG. 42 is a diagram of a column-level processing array based on a 3D stacking process according to the present application;

FIG. 43 is a diagram of a pixel-level processing array based on a 3D stacking process according to the present application;

FIG. 44 is a principle diagram of an “O” portion in a bottom circuit of a pixel-level processing array based on a 3D stacking process according to the present application; and

FIG. 45 is an architecture diagram of a high-precision, multi-value, time-varying vision sensor chip featuring a full-array asynchronous form according to the present application.

### DETAILED DESCRIPTION

To illustrate objectives, solutions and advantages of the present application more clearly, the solutions in the present application will be described below clearly and completely in conjunction with the accompanying drawings in the present application. The described embodiments are part of the embodiments of the present application, rather than all of the embodiments. All other embodiments obtained by a person of ordinary skill in the art based on the embodiments of the present utility model without any creative effort fall within the protection scope of the present utility model.

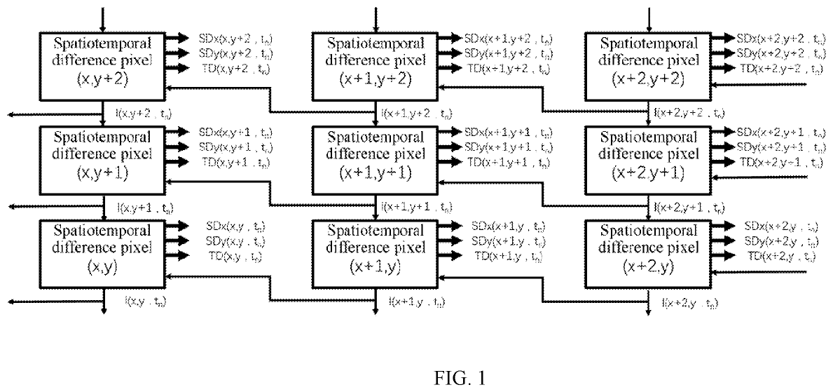

A vision sensor chip and a vision sensor of the present application are described below in conjunction with FIG. 1 to FIG. 14.

Abbreviations and definitions of key terms used in the present application are explained below:
APS denotes an active pixel sensor;
CFA denotes a color filter array;
CIS denotes a CMOS image sensor;
DAVIS denotes a dynamic and active-pixel vision sensor;
DVS denotes a dynamic vision sensor;
EVS denotes an event-based vision sensor;
fps denotes frames per second (unit of frame rate);
PD denotes a photodiode;
SD denotes spatial difference; and
TD denotes temporal difference.

A traditional DVS technology has the following defects.

### 1, Limited Precision of Single-Value Signals

DVS outputs ±1-bit information (for example, + indicates an increase in light intensity, − indicates a decrease in light intensity, and 0 indicates no change in light intensity; consequently, the DVS outputs positive and negative pulses based solely on this ±1-bit information, without being able to perceive a magnitude of the light intensity change). This renders the information susceptible to noise interference, results in a low information content, and makes it unable to adapt to complex environments.

### 2. Lack of Spatial Difference Information

In contrast, a human visual system simultaneously perceives both temporal and spatial variations, making it more sensitive and robust to the outside world. The DVS, however, can only output information regarding the temporal changes in visual signals; this information is highly susceptible to interference (for instance, in case that flickering light is present in the environment, DVS may fail, as it cannot distinguish between signal changes caused by variations in the light source and those caused by motion), and lacks spatial difference information.

According to the present application, there is provided a vision sensor chip, where the chip includes a plurality of pixels arranged in an array;
for each pixel, the pixel is provided with a temporal difference pathway and a spatial difference pathway corresponding to each pixel;
the temporal difference pathway is configured to output a temporal difference value of the pixel;
the spatial difference pathway is configured to output a spatial difference value of the pixel;
the temporal difference value is a result obtained by performing difference and quantization operations on output values of a photoreceptive subunit within the pixel at a current time and at a previous time;
the spatial difference value is a result obtained by performing difference and quantization operations on an output value of the photoreceptive subunit at the current time and an output value of the target photoreceptive subunit at the current time; and
a pixel where the target photoreceptive subunit is located is any pixel among the pixel array other than the pixel.

In an embodiment, a vision sensor with dual-pathway output is implemented in the present application. The two pathways are a TD pathway and an SD pathway.

The TD pathway outputs a temporal difference value TD(x,y,tₙ) of a current pixel (x,y) at time tₙ, expressed by the following equation:

$$TD ( x , y , {t}_{n} ) = {Q}_{TD} ( I ( x , y , {t}_{n} ) - I ( x , y , {t}_{n - 1} ) )$$

in the above equation, I(x, y, tₙ) and I(x, y, tₙ₋₁) represent output values of a photoreceptive subunit within the current pixel (x,y) at the time tₙ and at a previous time tₙ₋₁, respectively; Q_{TD} denotes a quantization method used by the TD pathway.

The SD pathway outputs a spatial difference value SD_{*}(x,y,tₙ) of the current pixel (x,y) at the time tₙ, expressed by the following equation:

$${SD}_{*} ( x , y , {t}_{n} ) = {Q}_{S D} ( I ( x , y , {t}_{n} ) - I ( {x}_{*} , {y}_{*} , {t}_{n} ) )$$

in the above equations, I(x_{*}, y_{*}, tₙ) represents an output value of the target photoreceptive subunit at the time tₙ (the current time);
a pixel where the target photoreceptive subunit is located is any pixel among the pixel array other than the pixel.

A number of the target photoreceptive subunit may be one or multiple, giving rise to the following cases.

Case (1), the SD pathway performs differentiation in only one specific direction in case that the number of the target photoreceptive subunit is one,

Case (2), the SD pathway performs differentiation in only one direction in case that the number of the target photoreceptive subunit is two (denoted as a first target photoreceptive subunit and a second target photoreceptive subunit, respectively) and a pixel where the first target photoreceptive subunit is located, a pixel where the second target photoreceptive subunit is located and the pixel all lie along a single straight line; in this case, precision in the differentiation of the pixel is higher than that in case (1).

Case (3), the SD pathway performs differentiation in two directions in case that the number of the target photoreceptive subunit is two (denoted as a first target photoreceptive subunit and a second target photoreceptive subunit, respectively) and a pixel where the first target photoreceptive subunit is located, a pixel where the second target photoreceptive subunit is located and the pixel all do not lie along a single straight line; in this case, the pixel can obtain spatial difference information from a plurality of directions.

Case (4), the SD pathway performs differentiation in only one direction in case that the number of the target photoreceptive subunit is multiple (more than two) and pixels where all target photoreceptive subunits and the pixel lie along a single straight line; in this case, precision in the differentiation of the pixel is higher than that in case (2).

Case (5), the SD pathway at least performs differentiation in two directions in case that the number of the target photoreceptive subunit is multiple (more than two) and pixels where all target photoreceptive subunits and the pixel do not lie along a single straight line.

It can be seen that the precision in the differentiation of the pixel is mainly influenced by the number of differentiation directions and the number of target photoreceptive subunits. In fact, the precision in the differentiation of the pixel is also influenced by distances among the pixels containing the target photoreceptive subunits and the pixel. Therefore, the present application preferably provides that the target photoreceptive subunits include a first target photoreceptive subunit and a second target photoreceptive subunit, where both the pixel where the first target photoreceptive subunit is located (hereinafter referred to as a first pixel) and a pixel where the second target photoreceptive subunit is located (hereinafter referred to as a second pixel) are adjacent to the pixel, and the first pixel, and the pixel, and the second pixel do not lie along the same straight line.

For example, the first pixel and the second pixel are a pixel (x+1,y) and a pixel (x,y+1), respectively; here, “1” refers to a spacing of one pixel.

In this case, the SD pathway outputs a spatial difference value SDₓ(x,y,tₙ) between a pixel value of the pixel (x,y) at the time tₙ and a pixel value of the pixel (x+1,y) at the time ty, as well as a spatial difference value SD_{y}(x,y,tₙ) between the pixel value of the pixel (x,y) at the time ty and a pixel value of a pixel (x,y+1) at the time tₙ;

$${SD}_{x} ( x y , {t}_{n} ) = {Q}_{SD} ( I ( x , y , {t}_{n} ) - I ( x + 1 y , {t}_{n} ) )$$

$${SD}_{y} ( x , y , {t}_{n} ) = {Q}_{SD} ( I ( x , y , {t}_{n} ) - I ( x , y + 1 , {t}_{n} ) )$$

$$I ( x , y + 1 , {t}_{n} ) .$$

For another example, the first pixel and the second pixel are a pixel (x−1,y+1) and a pixel (x+1,y+1), respectively; in this case, the SD pathway outputs a spatial difference value [symbol] (x,y,tₙ) between the pixel value of the pixel (x,y) at the time tₙ and a pixel value of pixel (x−1,y+1) at the time ty, as well as a spatial difference value [symbol] (x,y,tₙ) between the pixel value of pixel (x,y) at the time tₙ and a pixel value of pixel (x+1,y+1) at the time ty;

$${SD}_{↙} ( x , y , {t}_{n} ) = {Q}_{SD} ( I ( x , y , {t}_{n} ) - I ( x + 1 , y + 1 , {t}_{n} ) )$$

$${SD}_{↘} ( x , y , {t}_{n} ) = {Q}_{SD} ( I ( x , y , {t}_{n} ) - I ( x - 1 , y + 1 , {t}_{n} ) )$$

in the above equations, Q_{SD} represents a quantization method used by the spatial difference pathway.

I(x+1,y,tₙ) [symbol] I(x,y+1,tₙ) [symbol] I(x+1,y+1,tₙ) and I(x−1,y+1,tₙ) represent the output values of photoreceptive subunits inside pixels (x+1,y), (x,y+1), (x+1,y+1) and (x−1,y+1) at the time tₙ, respectively.

All signals mentioned above are three-dimensional quantities, including spatial two-dimensional quantities x and y and a temporal dimension t.

FIG. 1 is a schematic structural diagram of a corresponding vision sensor chip, which illustrates an example where a first pixel and a second pixel are (x+1,y) and (x,y+1), respectively.

The vision sensor chip according to the present application bins dual-pathway characteristics of a human visual system into a traditional vision sensor chip to significantly enhances capability of the vision sensor chip to perceive temporal-spatial dynamic information and enable high-precision, high-frame-rate, high-dynamic-range, efficient and robust visual representation.

Based on the aforementioned embodiments, the temporal difference pathway includes the photoreceptive subunit, a differential storage subunit and a temporal differentiator and quantizer provided inside the pixel;
the spatial difference pathway includes the photoreceptive subunit, the differential storage subunit, and a spatial differentiator and quantizer;
where the temporal differentiator and quantizer is provided inside the pixel, or is provided outside the pixel and shared by the pixel and other pixels located in a same column;
the spatial differentiator and quantizer is provided inside the pixel, or is provided outside the pixel and shared by the pixel and other pixels located in a same column;
the photoreceptive subunit is configured to convert intensity of light incident at the pixel at the current time into an electrical signal and output the electrical signal;
it is to be understood that output values of the photoreceptive subunits constitute electrical signals, such as charge, voltage, or current that characterizes a magnitude of intensity of the incident light perceived at the position of the current pixel at the current time; specifically, the greater the light intensity, the higher the pixel value.

The differential storage subunit is configured to write the output value of the photoreceptive subunit at the current time; where the differential storage subunit includes a first storage node and a second storage node, and is configured to write the output value of the photoreceptive subunit at the current time into the second storage node or the first storage node in case that the output value of the photoreceptive subunit at the previous time is stored in the first storage node or the second storage node; and
it can be understood that, in order to construct both the temporal difference pathway and the spatial difference pathway, two storage nodes (a first storage node and a second storage node, where the first storage node and the second storage nodes use a ping-pong buffering mode to buffer data, and the ping-pong buffering means that an output of the photoreceptive unit at the current time is stored in the first storage node, an output thereof at the next time is stored in the second storage node, and an output thereof at the subsequent time is stored back in the first storage node-thus alternating back and forth) are provided inside each pixel and signals at two times (I(x,y,tₙ), I(x,y,tₙ₋₁)) are output.

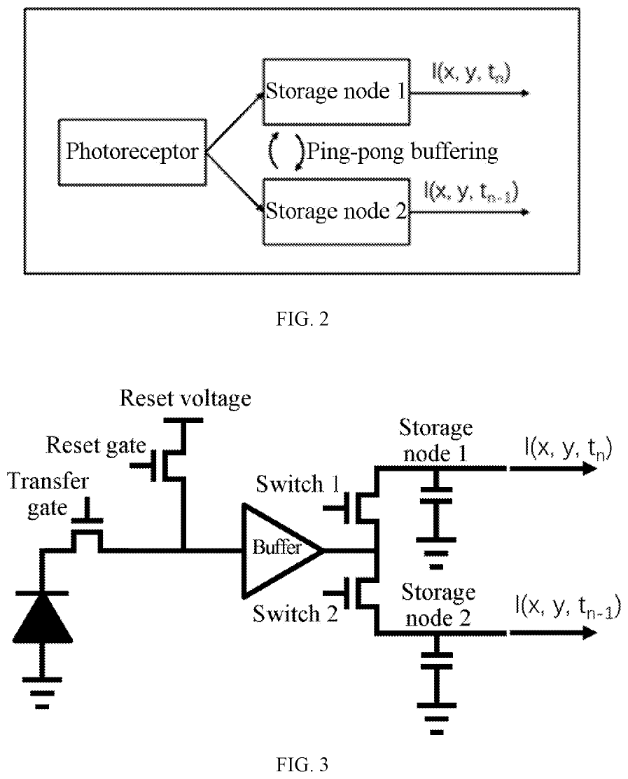

FIG. 2 is a structural block diagram of ping-pong buffering. FIG. 3 shows a possible specific circuit design; however, there is more than one type of actual circuit principle diagram.

The temporal differentiator and quantizer is configured to calculate and output the temporal difference value; and
the spatial differentiator and quantizer is configured to calculate and output the spatial difference value based on the output value of the target photoreceptive subunit at the current time.

In other words, four types of schematic structural diagram of a pixel are provided according to the present application depending on whether the temporal differentiator and quantizer and the spatial difference and quantizer are provided inside the pixel.

Type A, one temporal differentiator and quantizer and one spatial differentiator and quantizer are provided inside each pixel.

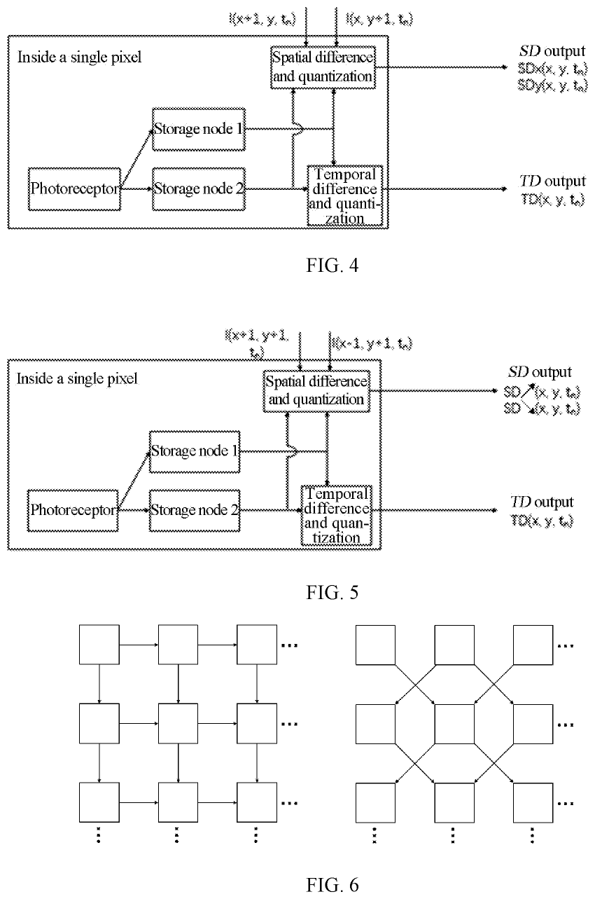

FIG. 4 and FIG. 5 are schematic structural diagrams of a pixel inside which both a temporal differentiator and quantizer and a spatial differentiator and quantizer are provided. FIG. 4 illustrates an example where a first pixel and a second pixel are (x+1,y) and (x,y+1), respectively. FIG. 5 illustrates an example where a first pixel and a second pixel are (x−1,y+1) and (x+1,y+1), respectively. For the Type A, a pixel readout mode is used, that is, each pixel directly reads out both the temporal difference value and the spatial difference value.

It should be noted that, due to the presence of the difference and quantization pathway, communication connections are established between each pixel inside the pixel array and its corresponding target photoreceptive subunit. FIG. 6 is a schematic diagram of communication connections among pixels within a chip according to the present application, in FIG. 6, squares represent a pixel, while connecting lines depict the transmission of output values from the photoreceptive subunits of the pixels at specific time ty. Specifically, the diagram on the left illustrates an example where the first pixel and the second pixel are (x+1,y) and (x,y+1), respectively. The diagram on the right illustrates an example where the first pixel and the second pixel are (x−1,y+1) and (x+1,y+1), respectively.

Type B, one temporal differentiator and quantizer and one spatial differentiator and quantizer are provided for each column of pixels and are shared by the column of pixels.

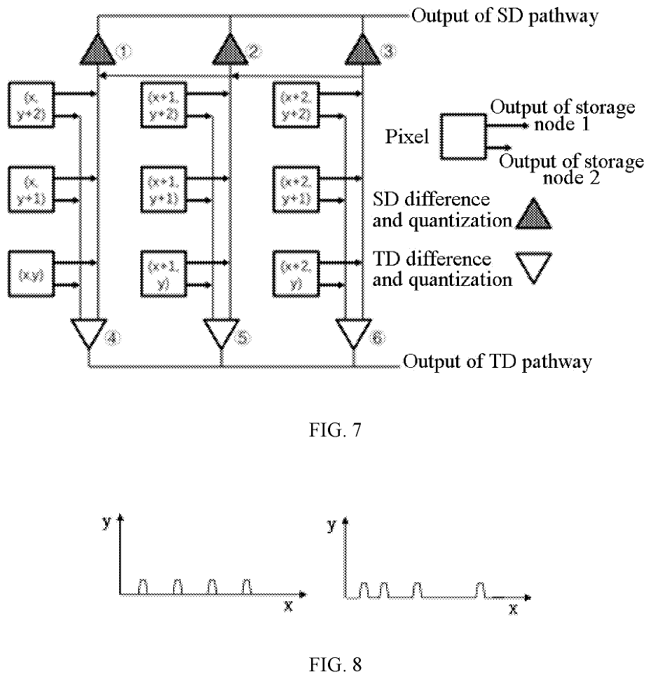

FIG. 7 is a schematic structural diagram of a pixel outside which both a temporal differentiator and quantizer and a spatial differentiator and quantizer are provided and illustrates an example where a first pixel and a second pixel are (x+1,y) and (x,y+1), respectively. For Type B, a column-level readout mode is used, that is each column shares one temporal differentiator and quantizer and one spatial differentiator and quantizer.

As shown in FIG. 7, the SD differentiator and quantizer (1) sequentially calculates:

$${SD}_{x} ( x , y , {t}_{n} ) = {Q}_{SD} ( I ( x , y , {t}_{n} ) - I ( x + 1 , y , {t}_{n} ) )$$

$${SD}_{y} ( x , y , {t}_{n} ) = {Q}_{SD} ( I ( x , y , {t}_{n} ) - I ( x , y + 1 , {t}_{n} ) )$$

$${SD}_{x} ( x , y + 1 , {t}_{n} ) = {Q}_{SD} ( I ( x , y + 1 , {t}_{n} ) - I ( x + 1 , y + 1 , {t}_{n} ) )$$

$${SD}_{y} ( x , y + 1 , {t}_{n} ) = {Q}_{, SD} ( I ( x , y + 1 , {t}_{n} ) - I ( x , y + 2 , {t}_{n} ) )$$

the SD differentiator and quantizer (2) sequentially calculates:

$${SD}_{x} ( x + 1 , y , {t}_{n} ) = {Q}_{SD} ( I ( x + 1 , y , {t}_{n} ) - I ( x + 2 , y , {t}_{n} ) )$$

$${SD}_{y} ( x + 1 , y , {t}_{n} ) = {Q}_{SD} ( I ( x + 1 , y , {t}_{n} ) - I ( x + 1 , y + 1 , {t}_{n} ) )$$

$${SD}_{x} ( x + 1 , y + 1 , {t}_{n} ) = {Q}_{SD} ( I ( x + 1 , y + 1 , {t}_{n} ) - I ( x + 2 , y + 1 , {t}_{n} ) )$$

$${SD}_{y} ( x + 1 , y + 1 , {t}_{n} ) = {Q}_{SD} ( I ( x + 1 , y + 1 , {t}_{n} ) - I ( x + 1 , y + 2 , {t}_{n} ) )$$

the SD differentiator and quantizer (3) can be deduced in the same way.

The TD differentiator and quantizer (4) sequentially calculates:

$$TD ( x , y , {t}_{n} ) = {Q}_{TD} ( I ( x , y , {t}_{n} ) - I ( x , y , {t}_{n - 1} ) )$$

$$TD ( x , y + 1 , {t}_{n} ) = {Q}_{TD} ( I ( x , y + 1 , {t}_{n} ) - I ( x , y + 1 , {t}_{n - 1} ) )$$

$$TD ( x , y + 2 , {t}_{n} ) = {Q}_{TD} ( I ( x , y + 2 , {t}_{n} ) - I ( x , y + 2 , {t}_{n - 1} ) )$$

the TD differentiator and quantizer (5) sequentially calculates:

$$TD ( x + 1 , y , {t}_{n} ) = {Q}_{TD} ( I ( x + 1 , y , {t}_{n} ) - I ( x + 1 , y , {t}_{n - 1} ) )$$

$$TD ( x + 1 , y + 1 , {t}_{n} ) = {Q}_{TD} ( I ( x + 1 , y + 1 , {t}_{n} ) - I ( x + 1 , y + 1 , {t}_{n - 1} ) )$$

$$TD ( x + 1 , y + 2 , {t}_{n} ) = {Q}_{TD} ( I ( x + 1 , y + 2 , {t}_{n} ) - I ( x + 1 , y + 2 , {t}_{n - 1} ) )$$

the SD differentiator and quantizer (6) proceeds in a similar manner.

A principle remains the same for examples where the first and second pixels are (x−1,y+1) and (x+1,y+1), respectively and therefore it is not described further in detail here.

Type C, one temporal differentiator and quantizer is provided inside each pixel and one spatial differentiator and quantizer is provided for each column of pixels and are shared by the column of pixels.

Type D, one spatial differentiator and quantizer is provided inside each pixel and one temporal differentiator and quantizer is provided for each column of pixels and are shared by the column of pixels.

Type C and Type D are evolved from types where the temporal differentiator and quantizer and the spatial differentiator and quantizer are provided either inside the pixel or inside the pixel and therefore they are not described further in detail here.

It should be noted that, in the aforementioned four types, the output values I(x,y,tₙ) and I(x,y,tₙ₋₁) of the photoreceptive subunits within a given pixel (x,y) at time tₙ and the previous time tₙ₋₁, respectively are simultaneously input into the spatial differentiator and quantizer and the spatial differentiator and quantizer selects I(x,y,tₙ) while I(x,y,tₙ₋₁) is discarded through an internal selector and then performs spatial difference and quantization operations.

Furthermore, a quantization mode used by both the temporal differentiator and quantizer and the spatial differentiator and quantizer is analog-to-digital converter (ADC) quantization;
where the ADC quantization may take various forms, including single-bit ADC quantization; multi-bit ADC quantization with a sign bit (where positive and negative signs indicate signal enhancement or attenuation, respectively); and multi-bit ADC quantization without a sign bit.

In the present application, the multi-bit ADC quantization with the sign bit (where positive and negative signs indicate signal enhancement or attenuation, respectively) is preferably used.

The multi-bit ADC quantization with the sign bit may perceive light intensity variations with greater precision and enhance precision in the pixels since it quantifies not only the magnitude of the differential result but also gives positive or negative signs of the difference results and may further improve a signal-to-noise ratio since the differential result is represented using a plurality of bits.

Based on the aforementioned embodiments, each pixel of the pixel array is provided with a trigger pulse generator; or
all pixels in the pixel array are collectively connected to one trigger pulse generator; or
the pixel array is partitioned into a plurality of sub-regions and all pixels in each sub-region are collectively connected to one trigger pulse generator;
where the trigger pulse generator is configured to generate a trigger signal at a fixed time interval, or at adaptive, programmable, and variable intervals to control a exposure time of a corresponding photoreceptive subunit.

The trigger pulse generator is configured to generate a trigger signal for controlling the photoreceptive subunit to perform exposure, that is, determine the specific time tₙ at which the signal is acquired. FIG. 8 is a schematic diagram of a trigger pulse signal; a horizontal axis of FIG. 8 represents time and a vertical axis represents an amplitude of a digital signal. As illustrated in FIG. 8, times at which a trigger pulse is generated correspond to sampling times of the pixel, specifically, are times tₙ, tₙ₋₁, tₙ₋₂, and so forth. These times can be configured not only as fixed time intervals, as depicted in the left-hand side of the figure but also as adaptive, programmable, and variable intervals, as depicted in the right-hand side. Such adaptive intervals may adapt the dynamic characteristics of external visual signals; specifically, a higher sampling frequency is used in case that the magnitude of change or the frequency of variation is high, whereas a lower sampling frequency is used for low-frequency signals, reducing both data volume and power consumption.

Based on the aforementioned embodiments, pixels connected to a same trigger pulse generator perform synchronous exposure, and pixels connected to different trigger pulse generators perform either synchronous or asynchronous exposure.

It is readily conceivable that if a trigger pulse generator is designed inside a pixel, the trigger pulse generator can independently and adaptively adjust a time for calculating the spatiotemporal difference signals, based on the light intensity level perceived by that specific pixel itself; consequently, the trigger times for each pixel may differ. The pixel may output information at any arbitrary time, enhancing flexibility and reducing output latency.

Therefore, the present application supports a configuration where all pixels within an array share a single trigger pulse generator; in such a scenario, only full-array synchronous exposure can be implemented.

The present application further supports a configuration where one trigger pulse generator is used for each pixel inside the pixel array, allowing the exposure mode to be configured as either synchronous or asynchronous exposure according to specific requirements.

The present application further supports a configuration where a plurality of pixels constitutes a single “macroblock” to share an intra-pixel pulse trigger generator, reducing the complexity of the chip design and minimize an occupied area of the chip. In this configuration, the pixels inside the same macroblock undergo synchronous exposure, while the exposure mode between different macroblocks can be configured as either synchronous or asynchronous according to specific requirements.

Based on the aforementioned embodiments, an exposure mode for each pixel of the pixel array is a global shutter or a rolling shutter.

The temporal differentiator and quantizer of the present application includes a temporal difference calculator and a quantizer; similarly, the spatial differentiator and quantizer includes a spatial difference calculator and a quantizer. Each pixel outputs an electrical signal representing light intensity through the photoreceptive unit. Upon entering a storage node, the electrical signal undergoes either temporal difference calculation or spatial difference calculation, followed by quantization before being output. An order in which the difference calculation and the quantization are performed is interchangeable. That is, two analog signals may first be quantized into digital signals, and the difference calculation is performed in the digital domain; or the difference calculation may first be performed on the analog signals in the analog domain and the resulting difference is quantized into a digital signal.

The traditional vision sensors typically necessitate the integration of DVS with a CMOS image sensor (CIS) that offers high spatial resolution and superior image quality since it is difficult for solely DVC to implement generalized visual perception. For example, the vision sensors include a DAVIS camera and a cameras based on a hybrid pixel array. The DAVIS camera combines CIS and DVS; within this architecture, output current from a single photodiode (PD, responsible for converting incident light into electrical current) is simultaneously used by both a APS circuit and a DVS circuit to simultaneously capture single-frame images (based on frame-based sampling) and record event-based information (based on event-based sampling). Consequently, the DAVIS camera may have the respective advantages of both technologies: the high image quality characteristic of CIS sensors and the high temporal resolution characteristic of DVS cameras. However, the DAVIS camera has several inherent limitations as outlined below:
1, the DAVIS camera inherits a fundamental drawback from DVS technology: limited precision of single-value signals; and
2. lack of Spatial Difference Information.

In case that a scene contains large-scale flashes or undergoes drastic changes in light intensity, all TD pixels simultaneously output events, leading to saturation. Consequently, the DVS pathway is unable to output valid information, while the CIS pathway is likewise unable to respond in real time due to be constrained by its frame rate. Such extreme scenarios are highly prevalent in autonomous driving environments and are critical to driving safety, for examples, the scenarios include entering or exiting tunnels, or encountering flashes from traffic enforcement cameras at night. In other words, from the perspective of visual primitives, a vision sensor provided solely with CIS and DVS pathways provides an incomplete acquisition of information. In contrast, a human visual system whether at high noon or at dusk, and whether operating in an open environment or a partially occluded scene is capable of rapidly identifying moving targets, achieving a level of robustness and versatility far exceeding that of the traditional DAVIS. This superior performance stems from the human eye's capability to construct efficient and robust visual representations by integrating various distinct visual primitives.

The DVS, however, can only output information regarding the temporal changes in visual signals; this information is highly susceptible to interference and lacks spatial difference information.

On this basis, according to the present application, there is provided a vision sensor chip, including a pixel array composed of pixels;
for each pixel, the pixel is provided with an intensity pathway, a temporal difference pathway and a spatial difference pathway corresponding to each pixel;
the intensity pathway is configured to output a quantized value of an output value of a photoreceptive subunit inside the pixel at a current time;
the temporal difference pathway is configured to output a temporal difference value of the pixel;
the spatial difference pathway is configured to output a spatial difference value of the pixel;
the temporal difference value is a result obtained by performing difference and quantization operations on output values of a photoreceptive subunit within the pixel at a current time and at a previous time;
the spatial difference value is a result obtained by performing difference and quantization operations on an output value of the photoreceptive subunit at the current time and an output value of the target photoreceptive subunit at the current time; and
a pixel where the target photoreceptive subunit is located is any pixel among the pixel array other than the pixel.

In an embodiment, a vision sensor with tri-pathway output is implemented in the present application. The three pathways are a light intensity quantization pathway, a TD pathway and an SD pathway, respectively.

The light intensity quantization pathway outputs a quantized result, denoted as A(x,y,tₙ), of an output value generated at time tₙ by the photosensitive unit located inside a current pixel (x,y), which is expressed by the following equation:

$$A ( x , y , {t}_{n} ) = Q ( I ( x , y , {t}_{n} ) )$$

Q represents a quantization method used by the intensity pathway.

Signals for the light intensity quantization pathway are three-dimensional quantities, including spatial two-dimensional quantities x and y and a temporal dimension t.

The description associated with the TD and SD pathways correspond to those of the TD and SD pathways within the pixels of the visual sensor chip described above; and therefore, the TD and SD pathways are not described in detail here.

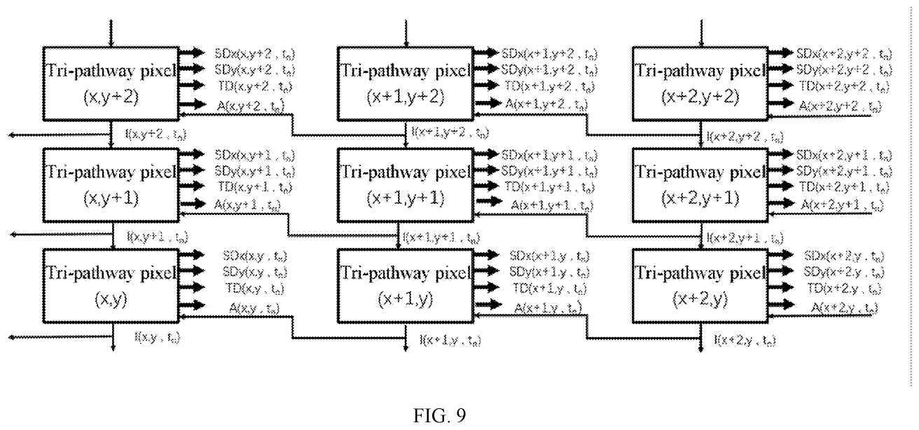

FIG. 9 is a schematic structural diagram of a corresponding vision sensor chip, which illustrates an example where a first pixel and a second pixel are (x+1,y) and (x,y+1), respectively.

The vision sensor chip according to the present application bins a spatial difference pathway analogous to that found in the human retina into the pixel of a traditional visual sensor previously containing only temporal difference pathway and a color pathway, significantly enhances the capability of visual sensor to perform high-precision reconstruction of spatiotemporal dynamic information and enabling the generation of efficient and robust visual representations.

Based on the aforementioned embodiments, the intensity pathway includes the photoreceptive subunit, a first unit and an intensity quantizer provided inside the pixel, or includes the photoreceptive subunit, a differential storage subunit provided inside the pixel, a frequency-division strober, and an intensity quantizer provided inside the pixel;
the temporal difference pathway includes the photoreceptive subunit, the differential storage subunit, and a temporal differentiator and quantizer;
the spatial difference pathway includes the photoreceptive subunit, the differential storage subunit, and a spatial differentiator and quantizer;
where the temporal differentiator and quantizer is provided inside the pixel, or is provided outside the pixel and shared by the pixel and other pixels located in a same column;
the spatial differentiator and quantizer is provided inside the pixel, or is provided outside the pixel and shared by the pixel and other pixels located in a same column;
the intensity quantizer is provided inside the pixel, or is provided outside the pixel and shared by the pixel and other pixels located in a same column;
the photoreceptive subunit is configured to convert intensity of light incident at the pixel at the current time into an electrical signal and output the electrical signal;
the differential storage subunit is configured to write the output value of the photoreceptive subunit at the current time; where the differential storage subunit includes a first storage node and a second storage node, and is configured to write the output value of the photoreceptive subunit at the current time into the second storage node or the first storage node in case that the output value of the photoreceptive subunit at the previous time is stored in the first storage node or the second storage node;
the first unit is configured to send, in case that the photoreceptive subunit uses the rolling shutter, the output value of the photoreceptive subunit at the current time into an intensity quantizer; and buffer and output, in case that the photoreceptive subunit does not use the rolling shutter, the current output value of the photoreceptive subunit at the current time.

The frequency-division strober is configured to perform low-frequency sampling on the current output value of the photoreceptive subunit written by the differential storage subunit. It can be understood that by the configuration of the frequency-division strobe, the pixel eliminates the need to allocate a dedicated storage node for the intensity channel and can directly obtain storage information from the storage subunit for difference. The frequency-division strober is configured to perform low-frequency sampling. Assuming the difference pathway array operates at 600 fps, the data update rate for the first and second storage nodes-due to the ping-pong storage configuration—is 300 Hz. Since the light intensity quantizer operates at 30 fps, the frequency-division strober simply needs to downsample the signal by a factor of ten (meaning that for every ten signals received, the gating unit outputs only one while discarding the remaining nine).

The intensity quantizer is configured to quantize and output an output value of the first unit;
the temporal differentiator and quantizer is configured to calculate and output the temporal difference value; and
the spatial differentiator and quantizer is configured to calculate and output the spatial difference value based on the output value of the target photoreceptive subunit at the current time.

In other words, in case that the intensity pathway includes the photoreceptive subunit, the first unit provided inside the pixel, and the intensity quantizer, eight types of structures of a pixel are provided depending on whether the temporal differentiator and quantizer, the spatial difference and quantizer and the intensity quantizer are provided inside the pixel.

Type A, all the temporal differentiator and quantizer, the spatial differentiator and quantizer and the intensity quantizer are provided inside the pixel.

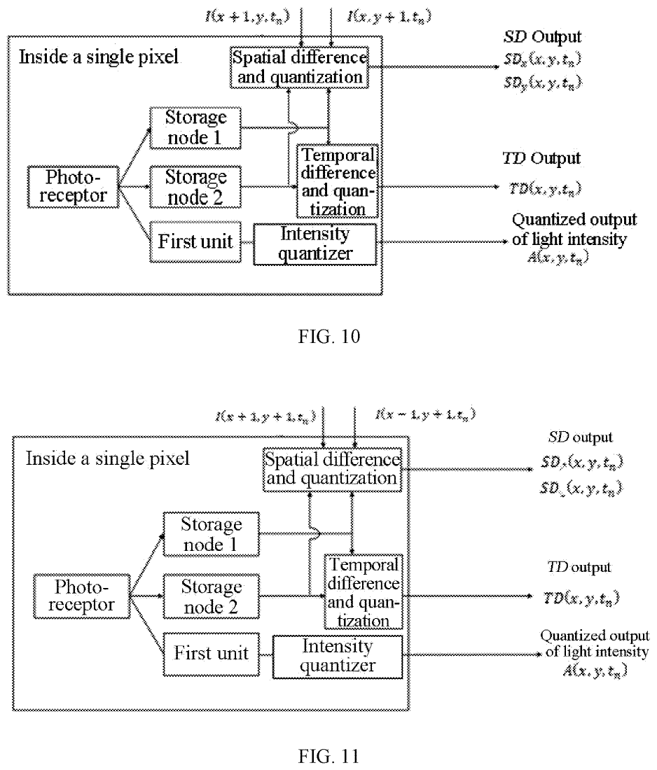

FIG. 10 and FIG. 11 are schematic structural diagrams of a pixel inside which both a temporal differentiator and quantizer, a spatial differentiator and quantizer and an intensity quantizer are provided. FIG. 10 illustrates an example where a first pixel and a second pixel are (x+1,y) and (x,y+1), respectively. FIG. 11 illustrates an example where a first pixel and a second pixel are (x−1,y+1) and (x+1,y+1), respectively.

Type B, the intensity quantizer is provided inside the pixel and the temporal differentiator and quantizer and the spatial differentiator and quantizer are provided outside the pixel.

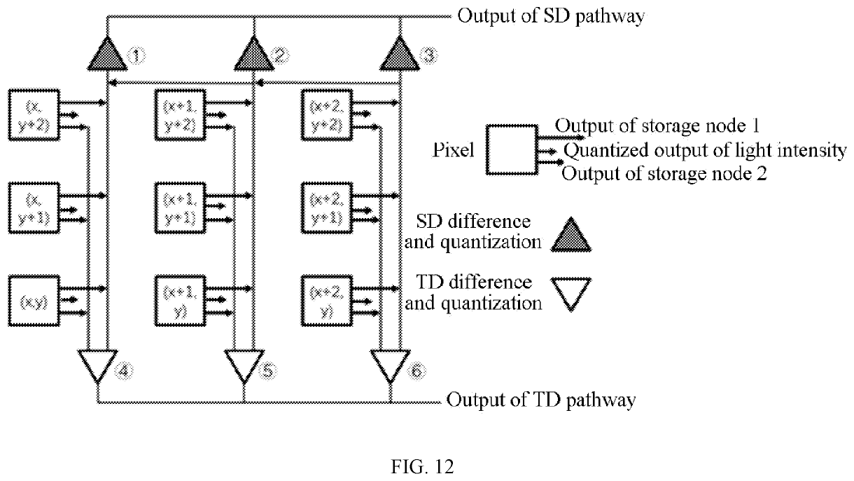

FIG. 12 is a schematic structural diagram of a pixel outside which both a temporal differentiator and quantizer and a spatial differentiator and quantizer are provided and inside which an intensity quantizer is provided and illustrates an example where a first pixel and a second pixel are (x+1,y) and (x,y+1), respectively. A principle remains the same for examples where the first and second pixels are (x+1,y+1) and (x−1,y+1), respectively and therefore it is not described further in detail here.

Type C, the temporal differentiator and quantizer is provided inside the pixel and the spatial differentiator and quantizer and the intensity quantizer are provided outside the pixel;

Type D, the spatial differentiator and quantizer is provided inside the pixel and the temporal differentiator and quantizer and the intensity quantizer are provided outside the pixel;

Type E, all the temporal differentiator and quantizer and the spatial differentiator and quantizer are provided inside the pixel and the intensity quantizer is provided outside the pixel;

Type F, the temporal differentiator and quantizer and the intensity quantizer are provided inside the pixel and the spatial differentiator is provided outside the pixel;

Type G, the spatial differentiator and quantizer and the intensity quantizer are provided inside the pixel and the temporal differentiator and quantizer is provided outside the pixel; and

Type H, all the temporal differentiator and quantizer, the spatial differentiator and quantizer and the intensity quantizer are provided outside the pixel.

The structures of the pixels corresponding to type C to type H are analogous in function and therefore, they will not be described in further detail here.

In case that the intensity path includes the photoreceptive subunit, a differential storage subunit provided inside the pixel, the frequency-division strober, and an intensity quantizer provided inside the pixel, eight types of structures of a pixel are provided depending on whether the temporal differentiator and quantizer, the spatial difference and quantizer and the intensity quantizer are also provided inside the pixel.

Type I, all the temporal differentiator and quantizer, the spatial differentiator and quantizer and the intensity quantizer are provided inside the pixel.

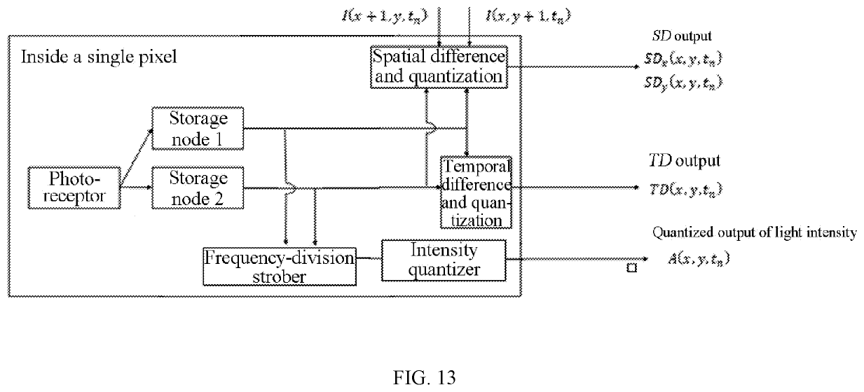

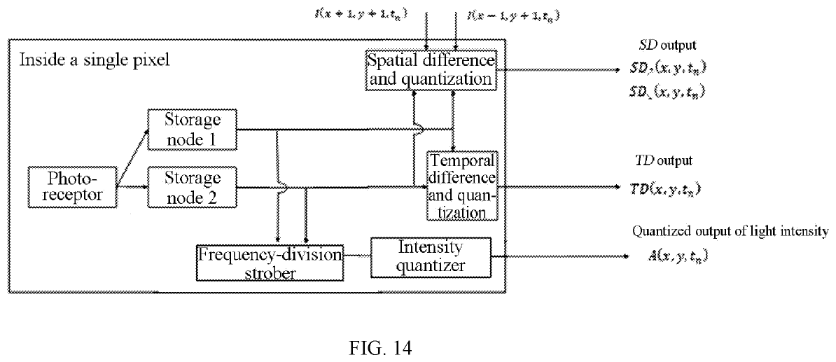

FIG. 13 and FIG. 14 are schematic structural diagrams of a pixel inside which both a temporal differentiator and quantizer, a spatial differentiator and quantizer and an intensity quantizer are provided. FIG. 13 illustrates an example where a first pixel and a second pixel are (x+1,y) and (x,y+1), respectively. FIG. 14 illustrates an example where a first pixel and a second pixel are (x−1,y+1) and (x+1,y+1), respectively.

Type II, all the temporal differentiator and quantizer and the spatial differentiator and quantizer are provided inside the pixel and the intensity quantizer is provided outside the pixel;

Type III, the temporal differentiator and quantizer and the intensity quantizer are provided inside the pixel and the spatial differentiator is provided outside the pixel;

Type IV, the spatial differentiator and quantizer and the intensity quantizer are provided inside the pixel and the temporal differentiator and quantizer is provided outside the pixel;

Type V, the temporal differentiator and quantizer is provided inside the pixel and the spatial differentiator and quantizer and the intensity quantizer are provided outside the pixel;

Type VI, the spatial differentiator and quantizer is provided inside the pixel and the temporal differentiator and quantizer and the intensity quantizer are provided outside the pixel;

Type VII, the intensity quantizer is provided inside the pixel and the temporal differentiator and quantizer and the spatial differentiator and quantizer are provided outside the pixel; and

Type VIII, all the temporal differentiator and quantizer, the spatial differentiator and quantizer and the intensity quantizer are provided outside the pixel.

The structures of the pixels corresponding to type II to type VIII are analogous in function and therefore, they will not be described in further detail here.

It should be noted that, in the aforementioned eight types, the output values I(x,y,tₙ) and I(x,y,tₙ₋₁) of the photoreceptive subunits within a given pixel (x,y) at time tₙ and the previous time tₙ₋₁, respectively are simultaneously input into the frequency-division strober and the frequency-division strober selects I(x,y,tₙ) while I(x,y,tₙ₋₁) is discarded through an internal selector and then performs spatial difference and quantization operation.

It is noted that identical to the temporal differentiator and quantizer and the spatial differentiator and quantizer, a quantization mode used by the intensity quantizer is the ADC quantization and the multi-bit ADC quantization with the sign bit (where positive and negative signs indicate signal enhancement or attenuation, respectively) is preferably used.

Based on the aforementioned embodiments, an output of the intensity pathway is a grayscale value or a color value;
in case that the output of the intensity pathway is the color value, an externally programmable demosaicer is embedded within the temporal differentiator and quantizer or the spatial differentiator and quantizer and is configured to determine output values of all color pathways of the pixel based on color values output from intensity pathways inside the pixel and surrounding pixels before the temporal difference value or the spatial difference value is calculated.

The CIS perceives visible light of different wavelengths through covering the pixel array with a color filter array (CFA), generating color images. The CFA typically includes filters of three colors—red, green, and blue—hence the color pathway is sometimes simply referred to as “RGB”. These three types of color filters are typically arranged in a Bayer pattern. However, other types of CFAs are also present, for instance, the CMY array based on three complementary colors (cyan, magenta, and yellow) and offers higher light transmittance. The present invention may be implemented without a CFA; in this configuration, the light intensity quantization pathway outputs grayscale values. In an embodiment, a CFA (e.g., an RGB color filter array) may be added, and the light intensity quantization pathway outputs color values in this case.

If the intensity pathway outputs color values, the corresponding pixels are covered with color filters. In this scenario, the output values of the photoreceptive subunits inside the temporal and spatial difference pathways contain information of only a single specific color pathway. Typically, for instance, in the case of red, green, and blue pathways, the pixels within the pixel array contains information corresponding to three colors (i.e., red, green, or blue).

Prior to performing temporal difference or spatial difference operations, a demosaicing operation is performed on all color. Specifically, for a pixel of color X, corresponding output values for color Y are obtained based on pixels of colors Y surrounding the pixel of color X and corresponding output values for color Z are obtained based on pixels of colors Z surrounding the pixel of color X. In this manner, each pixel has been assigned output values for all three color pathways and standard spatial difference operation can be then performed.

In the present invention, an externally programmable demosaicer is embedded within the temporal differentiator and quantizer or the spatial differentiator and quantizer and the demosaicing operation is performed using a demosaicing algorithm inside the demosaicer.

The demosaicing algorithm is not unique and can be implemented by selecting two, four, or even sixteen surrounding pixels.

In case that difference and quantization units are arranged in columns, the demosaicer can also be configured independently within each pixel.

In an embodiment, no demosaicer needs to be introduced and a spatial difference operation can be performed directly on the color pathway corresponding to the current pixel. Difference operation can be performed between pixels of the same color pathway (e.g., an X-colored pixel against another X-colored pixel) or between pixels of different color pathways (e.g., an X-colored pixel against a Y-colored pixel), and additional algorithmic post-processing is performed.

Based on the aforementioned embodiments, each pixel of the pixel array is provided with a trigger pulse generator; or
all pixels in the pixel array are collectively connected to one trigger pulse generator; or
the pixel array is partitioned into a plurality of sub-regions and all pixels in each sub-region are collectively connected to one trigger pulse generator;
where the trigger pulse generator is configured to generate a trigger signal at a fixed time interval, or at adaptive, programmable, and variable intervals to control a exposure time of a corresponding photoreceptive subunit.

Based on the aforementioned embodiments, pixels connected to a same trigger pulse generator perform synchronous exposure, and pixels connected to different trigger pulse generators perform either synchronous or asynchronous exposure.

Based on the aforementioned embodiments, an exposure mode for each pixel of the pixel array is a global shutter or a rolling shutter.

The aforementioned process is identical to the process described regarding the vision sensor chip and is not described in detail here.

The vision sensor chip described in the present application is connected to an image processor. The image processor may be integrated onto a same chip with the pixel array, or may be provided externally on a computer or other device and is configured to process the output signals generated by the chip.

The CIS captures video through a frame-based sampling principle, that is, outputs of all pixels within a pixel array are recorded in every frame of image of the CIS, and each frame is captured at equal time intervals. The CIS integrate transistors directly inside the pixels to perform high-performance charge-to-voltage conversion. The CIS can perceive visible light of different wavelengths through covering the pixel array with a color filter array (CFA), generating color images. The CIS offers distinct advantages, including high pixel array resolution, high degree of color reproduction, and superior image quality. A dynamic vision sensor (DVS) represents a novel type of imaging system. Unlike traditional cameras employing a shutter to control the frame rate and recording light intensity across all pixels on a per-frame basis, the DVS is sensitive to the rate of change in light intensity. Each pixel independently records the logarithmic change in light intensity at its specific location; and the pixel generates either a positive or a negative pulse in case that this change exceeds a predetermined threshold. The DVS is not controlled by the shutter due to characteristic of asynchronous pulse generation and thus has exceptionally high temporal resolution. In case that combined with its inherent sensitivity to change, the DVS naturally adapts to tasks such as motion detection. Another type of camera, known as DAVIS, integrates traditional CIS technology with DVS capabilities and is capable of simultaneously capturing discrete image frames and recording event-based information, combining the high spatial resolution advantages of traditional cameras with the high temporal resolution advantages of the DVS cameras.

From the perspective of visual primitives, a vision sensor provided solely with CIS and DVS pathways provides an incomplete acquisition of information. For example, in case that a scene contains large-scale flashes or undergoes drastic changes in light intensity, all TD pixels simultaneously output events, leading to saturation. Consequently, the DVS pathway is unable to output valid information, while the CIS pathway is likewise unable to respond in real time due to be constrained by its frame rate. Such extreme scenarios are highly prevalent in autonomous driving environments and are critical to driving safety, for examples, the scenarios include entering or exiting tunnels, or encountering flashes from traffic enforcement cameras at night.

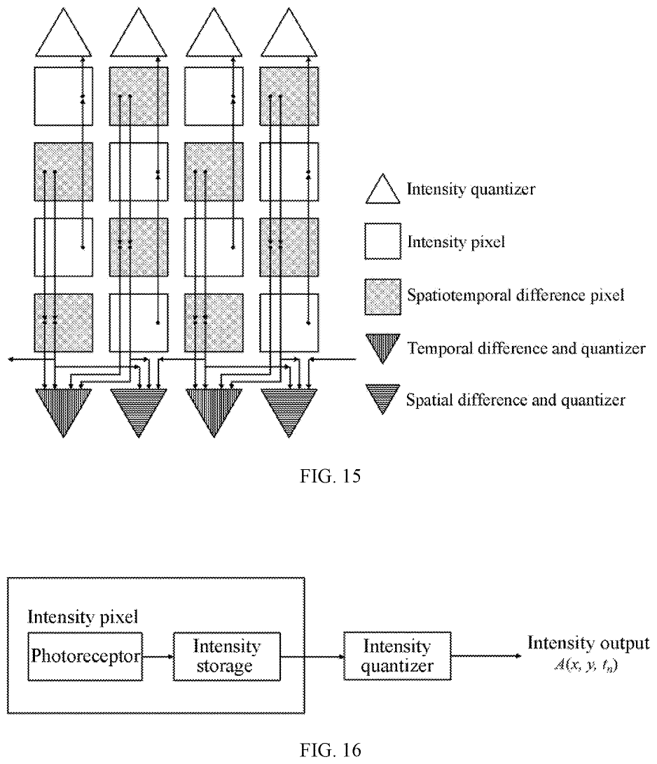

Reference is made to FIG. 15 and FIG. 15 is a first schematic architecture diagram of a vision sensor chip based on a hybrid array according to the present application.

Reference is made to FIG. 16 and FIG. 16 is a first schematic principle diagram of reading out a quantized value of an electrical signal converted from intensity of incident light of an intensity pixel according to the present application.

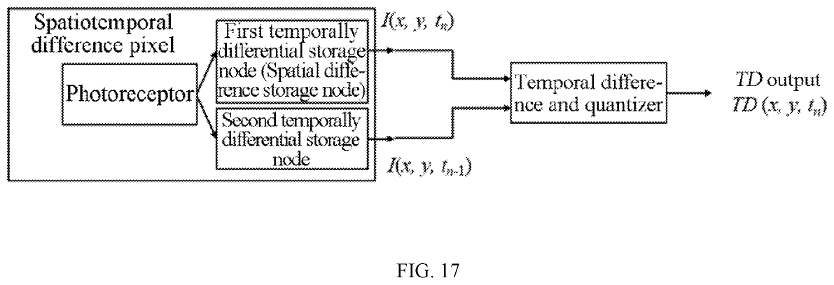

Reference is made to FIG. 17 and FIG. 17 is a first schematic principle diagram of reading out a temporal difference value of a spatiotemporal difference pixel according to the present application.

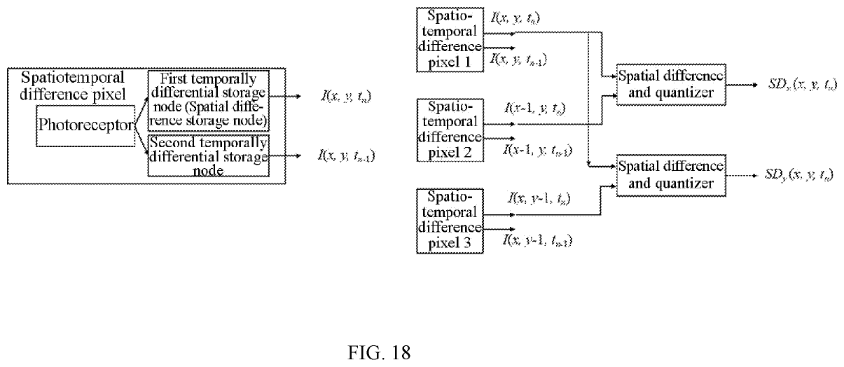

Reference is made to FIG. 18 and FIG. 18 is a first schematic principle diagram of reading out a spatial difference value of a spatiotemporal difference pixel according to the present application.

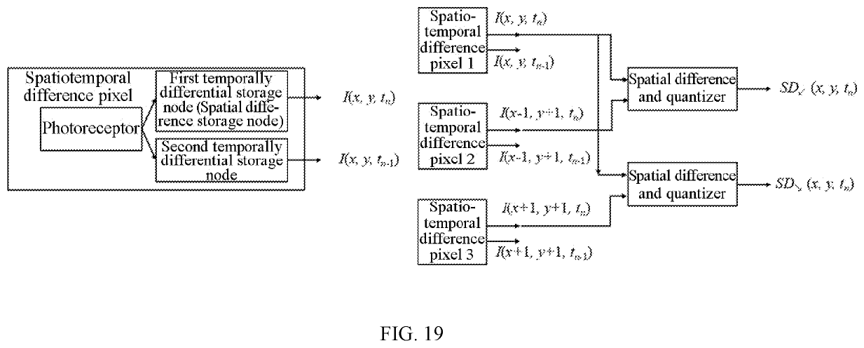

Reference is made to FIG. 19 and FIG. 19 is a second schematic principle diagram of reading out a spatial difference value of a spatiotemporal difference pixel according to the present application.

To address the problems in the related art, according to the present application, there is provided a vision sensor chip based on a hybrid array, including a pixel array and a vision sensing pathway corresponding to the pixel array; where the vision sensing pathway includes an intensity pathway, a temporal difference pathway, and a spatial difference pathway; and the pixel array includes a plurality of multiplexed pixels and a plurality of single pixels; the plurality of multiplexed pixels are pixels multiplexing two elements selected from intensity, temporal difference and spatial difference; the plurality of single pixels are pixels with an element different from the two elements of the multiplexed pixels; the intensity pathway is configured to determine a quantized value of an electrical signal converted from intensity of incident light at a position of a current pixel at a current time; the temporal difference pathway is configured to perform temporal difference and quantization operations in a charge domain, an analog domain, or a digital domain on a signal at the position of the current pixel at the current time and a signal at the position of the current pixel at a previous time to obtain a temporal difference value; the spatial difference pathway is configured to perform spatial difference and quantization operations in the charge domain, the analog domain, or the digital domain on the signal at the position of the current pixel at the current time and a signal at a position of a spatially associated pixel at the current time to obtain a spatial difference value, where the spatially associated pixel refers to any one or more pixels within the pixel array other than the current pixel.

In contrast, a human visual system whether at high noon or at dusk, and whether operating in an open environment or a partially occluded scene—is capable of rapidly identifying moving targets. A level of robustness and versatility far exceeding that of the traditional DAVIS is achieved. This superior performance stems from the fact that, in addition to intensity and temporal difference pathways, the human eye also possesses a spatial difference pathway; these three pathways integrate organically to form distinct visual primitives, generating highly efficient and robust visual representations. Inspired by human vision, a spatial difference pathway-analogous to that found in the human retina is added into traditional solutions based on single-pixel multiplexing or hybrid pixel arrays according to the present application. Specifically, the visual sensor simultaneously generates three distinct outputs: an intensity output, a temporal difference (TD) output, and a spatial difference (SD) output.

The intensity pathway outputs a quantized value of intensity I(x,y,tₙ) of incident light at a position of a current pixel (x,y) at a current time ty, that is,

$$A ( x , y , {t}_{n} ) = {Q}_{A} ( I ( x , y , {t}_{n} ) )$$

Q_{A} represents a quantization method used by the intensity pathway.

The temporal difference pathway outputs the temporal difference values at the position of the current pixel (x,y) at different times and the output generated by the temporal difference pathway is expressed by the following equation:

$$TD ( x , y , {t}_{n} ) = {Q}_{TD} ( I ( x , y , {t}_{n} ) - I ( x , y , {t}_{n - 1} ) )$$

where Q_{TD} represents a quantization method used by the temporal difference pathway.

The spatial difference pathway outputs the spatial difference value between the position of the current pixel (x,y) and positions of spatially correlated pixels (e.g., pixels provided diagonally or along the x-axis and y-axis) at the current time ty

$${SD}_{j} ( x , y , {t}_{n} ) = {Q}_{SD} ( I ( x , y , {t}_{n} ) - I ( {x}_{i} , {y}_{i} , {t}_{n} ) )$$

where Q_{SD} represents a quantization method used by the spatial difference pathway; in the above equation, SDᵢ denotes spatial difference value between the current pixel and an associated pixel (xᵢ,yᵢ).

All signals involved in the three visual sensing pathway are three-dimensional quantities, including spatial two-dimensional quantities x and y and a temporal dimension t.

Pixels inside the pixel array may take the following forms:
the pixel array constitutes a binary hybrid pixel array composed of a plurality of multiplexed pixels and a plurality of single pixels;
each of the plurality of multiplexed pixels is a pixel multiplexing intensity and temporal difference and each of the plurality of single pixels is a spatial difference pixel; or
each of the plurality of multiplexed pixels is a pixel multiplexing intensity and spatial difference and each of the plurality of single pixels is a temporal difference pixel; or
each of the plurality of multiplexed pixels is a pixel multiplexing temporal difference and spatial difference and each of the plurality of single pixels is an intensity pixel; or
the pixel array is a ternary hybrid pixel array composed independently of a plurality of intensity pixels, a plurality of temporal difference pixels and a plurality of spatial difference pixels.

Since the visual sensor chip according to the present application features a tri-pathway visual sensing architecture, simultaneously providing intensity output, temporal difference output, and spatial difference output, the capability of the vision sensor chip to perceive temporal-spatial dynamic information is significantly enhanced and high-precision, high-frame-rate, high-dynamic-range, efficient and robust visual representation are enabled.

Based on the embodiment above, the multiplexed pixels are pixels multiplexing temporal difference and spatial difference, and the single pixels are intensity pixels; the intensity pathway corresponds to the intensity pixels, while the temporal difference pathway and the spatial difference pathway correspond to the pixels multiplexing temporal difference and spatial difference, respectively.

According to the embodiment of the present application, there is provided a tri-pathway vision sensor based on a hybrid pixel, wherein the pixel array includes an intensity pixel and a pixel multiplexing both temporal difference and spatial difference (referred to as a spatiotemporal difference pixel). A quantized value of intensity of incident light of the intensity pixel is read out through an intensity pathway; a temporal difference value of the spatiotemporal difference pixel is read out through a temporal difference pathway; and a spatial differential value is read out through a spatial difference pathway.

In an embodiment, the intensity pathway includes an intensity storage and an intensity quantizer; the intensity storage is configured to store an electrical signal converted from intensity of incident light at a position of a current pixel at a current time; the intensity quantizer is configured to perform an analog-to-digital conversion on the electrical signal converted from the intensity of incident light at the position of the current pixel at the current time to obtain the quantized value of the electrical signal converted from the intensity of incident light at the position of the current pixel at the current time; the temporal difference pathway includes a temporally differential storage and a temporal differentiator and quantizer; the temporally differential storage is configured to store electrical signals at the position of the current pixel at different times using a ping-pong buffering mode; the temporally differential storage includes a first temporally differential storage node and a second temporally differential storage node; the ping-pong buffering mode is configured to store the electrical signal at the position of the current pixel at the current time in the second temporally differential storage node or the first temporally differential storage node in case that an electrical signal at the position of the current pixel at a previous time is stored in the first temporally differential storage node or the second temporally differential storage node; the temporal differentiator and quantizer is configured to perform temporal difference and quantization operations on the electrical signal at the position of the current pixel at the current time and the electrical signal at the position of the current pixel at the previous time to obtain a temporal difference value; the spatial difference pathway includes a spatially differential storage node multiplexing the first temporally differential storage node and a spatial differentiator and quantizer; the spatially differential storage node is configured to store the electrical signal at the position of the current pixel at the current time; and the spatial differentiator and quantizer is configured to perform difference and quantization operations on the electrical signal at the position of the current pixel at the current time and an electrical signal at a spatially associated pixel position at the current time to obtain a spatial difference value.

It should be noted that high-speed and low-precision storage nodes may be selected as the first temporally differential storage node and the second temporally differential storage node, while a low-speed and high-precision storage nodes may be selected as the intensity storage. This approach enables a complementary utilization of the respective advantages of these two types of storage nodes and holds the potential to achieve high-speed and high-precision overall performance at a relatively low cost in combined with post-processing. For a given pixel, the first temporally differential storage node and the second temporally differential storage node use a ping-pong alternating storage mode to store information corresponding to different times. The ping-pong buffering means that if the electrical signal of a pixel is stored in the first temporally differential storage node at the current time, stored in the second temporally differential storage node at the subsequent time, and then stored back in the first temporally differential storage node at the next time-continuing in this alternating fashion to output signals at two times (I(x,y,tₙ), I(x,y,tₙ₋₁)).

The intensity quantizer may be provided either outside or inside the intensity pixel. Similarly, the temporal differentiator and quantizer, as well as the spatial differentiator and quantizer may be provided either outside or inside the spatiotemporal difference pixel.

In the present embodiment, the intensity quantizer is illustrated as being provided outside the intensity pixel, while the temporal differentiator and quantizer as well as the spatial differentiator and quantizer are illustrated as being provided outside the spatiotemporal difference pixel.

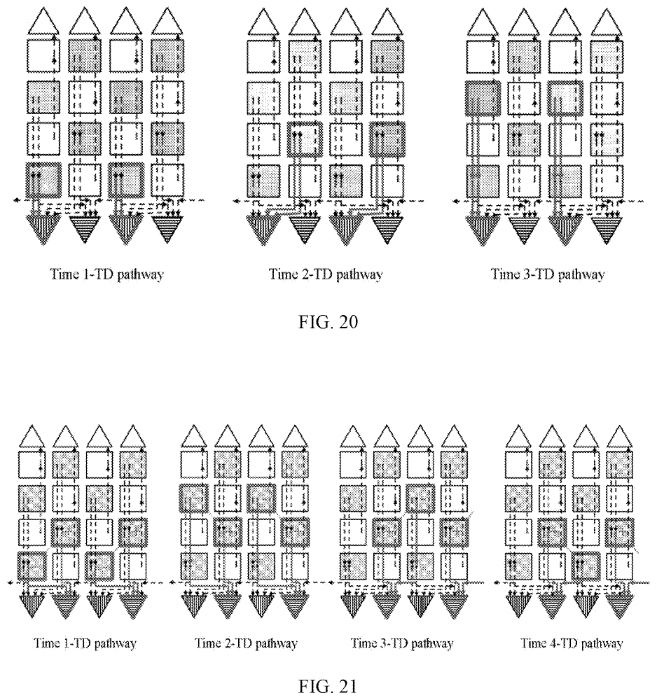

Reference is made to FIG. 20 and FIG. 20 is a schematic principle diagram of reading out a temporal difference value of a spatiotemporal difference pixel according to the present application.

In case that the temporal difference values are read out, the number of available temporal differentiator and quantizers and a plurality of spatiotemporal difference pixels sharing a single temporal differentiator and quantizer are taken into account. A single time is divided into a plurality of sub-times: t₁, t₂, t₃, and so forth, the temporal difference values of the spatiotemporal difference pixels located at a first region may be read out at the sub-time t₁; the temporal difference values of the spatiotemporal difference pixels located at a second region may be read out at the sub-time t₂; the temporal difference values of the spatiotemporal difference pixels located at a third region may be read out at the sub-time t₃, and so forth. In this manner, the temporal difference values of all spatiotemporal difference pixels inside the pixel array may be read out. In the figure, the squares with bolded borders represent the pixels currently being read out during the specific sub-time.

Reference is made to FIG. 21 and FIG. 21 is a schematic principle diagram of reading out a spatial difference value of a spatiotemporal difference pixel according to the present application.

In case that the spatial difference values are read out, the number of available spatial differentiator and quantizers and a plurality of spatiotemporal difference pixels sharing a single spatial differentiator and quantizer are taken into account. A single time is divided into a plurality of sub-times: t₁, t₂, t₃ t₄, and so forth, the spatial difference values of the spatiotemporal difference pixels located at a first region may be read out at the sub-time t₁; the spatial difference values of the spatiotemporal difference pixels located at a second region may be read out at the sub-time t₂; the spatial difference values of the spatiotemporal difference pixels located at a third region may be read out at the sub-time t₃, the spatial difference values of the spatiotemporal difference pixels located at a fourth region may be read out at the sub-time t₄, and so forth. In this manner, the spatial difference values of all spatiotemporal difference pixels inside the pixel array may be read out. In the figure, the squares with bolded borders represent the pixels currently being read out during the specific sub-time.

There are various options for selecting the pixels at spatially associated positions; for example, the pixels located at positions in the x and y directions adjacent to the current pixel, or the pixels located at positions diagonally adjacent to the current pixel.

For differences in the x and y directions, the outputs obtained from the spatial difference pathways are expressed by the following equations:

$${SD}_{x} ( x , y , {t}_{n} ) = {Q}_{SD} ( I ( x , y , {t}_{n} ) - I ( x - 1 , y , {t}_{n} ) )$$

$${SD}_{y} ( x , y , {t}_{n} ) = {Q}_{SD} ( I ( xy , {t}_{n} ) - I ( x , y - 1 , {t}_{n} ) )$$

for diagonal differences, the outputs obtained from the spatial difference pathways are expressed by the following equations:

$${SD}_{↙} ( x , y , {t}_{n} ) = {Q}_{SD} ( I ( x , y , {t}_{n} ) - I ( x - 1 , y - 1 , {t}_{n} ) )$$

$${SD}_{↘} ( x , y , {t}_{n} ) = {Q}_{SD} ( I ( x , y , {t}_{n} ) - I ( x + 1 , y - 1 , {t}_{n} ) )$$

furthermore, alternative forms may be selected. For instance, adjacent pixels in a specific direction are solely selected for performing difference to obtain difference information for that particular direction, or more than two associated pixels may also be simultaneously selected to improve the precision of spatial difference.

Quantization modes used by both the temporal differentiator and quantizer and the spatial differentiator and quantizer may be either multi-valued (>1 bit) or single-valued (positive and negative pulses). Times at which signals are obtained may be obtained through a full-array synchronization mode with a same time interval, full-array synchronization mode with a variable time interval or full-array synchronization mode.

In the field of digital signal processing, quantization mainly refers to a process of converting analog signals into digital signals. Sampling and quantization of signals are typically performed by an analog-to-digital converter (ADC).

In an embodiment, the intensity quantizer is provided inside the intensity pixel and uses a pixel-level signal readout mode; or the intensity quantizer is provided outside the intensity pixel and shared by another intensity pixel located in a same column and uses a column-level signal readout mode; the temporal differentiator and quantizer is provided inside a pixel multiplexing the temporal difference and the spatial difference and uses the pixel-level signal readout mode; or the temporal differentiator and quantizer is provided outside the pixel multiplexing the temporal difference and the spatial difference, and shared by a pixel multiplexing the temporal difference and the spatial difference located in a same column and uses the column-level signal readout mode; and the spatial differentiator and quantizer is provided inside a pixel multiplexing the temporal difference and the spatial difference and uses the pixel-level signal readout mode; or is provided outside a pixel multiplexing the temporal difference and the spatial difference, and shared by a pixel multiplexing the temporal difference and the spatial difference located in a same column and uses the column-level signal readout mode.

In the present embodiment, if the temporal differentiator and quantizer and the spatial differentiator and quantizer are provided outside the spatiotemporal difference pixel, a total number of quantizers is reduced, lowering hardware resource consumption. If the temporal differentiator and quantizer and the spatial differentiator and quantizer are provided inside the spatiotemporal difference pixel, flexibility is enhanced and output latency is reduced.

The present application pertains to a hybrid array including two different types of pixels, or a hybrid array including three different types of pixels. The arrangement method for such a hybrid array is not unique; for instance, the arrangement shown in FIG. 5 is also possible in addition to the arrangement shown in FIG. 1.

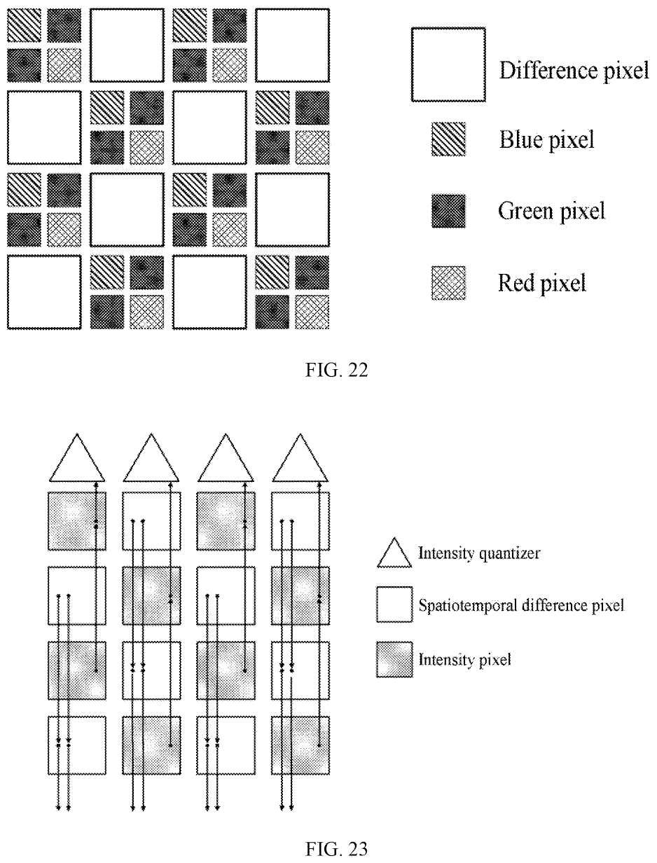

Reference is made to FIG. 22 and FIG. 22 is a second schematic architecture diagram of a vision sensor chip based on a hybrid array according to the present application.

Reference is made to FIG. 23 and FIG. 23 is a third schematic architecture diagram of a vision sensor chip based on a hybrid array according to the present application.

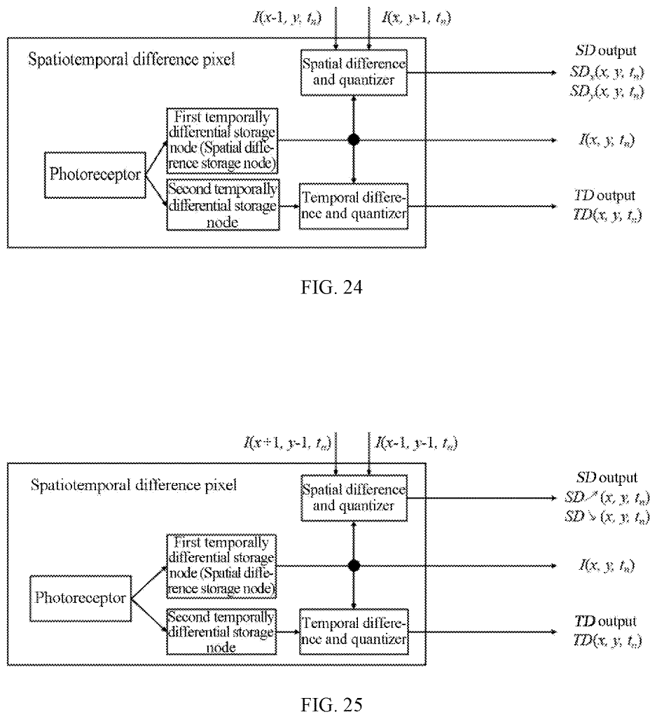

Reference is made to FIG. 24 and FIG. 24 is a third schematic principle diagram of reading out a temporal difference value and a spatial difference value of a spatiotemporal difference pixel according to the present application; and

Reference is made to FIG. 25 and FIG. 25 is a fourth schematic principle diagram of reading out a temporal difference value and a spatial difference value of a spatiotemporal difference pixel according to the present application.

The intensity quantizer of the visual sensor chip is provided outside the intensity pixel, whereas both the temporal differentiator and quantizer and the spatial differentiator and quantizer are provided inside the spatiotemporal difference pixel.

In an embodiment, the arrangement of the intensity quantizer being provided outside the intensity pixel and the temporal differentiator and quantizer and the spatial differentiator and quantizer being provided inside or outside the spatiotemporal difference pixel may be arbitrarily combined in the visual sensor chip of the present application; and there is no special limitation thereto in the present application.

In an embodiment, each pixel of the pixel array is provided with one pulse generator; or
all pixels in the pixel array are collectively connected to one pulse generator; or
the pixel array is partitioned into a plurality of sub-regions and all pixels in each sub-region are collectively connected to one pulse generator;
where the pulse generator is configured to generate a trigger signal at a fixed time interval, or at adaptive, programmable, and variable intervals to control a start exposure time and an exposure duration of a corresponding photoreceptor; pixels connected to a same pulse generator perform synchronous exposure, and pixels connected to different pulse generators perform either synchronous or asynchronous exposure; and
the photoreceptor is provided inside the pixel and is configured to convert the light signal at the position of the current pixel into an analog electrical signal.

In the present embodiment, the visual sensor chip further includes a trigger pulse generator. The trigger pulse generator is capable of generating trigger signals to control the exposure of the photoreceptor-specifically, by determining the precise time tₙ at which the signal is obtained. If a trigger pulse generator is designed into each pixel, full-array asynchronous exposure can be adopted. In this scenario, each trigger pulse generator can independently and adaptively adjust the timing for calculating the spatiotemporal difference signals based on level of the light intensity perceived by its own specific pixel; consequently, the trigger time differs for each pixel. The pixel may output information at any arbitrary time, enhancing flexibility and reducing output latency. Even under these circumstances, full-array synchronous exposure can be performed as required. If a group of pixels shares a same trigger pulse generator, synchronous exposure is performed on these specific pixels.

The trigger pulse generator may generate a trigger signal at a same time interval, or at adaptive, programmable, and variable intervals.

If all pixels inside the array share a single trigger pulse generator, simultaneous exposure is performed on all pixels, and the outputs of the pixels must follow a specific pattern.

In an embodiment, an exposure mode for each pixel of the pixel array is a global shutter or a rolling shutter.

Exposure mode, whether global or rolling used by the intensity pathway, the temporal difference pathway, and the spatial difference pathway may be combined in any arbitrary manner and there is no specific limitation thereto herein.

In an embodiment, an output color type of a pathway corresponding to the pixel is a color value in case that the pixel is provided with a color filter and an output color type of a pathway corresponding to the pixel is a grayscale value in case that the pixel is not provided with a color filter.

If a pixel is covered with a color filter, the information obtained by that pixel is limited to the information of a specific color pathway. Typical color filter, a combination of red, green, and blue, is referred to as the RGB type. Other color pathways, such as a CMY array composed of three complementary colors (cyan, magenta, and yellow), may also be employed. Pixels of the same general type may differ in their specific color pathways—for instance, a spatiotemporal difference pixel of color X, a spatiotemporal difference pixel of pathway Y, or a spatiotemporal difference pixel of pathway Z. In case that spatial difference is performed, the spatial difference may be performed either between pixels of the same color or between pixels of different colors (e.g., by subtracting a color X pixel from a color Y pixel).

Furthermore, an externally programmable demosaicer may be embedded within the pixel and output values of all other color pathways at the position of a pixel corresponding to color pathway X are obtained through a demosaicing algorithm, which is achieved through interpolation based on the values of surrounding pixels.

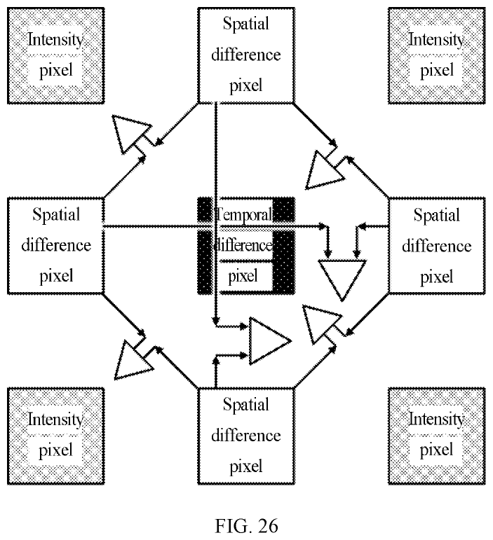

Reference is made to FIG. 26 and FIG. 26 is a fourth schematic architecture diagram of a vision sensor chip based on a hybrid array according to the present application.

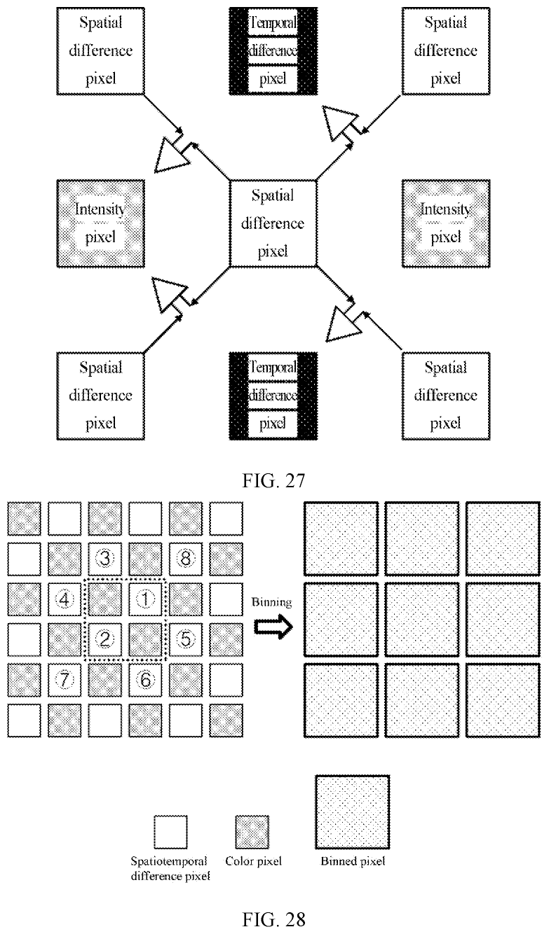

Reference is made to FIG. 27 and FIG. 27 is a fifth schematic architecture diagram of a vision sensor chip based on a hybrid array according to the present application.

According to the present application, there is further provided a vision sensor chip based on a hybrid array, including a pixel array and a vision sensing pathway corresponding to the pixel array; where the vision sensing pathway includes an intensity pathway, a temporal difference pathway, and a spatial difference pathway; the pixel array includes an intensity pixel, a temporal difference pixel, and a spatial difference pixel; the intensity pathway corresponds to the intensity pixel, the temporal difference pathway corresponds to the temporal difference pixel, and the spatial difference pathway corresponds to the spatial difference pixel; the intensity pathway is configured to determine a quantized value of an electrical signal converted from intensity of incident light at a position of a current intensity pixel at a current time; the temporal difference pathway is configured to perform temporal difference and quantization operations in a charge domain, an analog domain, or a digital domain on a signal at the position of the current temporal difference pixel at the current time and a signal at the position of the current temporal difference pixel at a previous time to obtain a temporal difference value; the spatial difference pathway is configured to perform spatial difference and quantization operations in the charge domain, the analog domain, or the digital domain on the signal at the position of the current spatial difference pixel at the current time and a signal at a position of a spatially associated spatial difference pixel at the current time to obtain a spatial difference value, where the spatially associated pixel refers to any one or more pixels within the pixel array other than the current spatial difference pixel.

The main difference between the present embodiment and the aforementioned embodiments of the vision sensor chip lies in the fact that the pixel array of the vision sensor chip is partitioned into three distinct types of pixels: an intensity pixel, the temporal difference pixel, and the spatial difference pixel. The arrangement of these three types of pixels inside the pixel array may be arbitrarily combined; for each specific arrangement, corresponding vision sensing pathways can be configured to enable the high-precision, multi-valued format (≥1 bit) quantization and readout of the incident light intensity values of the intensity pixels, the temporal difference values of the temporal difference pixels, and the spatial difference values of the spatial difference pixels. In the present application, by using a tri-pathway vision sensor chip architecture, the capability of the vision sensor chip to perceive temporal-spatial dynamic information is significantly enhanced and high-precision, high-frame-rate, high-dynamic-range, efficient and robust visual representation are enabled.

In an embodiment, the intensity pathway includes an intensity storage and an intensity quantizer; the intensity storage is configured to store an electrical signal converted from intensity of incident light at a position of a current intensity pixel at a current time; the intensity quantizer is configured to perform an analog-to-digital conversion on the electrical signal converted from the intensity of incident light at the position of the current intensity pixel at the current time to obtain the quantized value of the electrical signal converted from the intensity of incident light at the position of the current intensity pixel at the current time; the temporal difference pathway includes a temporally differential storage and a temporal differentiator and quantizer; the temporally differential storage is configured to store electrical signals at the position of the current pixel at different times using a ping-pong buffering mode; the temporally differential storage includes a first temporally differential storage node and a second temporally differential storage node; the ping-pong buffering mode is configured to store the electrical signal at the position of the current temporal difference pixel at the current time in the second temporally differential storage node or the first temporally differential storage node in case that an electrical signal at the position of the current temporal difference pixel at a previous time is stored in the first temporally differential storage node or the second temporally differential storage node; the temporal differentiator and quantizer is configured to perform temporal difference and quantization operations on the electrical signal at the position of the current temporal difference pixel at the current time and the electrical signal at the position of the current temporal difference pixel at the previous time to obtain a temporal difference value; the spatial difference pathway includes a spatially differential storage node and a spatial differentiator and quantizer; the spatially differential storage node is configured to store the electrical signal at the position of the current spatial difference pixel at the current time; and the spatial differentiator and quantizer is configured to perform difference and quantization operations on the electrical signal at the position of the current spatial difference pixel at the current time and an electrical signal at a spatially associated spatial difference pixel position at the current time to obtain a spatial difference value.

It should be noted that high-speed and low-precision storage nodes may be selected as the first temporally differential storage node and the second temporally differential storage node, while a low-speed and high-precision storage nodes may be selected as the intensity storage. For a given pixel, the first temporally differential storage node and the second temporally differential storage node use a ping-pong alternating storage mode to store information corresponding to different times. The ping-pong buffering means that if the electrical signal of a pixel is stored in the first temporally differential storage node at the current time, stored in the second temporally differential storage node at the subsequent time, and then stored back in the first temporally differential storage node at the next time—continuing in this alternating fashion to output signals at two times ((I(x,y,tₙ), I(x,y,tₙ₋₁)).

The intensity quantizer may be provided either outside or inside the intensity pixel. Similarly, the temporal differentiator and quantizer, as well as the spatial differentiator and quantizer may be provided either outside or inside the spatiotemporal difference pixel.

In the present embodiment, the intensity quantizer is illustrated as being provided outside the intensity pixel, while the temporal differentiator and quantizer is illustrated as being provided outside the temporal difference pixel and the spatial differentiator and quantizer is illustrated as being provided outside the spatial difference pixel.

There are various options for selecting the pixels at spatially associated positions; for example, the pixels located at positions in the x and y directions adjacent to the current pixel, or the pixels located at positions diagonally adjacent to the current pixel.

For differences in the x and y directions, the outputs obtained from the spatial difference pathways are expressed by the following equations:

$${SD}_{x} ( x , y , {t}_{n} ) = {Q}_{SD} ( I ( x , y , {t}_{n} ) - I ( x - 1 , y , {t}_{n} ) )$$

$${SD}_{y} ( x , y , {t}_{n} ) = {Q}_{SD} ( I ( xy , {t}_{n} ) - I ( x , y - 1 , {t}_{n} ) )$$

for diagonal differences, the outputs obtained from the spatial difference pathways are expressed by the following equations:

$${SD}_{↙} ( x , y , {t}_{n} ) = {Q}_{SD} ( I ( x , y , {t}_{n} ) - I ( x - 1 , y - 1 , {t}_{n} ) )$$

$${SD}_{↘} ( x , y , {t}_{n} ) = {Q}_{SD} ( I ( x , y , {t}_{n} ) - I ( x + 1 , y - 1 , {t}_{n} ) )$$

furthermore, alternative forms may be selected. For instance, adjacent pixels in a specific direction are solely selected for performing difference to obtain difference information for that particular direction, or more than two associated pixels may also be simultaneously selected to improve the precision of spatial difference.

Quantization modes used by both the temporal differentiator and quantizer and the spatial difference and quantizer may be either multi-valued (>1 bit) or single-valued (positive and negative pulses). Obtaining signals can be performed in one of three modes: full-array synchronization mode with a same time interval, full-array synchronization mode with a variable time interval or full-array synchronization mode.

In the field of digital signal processing, quantization mainly refers to a process of converting analog signals into digital signals. Sampling and quantization of signals are typically performed by an analog-to-digital converter (ADC).

In an embodiment, the intensity quantizer is provided inside the intensity pixel and uses a pixel-level signal readout mode; or the intensity quantizer is provided outside the intensity pixel and shared by another intensity pixel located in a same column and uses a column-level signal readout mode; the temporal differentiator and quantizer is provided inside a pixel multiplexing the temporal difference and the spatial difference and uses the pixel-level signal readout mode; or the temporal differentiator and quantizer is provided outside the pixel multiplexing the temporal difference and the spatial difference, and shared by a pixel multiplexing the temporal difference and the spatial difference located in a same column and uses the column-level signal readout mode; and the spatial differentiator and quantizer is provided inside a pixel multiplexing the temporal difference and the spatial difference and uses the pixel-level signal readout mode; or is provided outside a pixel multiplexing the temporal difference and the spatial difference, and shared by a pixel multiplexing the temporal difference and the spatial difference located in a same column and uses the column-level signal readout mode.

In the present embodiment, if the temporal differentiator and quantizer is provided outside the temporal difference pixel and the spatial differentiator and quantizer is provided outside the spatial difference pixel, a total number of quantizers is reduced, lowering hardware resource consumption.

If the temporal differentiator and quantizer is provided inside the temporal difference pixel and the spatial differentiator and quantizer is provided inside the spatial difference pixel, flexibility is enhanced and output latency is reduced.

The arrangement of the intensity quantizer being provided outside the intensity pixel and the temporal differentiator and quantizer being provided inside or outside the temporal difference pixel and the spatial differentiator and quantizer being provided inside or outside the spatial difference pixel may be arbitrarily combined in the visual sensor chip of the present application; and there is no any special limitation thereto in the present application.

In an embodiment, each pixel of the pixel array is provided with one pulse generator; or
all pixels in the pixel array are collectively connected to one pulse generator; or
the pixel array is partitioned into a plurality of sub-regions and all pixels in each sub-region are collectively connected to one pulse generator;
where the pulse generator is configured to generate a trigger signal at a fixed time interval, or at adaptive, programmable, and variable intervals to control a start exposure time and an exposure duration of a corresponding photoreceptor; pixels connected to a same pulse generator perform synchronous exposure, and pixels connected to different pulse generators perform either synchronous or asynchronous exposure; and
the photoreceptor is provided inside the pixel and is configured to convert the light signal at the position of the current pixel into an analog electrical signal.

In the present embodiment, the visual sensor chip further includes a trigger pulse generator. The trigger pulse generator is capable of generating trigger signals to control the exposure of the photoreceptor, specifically, by determining the precise time tₙ at which the signal is obtained. If a trigger pulse generator is designed into each pixel, full-array asynchronous exposure can be adopted. In this scenario, each trigger pulse generator can independently and adaptively adjust the timing for calculating the spatiotemporal difference signals based on level of the light intensity perceived by its own specific pixel; consequently, the trigger time differs for each pixel. The pixel may output information at any arbitrary time, enhancing flexibility and reducing output latency. Even under these circumstances, full-array synchronous exposure can be performed as required. If a group of pixels shares a same trigger pulse generator, synchronous exposure is performed on these specific pixels.

The trigger pulse generator may generate a trigger signal at a same time interval, or at adaptive, programmable, and variable intervals.

If all pixels inside the array share a single trigger pulse generator, simultaneous exposure is performed on all pixels, and the outputs of the pixels must follow a specific pattern.

In an embodiment, an exposure mode for each pixel of the pixel array is a global shutter or a rolling shutter.

Exposure mode, whether global or rolling used by the intensity pathway, the temporal difference pathway, and the spatial difference pathway may be combined in any arbitrary manner and there is no specific limitation thereto in the present application.

In an embodiment, an output color type of a pathway corresponding to the pixel is a color value in case that the pixel is provided with a color filter and an output color type of a pathway corresponding to the pixel is a grayscale value in case that the pixel is not provided with a color filter.

If a pixel is covered with a color filter, the information obtained by that pixel is limited to the information of a specific color pathway. Typical color filter, a combination of red, green, and blue, is referred to as the RGB type. Other color pathways, such as a CMY array composed of three complementary colors (cyan, magenta, and yellow), may also be employed. Pixels of the same general type may differ in their specific color pathways—for instance, a spatiotemporal difference pixel of color X, a spatiotemporal difference pixel of pathway Y, or a spatiotemporal difference pixel of pathway Z. In case that spatial difference is performed, the spatial difference may be performed either between pixels of the same color or between pixels of different colors (e.g., by subtracting a color X pixel from a color Y pixel).

Furthermore, an externally programmable demosaicer may be embedded within the pixel and output values of all other color pathways at the position of a pixel corresponding to color pathway X are obtained through a demosaicing algorithm, which is achieved through interpolation based on the values of surrounding pixels.

Reference is made to FIG. 28 and FIG. 28 is a first schematic principle diagram of a vision sensor chip based on a pixel binning technology according to the present application.

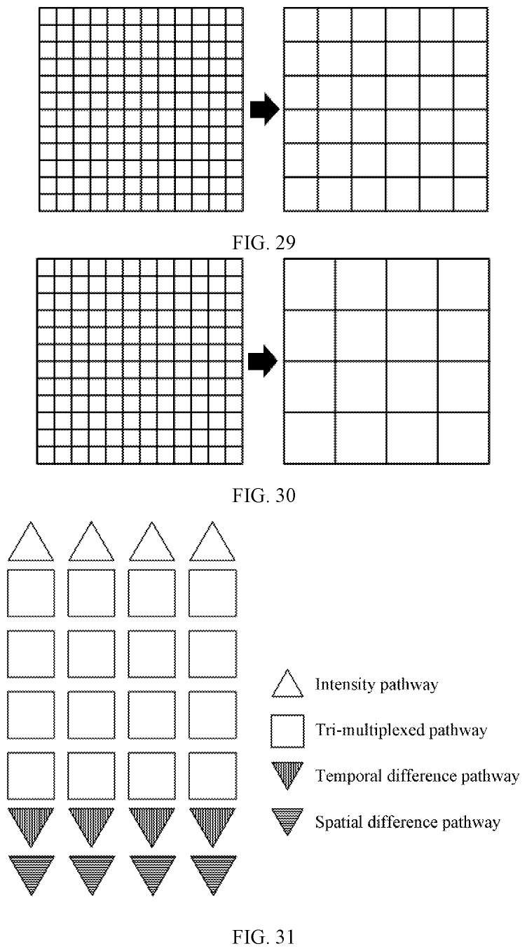

Reference is made to FIG. 29 and FIG. 29 is a first schematic principle diagram of pixel binning according to the present application.

Reference is made to FIG. 30 and FIG. 30 is a second schematic principle diagram of pixel binning according to the present application.

To solve the problems in the related art, according to the present application, there is further provided a vision sensor chip based on a pixel binning technology, including a pixel array, an intensity pathway, a temporal difference pathway, and a spatial difference pathway, where the pixel array includes a plurality of pixels; the binning technology is configured to bin signals of the plurality of pixels within a range of a binned pixel into a single signal and output the single signal; the intensity pathway is configured to determine a quantized value of an electrical signal converted from intensity of incident light at a binned pixel; the temporal difference pathway is configured to perform temporal difference, binning, and quantization operations in a charge domain, an analog domain, or a digital domain on a signal at a position of a current binned pixel at a current time and a signal at the position of the current binned pixel at the previous time to obtain a temporal difference value of the binned pixel; a signal of the binned pixel is a binned signal of the plurality of pixels within the range of the binned pixel; the spatial difference pathway is configured to perform spatial difference, binning, and quantization operations in the charge domain, the analog domain, or the digital domain on the signal at the position of the current binned pixel at the current time and the signal at a position of a spatially associated binned pixel at the current time to obtain a spatial difference value of the binned pixel; and the spatially associated binned pixel refers to any one or more binned pixels within the pixel array other than the current binned pixel.

In contrast, a human visual system, whether at high noon or at dusk, and whether operating in an open environment or a partially occluded scene, is capable of rapidly identifying moving targets. A level of robustness and versatility far exceeding that of the traditional DAVIS is achieved. This superior performance stems from the fact that, in addition to color and temporal difference pathways, the human eye also possesses a spatial difference pathway; these three pathways integrate organically to form distinct visual primitives, generating highly efficient and robust visual representations. The pixel binning is mainly used for reducing noise and decreasing data bandwidth. Inspired by human vision, a spatial difference pathway-analogous to that found in the human retina is added into traditional solutions based on single-pixel multiplexing or hybrid pixel arrays according to the present application. Specifically, the visual sensor simultaneously generates three distinct outputs: an intensity output, a TD output, and a SD output.

The present application supports pixel-space binning to enable spatiotemporal differential sensing characterized by a larger receptive field, a broader spatial scale, and higher sensitivity. By sharing readout switches and storage nodes, output values of a plurality of adjacent pixels are binned together; typical binning ranges include 2×2 pixels, 3×3 pixels, or other configurations. The binned pixels are combined into a single “super-pixel” output; the resulting output value may represent a sum or an average of output values of all binned pixels, or may represent their median, a maximum, a minimum, or other functional relationships. That is,

$${I}_{binning} = f ( {I}_{1} , {I}_{2} , … {I}_{n} )$$

where I_{binning} denotes a binning result, Iᵢ(i=1 . . . n) represents an output value of each individual pixel within the specified binning range, and f is a binning function—most typically, summing or averaging.

The binning process may be performed in the charge domain, the analog domain, or the digital domain. Pixel binning reduces the volume of data to be processed or transmitted, and a frame rate is increased in certain scenarios. Furthermore, the signal-to-noise ratio (SNR) of the binned pixel is enhanced.

In this context, the electrical signal may take the form of a charge signal, a current signal, or a voltage signal.

All signals involved in the three sensing pathways are three-dimensional quantities, including spatial two-dimensional quantities x and y and a temporal dimension t.

An output value of the binned pixel within the dashed box (representing a 2×2 array) is expressed by:

$${TD}_{binning} = \frac{{\sum }_{i = 1}^{8} {n}_{i} {TD}_{i}}{{\sum }_{i = 1}^{8} {n}_{i}}$$

where TDᵢ denotes an output value of the TD pathway for pixel (1) at the current time. nᵢ represents a weighting coefficient. Typically, n_{1~2}=1, n_{3~8}=0, n_{1~2}=6, n_{3~6}=1, n_{7~8}=0 and the method is not unique.

Reference is made to FIG. 31 and FIG. 31 is a schematic structural diagram of a tri-pathway vision sensor using multiplexed pixels according to the present application.

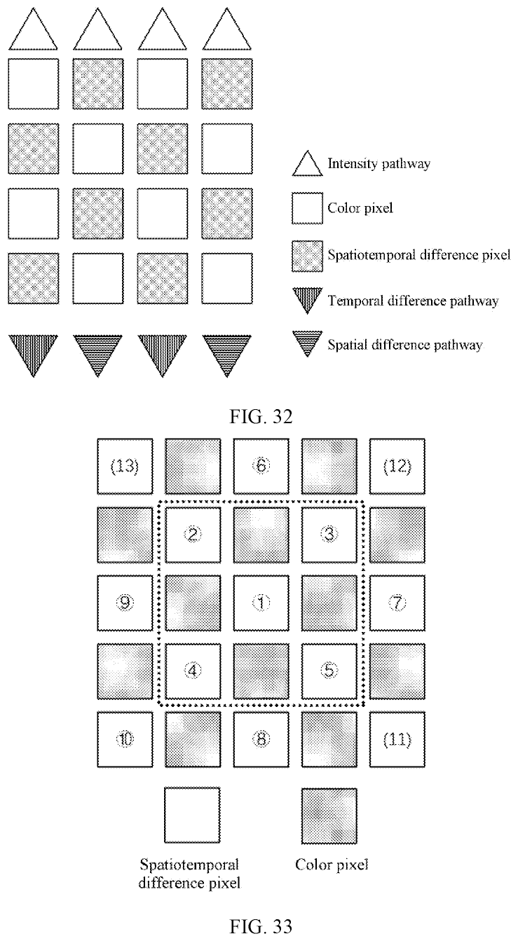

Reference is made to FIG. 32 and FIG. 32 is a schematic structural diagram of a vision sensor chip based on a hybrid pixel according to the present application.

A binned pixel includes a plurality of multiplexed pixels; or includes a plurality of binary hybrid pixels and a plurality of single pixels; or includes a plurality of ternary hybrid pixels. A multiplexed pixel is a pixel multiplexing intensity, a temporal difference and a spatial difference; the binary hybrid pixel multiplexing two elements selected from intensity, temporal difference, and spatial difference; a single pixel is a pixel using an element different from those of the binary hybrid pixels; and a ternary hybrid pixel is a pixel in which three types pixels corresponding to the intensity, the temporal difference, and the spatial difference respectively are arranged in a hybrid manner.

Furthermore, storage nodes may be flexibly configured to store signals in accordance with signal transmission requirements; and there is no specific limitation regarding the number or placement of the storage nodes.

An intensity quantizer may be provided outside the pixel. A temporal differentiator, a temporal quantizer, a spatial differentiator, a spatial quantizer, and a binner may be provided outside the pixel, where they are shared by pixels within the same column or they may be provided inside the pixel; and there is no specific limitation thereto herein.

The binner may be designed individually for each pixel, distributed on a column basis, or implemented within a subsequent image processor; and there is no specific limitation thereto herein.

Binners sharing identical fusion logic may be multiplexed.

In the present application, the pixel binning technology is introduced into a tri-pathway visual sensor chip architecture can enhance an output signal-to-noise ratio and reduce the volume of transmitted data, alleviating pressure on bandwidths.

Based on the embodiment above, an intensity pathway includes a first intensity binner and a first intensity quantizer; the first intensity binner is configured to bin analog signals of the plurality of pixels at the position of the current binned pixel at the current time to obtain a first intensity binned signal; and the first intensity quantizer is configured to perform analog-to-digital conversion on the first intensity binned signal to obtain a quantized value of an electrical signal converted from intensity of incident light at the binned pixel;

$${I}_{binning} ( x , y , {t}_{n} ) = {Q}_{A} ( {\sum }_{i = 1}^{N} {I}_{i} ( {x}_{i} , {y}_{i} , t ) )$$

where xy denote coordinates of the binned pixel, xᵢ,yᵢ denote the coordinates of each pixel, and Q_{A} represents the quantization of the intensity pathway.

In addition to summing

$${I}_{sum} = {\sum }_{i = 1}^{N} {I}_{i} ( {x}_{i} , {y}_{i} , t ) ,$$

binning pixels can also be performed by averaging:

$${I}_{ave} = \frac{{\sum }_{1}^{N} {I}_{1} ( {x}_{1} , {y}_{1} , t )}{N} .$$

In an embodiment, the intensity pathway includes a second intensity quantizer and a second intensity binner; the second intensity quantizer is configured to perform analog-to-digital conversion on analog signals of the plurality of pixels at the position of the current binned pixel at the current time to obtain a quantized value of an electrical signal converted from intensity of incident light at each of the pixels; and the second intensity binner is configured to bin quantized values of intensities of incident light at the plurality of pixels to obtain a quantized value of the electrical signal converted from intensity of incident light of the binned pixel.

The second intensity quantizer obtains the quantized value of the electrical signal converted from intensity of incident light at each of the pixels through I(xᵢ,yᵢ,tⱼ)=Q_{A}(I(xᵢ,yᵢ,tⱼ)); and the second intensity binner obtains the quantized value of the electrical signal converted from intensity of incident light of the binned pixel through

$${I}_{binning} = ( {\sum }_{i = 1}^{N} I ( {x}_{i} , {y}_{i} , t ) ) .$$

In an embodiment, the temporal difference pathway includes a first temporally differential binner, a first temporal differentiator, and a first temporal quantizer; the first temporally differential binner is configured to bin electrical signals of the plurality of the pixels to obtain first temporally differential binned signals at the position of the current binned pixel at different times; the first temporal differentiator is configured to perform temporal difference operation on a first temporally differential binned signal at the position of the current binned pixel at the current time and a first temporally differential binned signal at the position of the current binned pixel at the previous time to obtain a temporal difference value of the binned pixel; and analog-to-digital signal conversion is performed by the first temporal quantizer during the binning and temporal difference processes.

In all following subscripts, analog indicates that the signal is an analog signal, while digital indicates that the signal is a digital signal. Iᵢ represents initial analog signals, while “TD” and “SD” represent final digital signals.

The first temporally differential binner obtains the first temporally differential binned signals through

$${I}_{binning - analog} = {\sum }_{i = 1}^{N} {I}_{i} ( {x}_{i} , {y}_{i} , t ) ;$$

and
the first temporal differentiator, in conjunction with the first temporal quantizer, obtains the temporal difference value of the binned pixels, through TD(x,y,tₙ)=I_{binning-digital}(x,y, tₙ)−I_{binning-digital}(x,y,tₙ₋₁).

In an embodiment, the first temporally differential binner, in conjunction with the first temporal quantizer, obtains the first temporally differential binned signals through

$${I}_{binning - digital} = {Q}_{A} ( {\sum }_{i = 1}^{N} {I}_{i} ( {x}_{i} , {y}_{i} , t ) ) ;$$

the first temporal differentiator obtains the temporal difference value of the binned pixels through TD(x,y,tₙ)=I_{binning-digital}(x,y,tₙ)−I_{binning-digital}(x,y,tₙ₋₁).

In an embodiment, the first temporal quantizer obtains the quantized value of intensity of incident light at each pixel through I_{i-digital}(xᵢ,yᵢ,tⱼ)=Q_{A}(Iᵢ(xᵢ,yᵢ,tⱼ);
the first temporally differential binner obtains the first temporally differential binned signals through

$${I}_{binning - digital} = ( {\sum }_{i = 1}^{N} {I}_{i - digital} ( {x}_{i} , {y}_{i} , t ) ) ,$$

and
the first temporal differentiator obtains the temporal difference value of the binned pixels through TD(x,y,tₙ)=I_{binning-digital}(x,y, tₙ)−I_{binning-digital}(x,y,tₙ₋₁).

In an embodiment, the temporal difference pathway includes a second temporal differentiator, a second temporal quantizer, and a second temporally differential binner; the second temporal differentiator is configured to determine a temporal difference value of each of the plurality of pixels; the temporal difference value of each of the pixels is obtained by performing a temporal difference operation on an electrical signal at a position of a current pixel at a current time and an electrical signal at the position of the current pixel at a previous time; and the second temporally differential binner is configured to bin temporal difference values of the plurality of pixels to obtain a temporal difference value of the binned pixel; and analog-to-digital signal conversion is performed by the second temporal quantizer during the binning and temporal difference processes.

The second temporal differentiator determine the temporal difference value of each pixel through TD_{i-analog}(xᵢ,yᵢ,tₙ)=Iᵢ(xᵢ,yᵢ,tₙ)−Iᵢ(xᵢ,yᵢ,tₙ₋₁); and
the second temporally differential binner, in conjunction with the second temporal quantizer, obtains the temporal difference value of the binned pixel through

$$TD ( x , y , {t}_{n} ) = {Q}_{TD} ( {\sum }_{i = 1}^{N} {TD}_{i - analog} ( {x}_{i} , {y}_{i} , t ) ) .$$

In an embodiment, the second temporal differentiator, in conjunction with the second temporal quantizer, determines the temporal difference value of each pixel through

$${TD}_{i - digital} ( {x}_{i} , {y}_{i} , {t}_{n} ) = {Q}_{TD} ( {I}_{i} ( {x}_{i} , {y}_{i} , {t}_{n} ) - {I}_{i} ( {x}_{i} , {y}_{i} , {t}_{n - 1} ) ) ;$$

and
the second temporally differential binner obtains the temporal difference value of the binned pixel through

$$TD ( x , y , {t}_{n} ) = {\sum }_{i = 1}^{N} {TD}_{i - digital} ( {x}_{i} , {y}_{i} , t ) .$$

In an embodiment, the second temporal quantizer obtains the quantized value of intensity of incident light at each pixel through I_{i-digital}(xᵢ,yᵢ,tⱼ)Q_{A}(Iᵢ(xᵢ,yᵢ,tⱼ));
the second temporal differentiator determine the temporal difference value of each pixel through TD_{i-digital}(xᵢ,yᵢ,tₙ)=(I_{i-digital}(xᵢ,yᵢ,tₙ)−I_{i-digital}(xᵢ,yᵢ,tₙ₋₁)); and
the second temporally differential binner obtains the temporal difference value of the binned pixel through

$$TD ( x , y , {t}_{n} ) = {\sum }_{i = 1}^{N} {TD}_{i - digital} ( {x}_{i} , {y}_{i} , t ) .$$

In the above context, Q_{TD} represents a quantization method used by the temporal difference pathway.

Reference is made to FIG. 33 and FIG. 33 is a second schematic principle diagram of a vision sensor chip based on a pixel binning technology according to the present application.

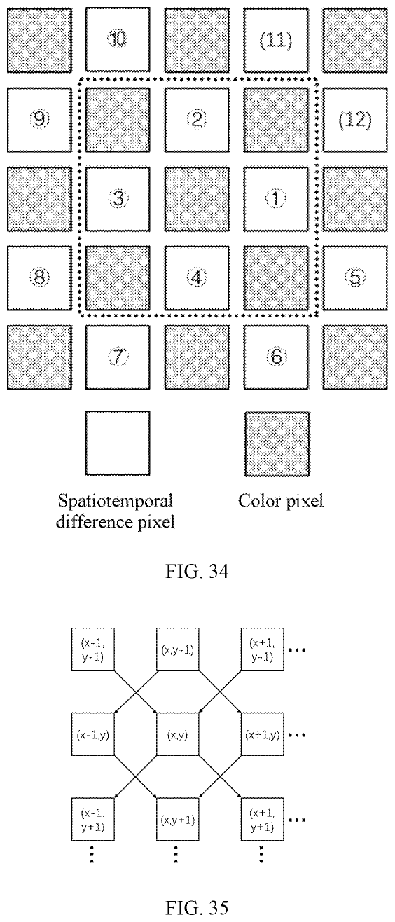

Reference is made to FIG. 34 and FIG. 34 is a third schematic principle diagram of a vision sensor chip based on a pixel binning technology according to the present application.

The hybrid pixel array involves two different types of pixels; the TD pixel type is used here as an example (the same logic applies to the A and SD pixel types).

$${TD}_{binning} = \frac{{\sum }_{i = 1}^{N} {n}_{i} {TD}_{i}}{{\sum }_{i = 1}^{N} {n}_{i}}$$

where N represents the pixels within the selected range of binned pixels as well as the surrounding ring of adjacent pixels. Only those pixels exhibiting a differential output are selected to constitute this designated range.

An output value of the binned pixel within the dashed box (representing a 3×3 array) in FIG. 33 is expressed by:

$${TD}_{binning} = \frac{{\sum }_{i = 1}^{12} {n}_{i} {TD}_{i}}{{\sum }_{i = 1}^{12} {n}_{i}}$$

where TDᵢ denotes an output value of the TD pathway of pixel i at the current time. nᵢ represents a weighting coefficient. For example, n_{1~5}=1 and n_{6~13}=0.

An output value of the binned pixel within the dashed box (representing a 3×3 array) in FIG. 34 is expressed by:

$${TD}_{binning} = \frac{{\sum }_{i = 1}^{12} {n}_{i} {TD}_{i}}{{\sum }_{i = 1}^{12} {n}_{i}}$$

where TDᵢ denotes an output value of the TD pathway of pixel i at the current time. nᵢ represents a weighting coefficient. For example, n_{1~4}=1 and n_{5~12}=0.

Reference is made to FIG. 35 and FIG. 35 is a schematic principle diagram of difference in a diagonal direction according to the present application.

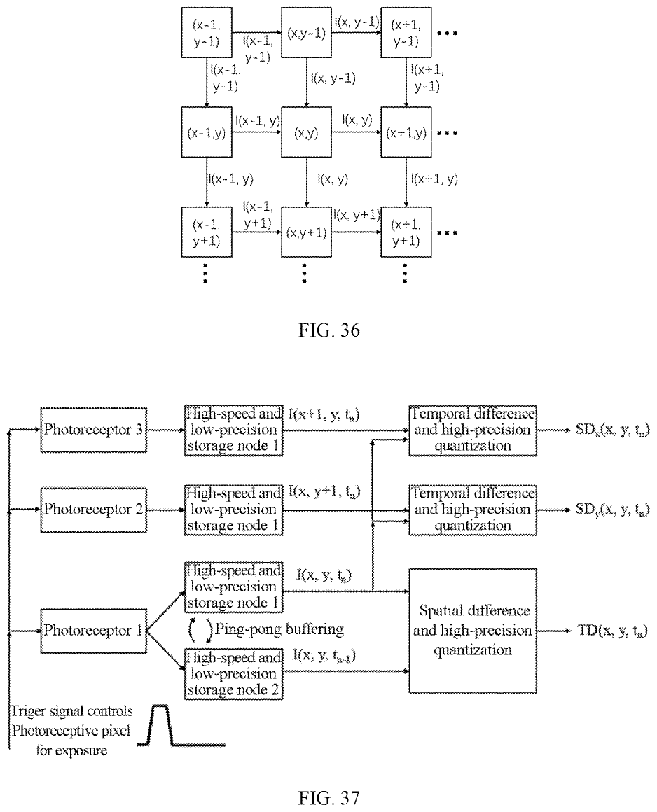

Reference is made to FIG. 36 and FIG. 36 is a schematic principle diagram of difference in x and y directions according to the present application.

In addition to these two difference modes, other difference modes are present—for instance, difference is performed solely along the X-axis, or more than two adjacent pixels are selected for performing difference.

In an embodiment, the spatial difference pathway includes a first spatially differential binner, a first spatial differentiator, and a first spatial quantizer; the first spatially differential binner is configured to bin electrical signals of the plurality of pixels to obtain first spatially differential binned signals at a position of a current binned pixel at a current time; the first spatial differentiator is configured to perform spatial difference operation on a first spatially differential binned signal at the position of the current binned pixel at the current time and a first spatially differential binned signal at a position of a spatially associated binned pixel at the current time to obtain a spatial difference value of the binned pixel; and analog-to-digital signal conversion is performed by the first spatial quantizer during the binning and spatial difference processes.

The first spatially differential binner obtains the first spatially differential binned signals through

$${I}_{binning - analog} ( x , y , {t}_{n} ) = {\sum }_{i = 1}^{N} {I}_{i} ( {x}_{i} , {y}_{i} , t ) ;$$

the first spatial differentiator, in conjunction with the first spatial quantizer, obtains the spatial difference value of the binned pixels, through the following equations:

$${SD}_{X} ( x , y , {t}_{n} ) = {Q}_{SD} ( {I}_{binning - analog} ( x , y , {t}_{n} ) - {I}_{binning - analog} ( x - 1 , y , {t}_{n} ) )$$

$${SD}_{Y} ( x , y , {t}_{n} ) = {Q}_{SD} ( {I}_{binning - analog} ( x , y , {t}_{n} ) - {I}_{binning - analog} ( x , y - 1 , {t}_{n} ) )$$

$${SD}_{↙} ( x , y , {t}_{n} ) = {Q}_{SD} ( {I}_{binning} ( x , y , {t}_{n} ) - {I}_{binning} ( x - 1 , y - 1 , {t}_{n} ) )$$

$${SD}_{↘} ( x , y , {t}_{n} ) = {Q}_{SD} ( {I}_{binning} ( x , y , {t}_{n} ) - {I}_{binning} ( x + 1 , y - 1 , {t}_{n} ) )$$

the first spatially differential binner, in conjunction with the first spatial quantizer, obtains the first spatially differential binned signals through

$${I}_{binning} = {Q}_{A} ( {\sum }_{i = 1}^{N} {I}_{i} ( {x}_{i} , {y}_{i} , t ) ) ;$$

and
the first spatial differentiator determines the spatial difference value of the binned pixel through the following equations:

$$SD\_X ( x , y , {t}_{n} ) = {I}_{binning} ( x , y , {t}_{n} ) - {I}_{binning} ( x - 1 , y , {t}_{n} )$$

$$SD\_Y ( x , y , {t}_{n} ) = {I}_{binning} ( x , y , {t}_{n} ) - {I}_{binning} ( x , y - 1 , {t}_{n} ) .$$

In an embodiment, the first spatial quantizer obtains the quantized value of intensity of incident light at each pixel through I_{i-analog}(xᵢ,yᵢ,tⱼ)=Q_{A}(Iᵢ(xᵢ,yᵢ,tⱼ);
the first spatially differential binner obtains the first spatially differential binned signals through

$${I}_{binning} = ( {\sum }_{i = 1}^{N} {I}_{i - analog} ( {x}_{i} , {y}_{i} , t ) ) ;$$

and
the first spatial differentiator determines the spatial difference value of the binned pixel through the following equations:

$$SD\_X ( x , y , {t}_{n} ) = {I}_{binning} ( x , y , {t}_{n} ) - {I}_{binning} ( x - 1 , y , {t}_{n} )$$

$$SD\_Y ( x , y , {t}_{n} ) = {I}_{binning} ( x , y , {t}_{n} ) - {I}_{binning} ( x , y - 1 , {t}_{n} ) .$$

In an embodiment, the spatial difference pathway includes a second spatial differentiator, a second spatial quantizer, and a second spatially differential binner; the second spatial differentiator is configured to determine a spatial difference value of each of the pixels; the spatial difference value of each of the pixels is obtained by performing spatial difference operation on an electrical signal at a position of a current pixel at a current time and an electrical signal at the position of the spatially associated binned pixel at the current time; and the second spatially differential binner is configured to bin spatial difference values of the plurality of pixels to obtain a spatial difference value of the binned pixel; and analog-to-digital signal conversion is performed by the second spatial quantizer during the binning and spatial difference processes.

The second spatial differentiator obtains the spatial difference value of each pixel through the following equations;

$${SD}_{{analag}_{X}} ( {x}_{i} , {y}_{i} , {t}_{n} ) = I ( {x}_{i} , {y}_{i} , {t}_{n} ) - I ( {x}_{i} - 1 , {y}_{i} , {t}_{n} )$$

$${SD}_{{analag}_{y}} ( {x}_{i} , {y}_{i} , {t}_{n} ) = I ( {x}_{i} , {y}_{i} , {t}_{n} ) - I ( {x}_{i} , {y}_{i} - 1 , {t}_{n} )$$

$${SD}_{{analag}_{↙}} ( {x}_{i} , {y}_{i} , {t}_{n} ) = I ( {x}_{i} , {y}_{i} , {t}_{n} ) - I ( {x}_{i} - 1 , {y}_{i} - 1 , {t}_{n} )$$

$${SD}_{{analag}_{↘}} ( {x}_{i} , {y}_{i} , {t}_{n} ) = I ( {x}_{i} , {y}_{i} , {t}_{n} ) - I ( {x}_{i} + 1 , {y}_{i} - 1 , {t}_{n} )$$

the second spatially differential binner, in conjunction with the second spatial quantizer, obtains the spatial difference value of the binned pixel through the following equations:

$$SD\_x ( x , y , {t}_{n} ) = {Q}_{S D} ( {\sum }_{i = 1}^{N} S {D}_{{analog}_{x}} ( {x}_{i} , {y}_{i} , t ) )$$

$$S {D}_{y ( x , y , {t}_{n} )} = {Q}_{S D} ( {Σ}_{i = 1}^{N} S {D}_{{analog}_{y}} ( {x}_{i} , {y}_{i} , t ) ) .$$

In an embodiment, the second spatial differentiator, in conjunction with the second spatial quantizer, obtains the spatial difference value of each pixel through the following equations:

$$S {D}_{x} ( {x}_{i} , {y}_{i} , {t}_{n} ) = {Q}_{S D} ( I ( {x}_{i} , {y}_{i} , {t}_{n} ) - I ( {x}_{i} - 1 , {y}_{i} , {t}_{n} ) )$$

$$S {D}_{y} ( {x}_{i} , {y}_{i} , {t}_{n} ) = {Q}_{S D} ( I ( {x}_{i} , {y}_{i} , {t}_{n} ) - I ( {x}_{i} , {y}_{i} - 1 , {t}_{n} ) )$$

$$S {D}_{↙} ( {x}_{i} , {y}_{i} , {t}_{n} ) = {Q}_{S D} ( I ( {x}_{i} , {y}_{i} , {t}_{n} ) - I ( {x}_{i} - 1 , {y}_{i} - 1 , {t}_{n} ) )$$

$$S {D}_{↘} ( {x}_{i} , {y}_{i} , {t}_{n} ) = {Q}_{S D} ( I ( {x}_{i} , {y}_{i} , {t}_{n} ) - I ( {x}_{i} + 1 , {y}_{i} - 1 , {t}_{n} ) )$$

the second spatially differential binner obtains the spatial difference value of the binned pixel through the following equations:

$$S {D}_{x} ( x , y , {t}_{n} ) = {\sum }_{i = 1}^{N} SD\_x ( {x}_{i} , {y}_{i} , t ) ,$$

$${SD}_{y} ( x , y , {t}_{n} ) = {\sum }_{i = 1}^{N} SD\_x ( {x}_{i} , {y}_{i} , t ) .$$

In an embodiment, the second spatial quantizer obtains the quantized value of intensity of incident light at each pixel through I_{i-digital}(xᵢ,yᵢ,tⱼ)=Q_{A}(Iᵢ(xᵢ,yᵢ,tⱼ));
the second spatial differentiator obtains the spatial difference value of each pixel through the following equations;

$$S {D}_{x - i} ( {x}_{i} , {y}_{i} , {t}_{n} ) = ( {I}_{i - digital} ( {x}_{i} , {y}_{i} , {t}_{n} ) - {I}_{i - digital} ( {x}_{i} - 1 , {y}_{i} , {t}_{n} ) )$$

$$S {D}_{y - i} ( {x}_{i} , {y}_{i} , {t}_{n} ) = ( {I}_{i - digital} ( {x}_{i} , {y}_{i} , {t}_{n} ) - {I}_{i - digital} ( {x}_{i} , {y}_{i} - 1 , {t}_{n} ) ) ;$$

the second spatially differential binner obtains the spatial difference value of the binned pixel through the following equations:

$$S {D}_{x} ( x , y , {t}_{n} ) = {Σ}_{i = 1}^{N} S {D}_{x - i} ( {x}_{i} , {y}_{i} , t ) ,$$

$$S {D}_{y} ( x , y , {t}_{n} ) = {Σ}_{i = 1}^{N} S {D}_{x - i} ( {x}_{i} , {y}_{i} , t ) .$$

In an embodiment, each pixel of the pixel array is provided with one pulse generator; or
all pixels in the pixel array are collectively connected to one pulse generator; or
the pixel array is partitioned into a plurality of sub-regions and all pixels in each sub-region are collectively connected to one pulse generator;
where the pulse generator is configured to generate a trigger signal at a fixed time interval, or at adaptive, programmable, and variable intervals to control a start exposure time and an exposure duration of a corresponding photoreceptor; pixels connected to a same pulse generator perform synchronous exposure, and pixels connected to different pulse generators perform either synchronous or asynchronous exposure; and
the photoreceptor is provided inside the pixel and is configured to convert the light signal at the position of the current pixel into an analog electrical signal.

In the present embodiment, the visual sensor chip further includes a trigger pulse generator. The trigger pulse generator is capable of generating trigger signals to control the exposure of the photoreceptor, specifically, by determining the precise time tₙ at which the signal is obtained. If a trigger pulse generator is designed into each pixel, full-array asynchronous exposure can be adopted. In this scenario, each trigger pulse generator can independently and adaptively adjust the timing for calculating the spatiotemporal difference signals based on level of the light intensity perceived by its own specific pixel; consequently, the trigger time differs for each pixel. The pixel may output information at any arbitrary time, enhancing flexibility and reducing output latency. Even under these circumstances, full-array synchronous exposure can be performed as required. If a group of pixels shares a same trigger pulse generator, synchronous exposure is performed on these specific pixels.

The trigger pulse generator may generate a trigger signal at a same time interval, or at adaptive, programmable, and variable intervals.

If all pixels inside the array share a single trigger pulse generator, simultaneous exposure is performed on all pixels, and the outputs of the pixels must follow a specific pattern.

Quantization modes used by both the temporal differentiator and quantizer and the spatial differentiator and quantizer may be either multi-valued (>1 bit) or single-valued (positive and negative pulses). Obtaining signals can be performed in one of three modes: full-array synchronization mode with a same time interval, full-array synchronization mode with a variable time interval or full-array synchronization mode.

In the field of digital signal processing, quantization mainly refers to a process of converting analog signals into digital signals. Sampling and quantization of signals are typically performed by an analog-to-digital converter (ADC).

In an embodiment, an exposure mode for each pixel of the pixel array is a global shutter or a rolling shutter.

Exposure mode, whether global or rolling used by the intensity pathway, the temporal difference pathway, and the spatial difference pathway may be combined in any arbitrary manner and there is no specific limitation thereto herein.

In an embodiment, an output color type of a pathway corresponding to the pixel is a color value in case that the pixel is provided with a color filter and an output color type of a pathway corresponding to the pixel is a grayscale value in case that the pixel is not provided with a color filter.

If a pixel is covered with a color filter, the information obtained by that pixel is limited to the information of a specific color pathway. Typical color filter, a combination of red, green, and blue, is referred to as the RGB type. Other color pathways, such as a CMY array composed of three complementary colors (cyan, magenta, and yellow), may also be employed. Pixels of the same general type may differ in their specific color pathways—for instance, a spatiotemporal difference pixel of color X, a spatiotemporal difference pixel of pathway Y, or a spatiotemporal difference pixel of pathway Z. In case that spatial difference is performed, the spatial difference may be performed either between pixels of the same color or between pixels of different colors (e.g., by subtracting a color X pixel from a color Y pixel).

Furthermore, an externally programmable demosaicer may be embedded within the pixel and output values of all other color pathways at the position of a pixel corresponding to color pathway X are obtained through a demosaicing algorithm, which is achieved through interpolation based on the values of surrounding pixels.

A majority of CIS captures video through a frame-based sampling principle, that is, outputs of all pixels within a pixel array are recorded in every frame of image of the CIS, and each frame is captured at equal time intervals. The CIS integrate transistors directly inside the pixels to perform high-performance charge-to-voltage conversion and is also referred to as an active pixel sensor (APS). The CIS can perceive visible light of different wavelengths through covering the pixel array with a color filter array (CFA), generating color images. The CIS offers distinct advantages, including high pixel array resolution, high degree of color reproduction, and superior image quality.

An event camera, also referred to as a dynamic vision sensor (DVS), is a novel type of imaging system. Unlike traditional cameras employing a shutter to control the frame rate and recording light intensity across all pixels on a per-frame basis, the event camera is sensitive to the rate of change in light intensity. Each pixel independently records the logarithmic change in light intensity at its specific location; and the pixel generates either a positive or a negative pulse in case that this change exceeds a predetermined threshold. The event camera is not controlled by the shutter due to asynchronous characteristic and thus has exceptionally high temporal resolution (Frame rate: approximately 10,000 fps; while the frame rate of traditional cameras is about 100 fps). In case that combined with its inherent sensitivity to change, the DVS naturally adapts to tasks such as motion detection. Another type of camera, known as DAVIS, integrates traditional APS technology with DVS capabilities and is capable of simultaneously capturing discrete image frames and recording event-based information, combining the high spatial resolution advantages of traditional cameras with the high temporal resolution advantages of the DVS cameras.

In traditional manufacturing processes for visual sensors, all circuit components are fabricated on a single two-dimensional wafer. Through this traditional processes, the processing circuit embedded within each pixel occupies a larger area. Taking the DVS as an example, the DVS can only output information regarding the temporal changes in visual signals across the focal plane; and this information is highly susceptible to interference. For instance, in case that flickering light is present in the environment, DVS may fail, as it cannot distinguish between signal changes caused by variations in the light source and those caused by motion. Furthermore, spatial gradients within an image constitute the foundational basis for numerous algorithms, such as the Harris corner algorithm, making this information critically important. Although the DVS can capture spatial gradients associated with object motion to a certain extent, specifically by approximating the spatial gradients through the relationship ΔL≈∇L·vΔτ. The fact that this gradient information is inherently coupled with the object's velocity makes it practically difficult to achieve high levels of precision. Consequently, there is an urgent need for a visual sensor capable of simultaneously perceiving both temporal and spatial variations.

Reference is made to FIG. 37 and FIG. 37 is a flowchart of signal processing of spatiotemporal difference vision sensor chip based on a 3D stacking technology according to the present application.

To address the problems in the related art, according to the present application, there is further provided a spatiotemporal difference vision sensor chip based on a 3D stacking technology, including a pixel array, a storage circuit, and a spatiotemporal difference and quantization circuit; the pixel array is provided at a top wafer, the spatiotemporal difference and quantization circuit is provided at a same bottom wafer, the top wafer and the bottom wafer are connected through a 3D stacking mode; the pixel array includes a plurality of pixels; a photoreceptive circuit is provided inside the pixel array; the photoreceptive circuit is configured to convert obtained light signals of the plurality of pixels into analog electrical signals of the plurality of pixels; the storage circuit is configured to store the analog or digital electrical signals of the plurality of pixels; the spatiotemporal difference and quantization circuit is configured to perform spatiotemporal difference and quantization operations on the analog electrical signals of the plurality of pixels to obtain a digital spatiotemporal difference electrical signals of each of the plurality of pixels; or the spatiotemporal difference and quantization circuit is configured to quantize the analog electrical signals of the plurality of pixels to obtain digital electrical signals of the plurality of pixels, and subsequently perform spatiotemporal difference operation on the digital electrical signals to obtain a digital spatiotemporal difference electrical signal of each of the plurality of pixels.

A human visual system can simultaneously perceive both temporal and spatial variations, making it more sensitive and robust to the outside world. Inspired by human vision, there is provided a vision sensor based on the principles of temporal variation and spatial gradients. The vision sensing architecture requires the acquisition of temporal and spatial variations in visual signals in either a synchronous or an asynchronous manner. Difference operation is performed in a charge, an analog domain or a digital domain on signals at a current time and a previous time and a photoreceptive unit at any other spatial location and results of the difference operation are output. These variation values are quantized and read out in a high-precision multi-bit format 1 bit). Hereinafter, temporal difference is abbreviated as TD, and spatial difference is abbreviated as SD. Furthermore, based on the 3D stacking technology, the photoreceptive circuit and the processing circuit (specifically, the difference and quantization circuit) are separated onto different layers of wafer, which significantly enhances photoreceptive performance, processing performance and energy efficiency of the chip.

The vision sensor chip described herein may further include a color pathway forming a tri-pathway bionic vision sensor in combination with a temporal difference pathway and a spatial difference pathway.

A storage circuit may be provided at either the top wafer or a bottom wafer and there is no any specific limitation thereto herein.

Based on the embodiment above, the storage circuit includes a plurality of storage nodes, the plurality of storage nodes are configured to store analog electrical signals of the pixels at different locations and different times using a multi-node random-access buffering mode; the spatiotemporal difference and quantization circuit includes a temporal difference and quantization unit and a spatial difference and quantization unit; the temporal difference and quantization unit is configured to perform temporal difference and quantization operations on the analog electrical signals of the plurality of pixels at different times to obtain temporal difference values at a position of a current pixel at different times; the spatial difference and quantization unit is configured to perform spatial difference and quantization operations on the analog electrical signals of pixels at different locations to obtain spatial differential values of the pixel at the position of the current pixel and adjacent pixels at the current time.

In an embodiment, there is provided a vision sensor with multi-pathway output according to the present application. The two pathways are a TD pathway and an SD pathway. Information from the TD and SD pathways is output independently from the chip to subsequent image processors. By incorporating both the TD and SD pathways, the present application enables the sensing chip to capture complete spatiotemporal information.

The TD pathway outputs the temporal difference values at the position of the current pixel (x,y) at different times and the output from the TD pathway is expressed by the following equation:

$$T D ( x , y , {t}_{n} ) = {Q}_{T D} ( I ( x , y , {t}_{n} ) - I ( x , y , {t}_{n - 1} ) )$$

where Q_{TD} represents a high-precision (≥1 bit) quantization method used by the temporal difference pathway.

The SD pathway outputs a spatial difference value between the position of the current pixel (x,y) and adjacent pixels (e.g., pixels provided diagonally or along the x-axis and γ-axis) at the current time tₙ. For differences in the x and y directions, the outputs obtained from the spatial difference pathways are expressed by the following equations:

$$S {D}_{x} ( x , y , {t}_{n} ) = {Q}_{S D} ( I ( x , y , {t}_{n} ) - I ( x + 1 , y , {t}_{n} ) )$$

$$S {D}_{y} ( x , y , {t}_{n} ) = {Q}_{S D} ( I ( x , y , {t}_{n} ) - I ( x , y + 1 , {t}_{n} ) )$$

for diagonal differences, the outputs obtained from the spatial difference pathways are expressed by the following equations:

$$S {D}_{↙} ( x , y , {t}_{n} ) = {Q}_{S D} ( I ( x , y , {t}_{n} ) - I ( x + 1 , y + 1 , {t}_{n} ) )$$

$$S {D}_{↘} ( x , y , {t}_{n} ) = {Q}_{S D} ( I ( x , y , {t}_{n} ) - I ( x - 1 , y + 1 , {t}_{n} ) )$$

where Q_{SD} represents a high-precision (≥1 bit) quantization method used by the spatial difference pathway.

All signals mentioned above are three-dimensional quantities, including spatial two-dimensional quantities x and y and a temporal dimension t. The data acquired includes TD(x,y,tₙ), SDₓ(x,y,tₙ), SD_{y}(x,y,tₙ), [symbol] (x,y,tₙ), [symbol] (x,y,tₙ); and I(x,y,tₙ) represents the absolute intensity value of the pixel at the corresponding position at the current time.

Times at which signals are obtained, tₙ,tₙ₋₁,tₙ₋₂, . . . may be obtained through a full-array synchronization mode with a same time interval, full-array synchronization mode with a variable time interval or full-array synchronization mode.

It should be noted that the term “multi-node randomly accessible buffer” means that if the analog electrical signal output from the photoreceptive circuit at the current time is stored in Node 1, may be stored in Node 2 at the next time, and in Node 3 at the subsequent time, enabling random storage.

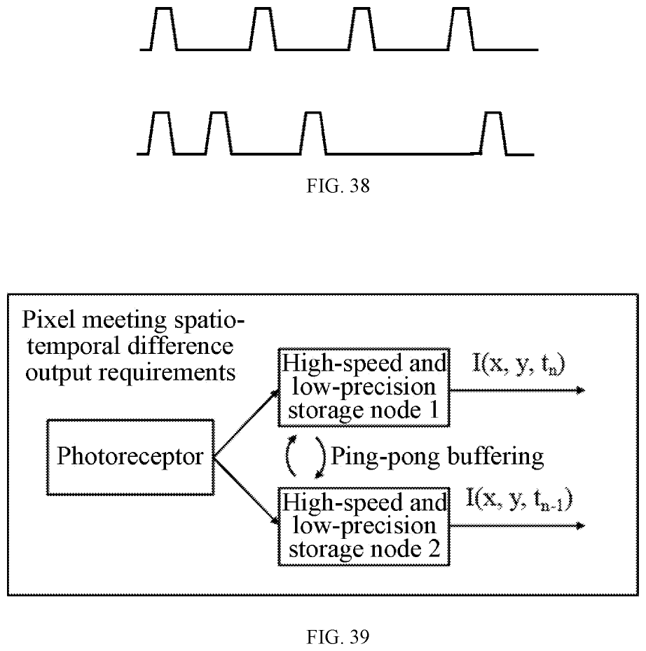

Reference is made to FIG. 38 and FIG. 38 is a schematic diagram of a synchronization trigger signal according to the present application.

In an embodiment, the spatiotemporal difference vision sensor chip further includes a pulse signal generator configured to control exposure of the photoreceptive circuit.

In an embodiment, a single pulse signal generator is provided inside each of the plurality of pixels, and the digital spatiotemporal difference electrical signals of the plurality of pixels are output at a same time interval or at an adaptive and programmable time interval.

In an embodiment, the plurality of the pixels share a single pulse signal generator, and the digital spatiotemporal difference electrical signals of the plurality of pixels are output at a same time interval.

In the present application, synchronous pulses generated by a pulse signal generator provided either outside or inside the pixel are used to trigger the photoreceptive circuit to record visual signals; upon receiving a pulse, the photoreceptive circuit initiates the conversion of optical signals into electrical visual signals, and performs then subsequent readout and quantization.

The synchronization pulses can be generated not only at fixed time intervals but also at adaptive, programmable variable intervals. Such adaptive intervals may adapt the dynamic characteristics of external visual signals; specifically, a higher sampling frequency is used in case that the magnitude of change or the frequency of variation is high, whereas a lower sampling frequency is used for low-frequency signals, reducing both data volume and power consumption.

The present application further supports a configuration where N×N pixels constitutes a single “macroblock” to share an intra-pixel pulse trigger generator, reducing the complexity of the chip design and minimize an occupied area of the chip.

Reference is made to FIG. 39 and FIG. 39 is an internal block diagram of a pixel meeting spatiotemporal difference output requirements according to the present application.

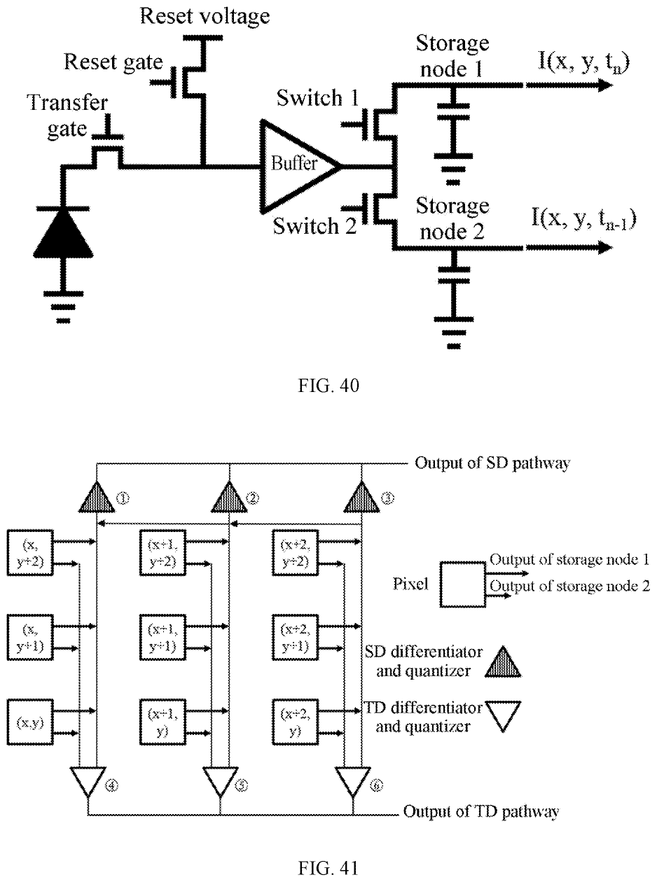

Reference is made to FIG. 40 and FIG. 40 is a circuit diagram of a pixel meeting spatiotemporal difference output requirements according to the present application.

Reference is made to FIG. 41 and FIG. 41 is an architecture diagram of pathways of a spatiotemporal difference vision sensor chip based on a 3D stacking technology according to the present application.

In an embodiment, the spatiotemporal difference and quantization circuit is provided outside the plurality of pixels and uses a column-level signal readout mode.

In this embodiment, electrical digital signals are processed through a column-level readout mode; that is, the differentiator and quantizer operates independently of the individual pixels, and each column shares a single differentiator and quantizer. To satisfy the input requirements of the differentiator, two storage nodes need to be designed inside each pixel for outputting signals at two times. While this embodiment presents a possible specific circuit design; however, there is more than one type of actual circuit principle diagram. The present application primarily emphasizes and seeks to protect the logic of the block diagrams, thereby encompassing all potential circuit design.

Taking a 3×3 pixel array as an example, the readout mode for the temporal and spatial difference signals is as follows:
SD differentiator and quantizer (1) calculates sequentially:

$$S {D}_{x} ( x , y , {t}_{n} ) = {Q}_{S D} ( I ( x , y , {t}_{n} ) - I ( x + 1 , y , {t}_{n} ) )$$

$$S {D}_{y} ( x , y , {t}_{n} ) = {Q}_{S D} ( I ( x , y , {t}_{n} ) - I ( x , y + 1 , {t}_{n} ) )$$

$$S {D}_{x} ( x , y + 1 , {t}_{n} ) = {Q}_{S D} ( I ( x , y + 1 , {t}_{n} ) - I ( x + 1 , y + 1 , {t}_{n} ) )$$

$$S {D}_{y} ( x , y + 1 , {t}_{n} ) = {Q}_{S D} ( I ( x , y + 1 , {t}_{n} ) - I ( x , y + 2 , {t}_{n} ) )$$

SD differentiator and quantizer (2) calculates sequentially:

$$S {D}_{x} ( x + 1 , y , {t}_{n} ) = {Q}_{S D} ( I ( x + 1 , y , {t}_{n} ) - I ( x + 2 , y , {t}_{n} ) )$$

$$S {D}_{y} ( x + 1 , y , {t}_{n} ) = {Q}_{S D} ( I ( x + 1 , y , {t}_{n} ) - I ( x + 1 , y + 1 , {t}_{n} ) )$$

$$S {D}_{x} ( x + 1 , y + 1 , {t}_{n} ) = {Q}_{S D} ( I ( x + 1 , y + 1 , {t}_{n} ) - I ( x + 2 , y + 1 , {t}_{n} ) )$$

$$S {D}_{y} ( x + 1 , y + 1 , {t}_{n} ) = {Q}_{S D} ( I ( x + 1 , y + 1 , {t}_{n} ) - I ( x + 1 , y + 2 , {t}_{n} ) )$$

the SD differentiator and quantizer (3) calculates in the same way.

The TD differentiator and quantizer (4) calculates sequentially:

$$T D ( x , y , {t}_{n} \} = {Q}_{T D} ( I ( x , y , {t}_{n} ) - I ( x , y , {t}_{n - 1} ) )$$

$$TD ( x , y + 1 , {t}_{n} ) = {Q}_{T D} ( I ( x , y + 1 , {t}_{n} ) - I ( x , y + 1 , {t}_{n - 1} ) )$$

$$TD ( x , y + 2 , {t}_{n} \} = {Q}_{T D} ( I ( x , y + 2 , {t}_{n} ) - I ( x , y + 2 , {t}_{n - 1} ) )$$

the TD differentiator and quantizer (5) calculates sequentially:

$$T D ( x + 1 , y , {t}_{n} \} = {Q}_{T D} ( I ( x + 1 , y , {t}_{n} ) - I ( x + 1 , y , {t}_{n - 1} ) )$$

$$TD ( x + 1 , y + 1 , {t}_{n} ) = {Q}_{T D} ( I ( x + 1 , y + 1 , {t}_{n} ) - I ( x + 1 , y + 1 , {t}_{n - 1} ) )$$

$$TD ( x + 1 , y + 2 , {t}_{n} ) = {Q}_{T D} ( I ( x + 1 , y + 2 , {t}_{n} ) - I ( x + 1 , y + 2 , {t}_{n - 1} ) )$$

the TD differentiator and quantizer (6) calculates in the same way.

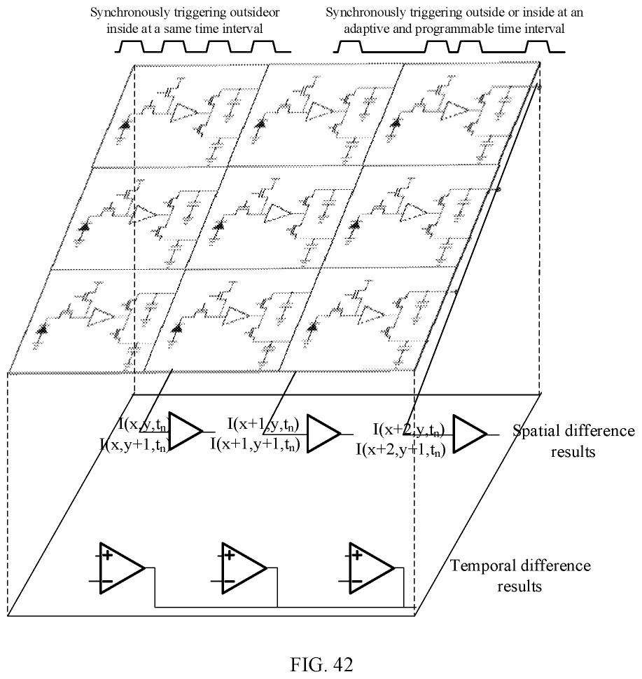

Reference is made to FIG. 42 and FIG. 42 is a diagram of a column-level processing array based on a 3D stacking process according to the present application.

In the present embodiment, based on the 3D stacking technology, the plurality of pixels are provided at the top wafer, and these plurality of pixels share a spatiotemporal differentiator and quantizer. The spatiotemporal differentiator and quantizer is provided at the bottom wafer, enabling column-level signal readout while simultaneously significantly enhancing photosensitivity, processing performance, and energy efficiency of the chip.

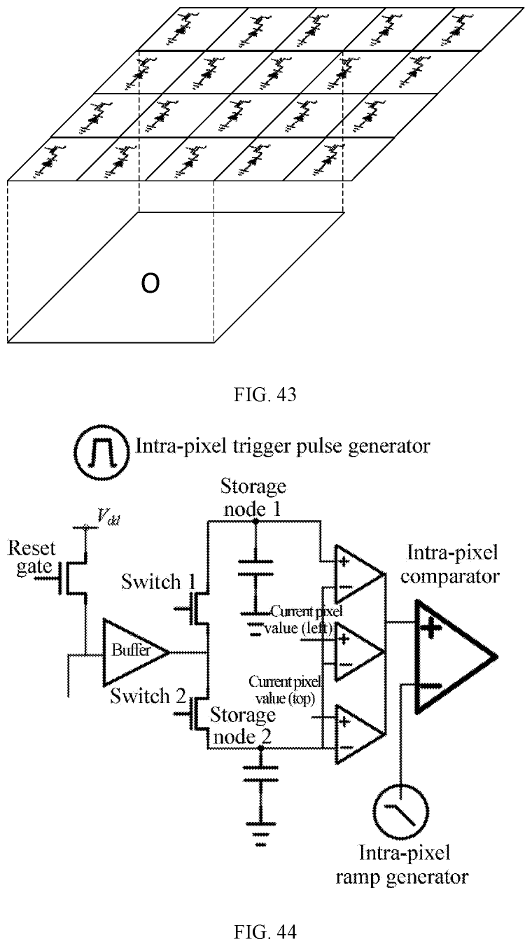

Reference is made to FIG. 43 and FIG. 43 is a diagram of a pixel-level processing array based on a 3D stacking process according to the present application.

Reference is made to FIG. 44 and FIG. 44 is a principle diagram of an “O” portion of a bottom circuit of a pixel-level processing array based on a 3D stacking process according to the present application.

In an embodiment, the spatiotemporal difference and quantization circuit is provided inside each of the plurality of pixels and uses a pixel-level signal readout mode.

In the present embodiment, based on the 3D stacking technology, the plurality of pixels are provided at the top wafer, and a spatiotemporal differentiator and quantizer is provided corresponding to each pixel. The spatiotemporal differentiator and quantizer is provided at the bottom wafer, enabling pixel-level signal readout while simultaneously significantly enhancing photosensitivity, processing performance, and energy efficiency of the chip.

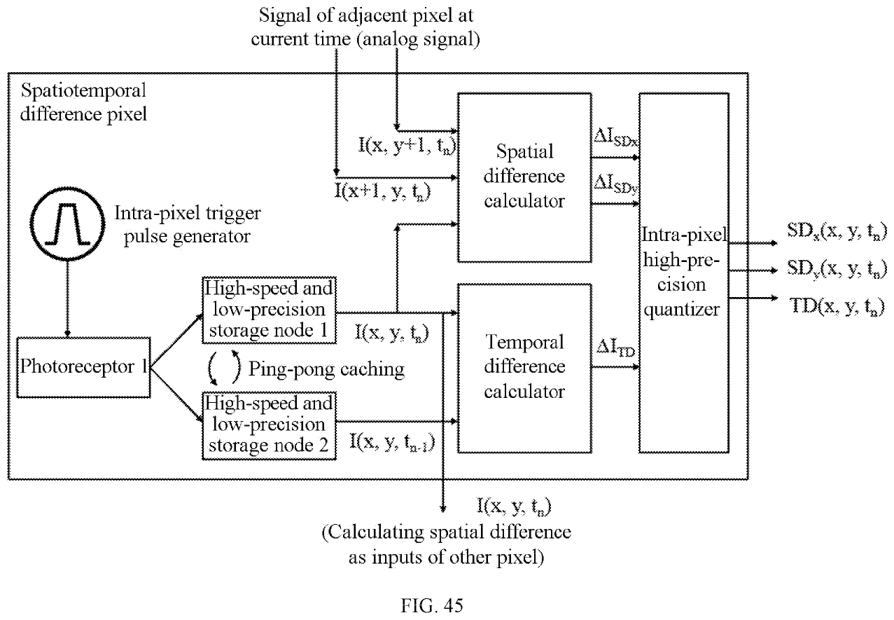

Reference is made to FIG. 45 and FIG. 45 is an architecture diagram of a high-precision, multi-value, time-varying vision sensor chip featuring a full-array asynchronous form according to the present application.

In an embodiment, the digital electrical signals of the plurality of pixels are quantized and read out in a multi-valued mode.

It is noted that traditional dynamic visual sensor (DVS) generates asynchronous information and outputs only timestamps and 1-bit data. Consequently, DVS is susceptible to noise interference, possess low information density, and exhibit a low signal-to-noise ratio (SNR).

Furthermore, the DVS is prone to encountering a case where the generalized sampling theorem is not satisfied and cannot adapt to complex environments since the DVS is inherently limited to outputting only time-varying information in a 1-bit format. The present application further implements an architecture of a high-precision, multi-value, time-varying vision sensor chip featuring a full-array asynchronous form. The present chip implements self-triggering (supporting internal or external triggering, which is programmable and adaptive), signal storage, intra-pixel temporal signal difference, and quantized readout within a single pixel; and each pixel directly outputs high-precision, multi-valued temporal and spatial difference signals (with a precision of ≥1 bit).

The chip supports global asynchronous operation, wherein each pixel is provided with a dedicated control logic. The control logic, referred to as an intra-pixel pulse trigger generator, is capable of adaptively adjusting a time at which calculating temporal difference visual signals is triggered based on a light intensity level perceived by the pixel. Since the trigger time varies for each pixel, this mechanism constitutes the implementation of the global asynchronous operation.

In an embodiment, the spatiotemporal difference vision sensor chip further includes a binning circuit configured to bin the analog electrical signals of a plurality of the pixels to obtain a binned analog electrical signal; the spatiotemporal difference and quantization circuit is further configured to perform spatiotemporal difference and quantization operations on the binned analog electrical signal to obtain a binned digital spatiotemporal difference electrical signal.

The present application may support pixel-space binning to enable spatiotemporal differential sensing characterized by a larger receptive field, a broader spatial scale, and higher sensitivity. By sharing readout switches and storage nodes, the photo-generated electrical signals of the plurality of pixels (i.e., signals produced by photodiodes that exhibit a linear correlation with the incident optical signals) are binned together and spatiotemporal difference calculations are performed on the resulting binned photoelectric signal. The binning process may be implemented using either a summing method or an averaging method. The summing method is

$${I}_{sum} = {Σ}_{i = 1}^{N} {I}_{i} ( {x}_{i} , {y}_{i} , t ) ,$$

and the averaging method is

$${I}_{ave} = \frac{{Σ}_{i = 1}^{N} {I}_{i} ( {x}_{i} , {y}_{i} , t )}{N} .$$

A range of the binned pixel typically includes configurations such as 2×2, 3×3, and so forth.

Subsequently, the spatiotemporal difference is calculated (wherein, in this context, I_{binning} may represent either Iₐᵥₑ or Iₛᵤₘ.

$$T D ( x , y , {t}_{n} ) = Q ( {I}_{b i n n i n g} ( x , y , {t}_{n} ) - {I}_{b i n n i n g} ( x , y , {t}_{n - 1} ) )$$

$$SD\_X ( x , y , {t}_{n} ) = Q ( {I}_{b i n n i n g} ( x , y , {t}_{n} ) - {I}_{b i n n i n g} ( x - 1 , y , {t}_{n} ) )$$

$$SD\_Y ( x , y , {t}_{n} ) = Q ( {I}_{b i n n i n g} ( x , y , {t}_{n} ) - {I}_{b i n n i n g} ( x - 1 , y - 1 , {t}_{n} ) ) .$$

The present application provides a multi-valued and high-precision visual sensor chip architecture capable of obtaining spatiotemporal variations, and introduces various signal recording and conversion methods, significantly enhancing capability of the visual sensor chip to perform high-precision reconstruction of spatiotemporal dynamic information.

According to the present application, there is further provided an imaging system including the aforementioned spatiotemporal difference vision sensor chip based on the 3D stacking technology.

The imaging system of the present application can be referred to above embodiments and is not described in detail herein.

The apparatuses embodiments described above are merely illustrative, where the units described as separate components may or may not be physically separate, and the components displayed as units may or may not be physical units, that is, may be located at the same place or be distributed to a plurality of network units. Some or all of the modules may be selected according to actual needs to achieve the purpose of the solution of the present embodiment. Those skilled in the art can understand and implement the embodiments described above without paying creative labors.

Through the description of the embodiments above, it can be clearly understood for those skilled in the art that the various embodiments can be implemented by means of software and a necessary general hardware platform, and of course, by hardware. Based on such understanding, the solutions of the present application in essence or a part of the solutions that contributes to the prior art, or a part of the solutions, may be embodied in the form of a software product, which may be stored in a storage medium such as ROM/RAM, magnetic discs, optical discs, etc., and includes several instructions to cause a computer device (which may be a personal computer, server, or network device, etc.) to perform the methods described in various embodiments or a part thereof.

Finally, it should be noted that the above embodiments are only used to explain the solutions of the present application, and are not limited thereto; although the present application is described in detail with reference to the foregoing embodiments, it should be understood by those skilled in the art that they can still modify the solutions described in the foregoing embodiments and make equivalent replacements to a part of the features and these modifications and substitutions do not depart from the scope of the solutions of the embodiments of the present application.

What is claimed is:

1. A vision sensor chip, comprising a pixel array composed of pixels;
wherein for each pixel, the pixel is provided with a temporal difference pathway and a spatial difference pathway corresponding to each pixel;
the temporal difference pathway is configured to output a temporal difference value of the pixel;
the spatial difference pathway is configured to output a spatial difference value of the pixel;
the temporal difference value is a result obtained by performing difference and quantization operations on output values of a photoreceptive subunit within the pixel at a current time and at a previous time;
the spatial difference value is a result obtained by performing difference and quantization operations on an output value of the photoreceptive subunit at the current time and an output value of the target photoreceptive subunit at the current time; and
a pixel where the target photoreceptive subunit is located is any pixel among the pixel array other than the pixel.

2. The vision sensor chip of claim 1, wherein the temporal difference pathway comprises the photoreceptive subunit, a differential storage subunit and a temporal differentiator and quantizer provided inside the pixel;
the spatial difference pathway comprises the photoreceptive subunit, the differential storage subunit, and a spatial differentiator and quantizer;
wherein the temporal differentiator and quantizer is provided inside the pixel, or is provided outside the pixel and shared by the pixel and other pixels located in a same column;
the spatial differentiator and quantizer is provided inside the pixel, or is provided outside the pixel and shared by the pixel and other pixels located in a same column;
the photoreceptive subunit is configured to convert intensity of light incident at the pixel at the current time into an electrical signal and output the electrical signal;
the differential storage subunit is configured to write the output value of the photoreceptive subunit at the current time; the differential storage subunit comprising a first storage node and a second storage node, and being configured to write the output value of the photoreceptive subunit at the current time into the second storage node or the first storage node in case that the output value of the photoreceptive subunit at the previous time is stored in the first storage node or the second storage node;
the temporal differentiator and quantizer is configured to calculate and output the temporal difference value; and
the spatial differentiator and quantizer is configured to calculate and output the spatial difference value based on the output value of the target photoreceptive subunit at the current time.

3. The vision sensor chip of claim 1, wherein each pixel of the pixel array is provided with one trigger pulse generator; or
all pixels in the pixel array are collectively connected to one trigger pulse generator; or
the pixel array is partitioned into a plurality of sub-regions and all pixels in each sub-region are collectively connected to one trigger pulse generator;
wherein the trigger pulse generator is configured to generate a trigger signal at a fixed time interval, or at adaptive, programmable, and variable intervals to control a start exposure time and an exposure duration of a corresponding photoreceptive subunit.

4. The vision sensor chip of claim 1, wherein pixels connected to a same trigger pulse generator perform synchronous exposure, and pixels connected to different trigger pulse generators perform either synchronous or asynchronous exposure.

5. The vision sensor chip of claim 1, wherein an exposure mode for each pixel of the pixel array is a global shutter or a rolling shutter.

6. The vision sensor chip of claim 1, wherein the pixel array comprises a plurality of multiplexed pixels being pixels multiplexing temporal difference and spatial difference, and the temporal difference pathway and the spatial difference pathway correspond to the pixels multiplexing temporal difference and spatial difference, respectively.

7. The vision sensor chip of claim 1, wherein an output color type of a pathway corresponding to the pixel is a color value in case that the pixel is provided with a color filter and an output color type of a pathway corresponding to the pixel is a grayscale value in case that the pixel is not provided with a color filter.

8. The vision sensor chip of claim 1, wherein the pixel array comprises a temporal difference pixel corresponding to the temporal difference pathway and a spatial difference pixel corresponding to the spatial difference pathway.

9. The vision sensor chip of claim 1, wherein a binning technology is configured to bin signals of a plurality of pixels within a range of a binned pixel into a single signal and output the single signal;
the temporal difference pathway is configured to perform temporal difference, binning, and quantization operations in a charge domain, an analog domain, or a digital domain on a signal at a position of a current binned pixel at a current time and a signal at the position of the current binned pixel at the previous time to obtain a temporal difference value of the binned pixel; a signal of the binned pixel being a binned signal of the plurality of pixels within the range of the binned pixel; and
the spatial difference pathway is configured to perform spatial difference, binning, and quantization operations in the charge domain, the analog domain, or the digital domain on the signal at the position of the current binned pixel at the current time and the signal at a position of a spatially associated binned pixel at the current time to obtain a spatial difference value of the binned pixel; the spatially associated binned pixel referring to any one or more binned pixels within the pixel array other than the current binned pixel.

10. The vision sensor chip of claim 9, wherein the temporal difference pathway comprises a first temporally differential binner, a first temporal differentiator, and a first temporal quantizer;
the first temporally differential binner is configured to bin electrical signals of the plurality of the pixels to obtain first temporally differential binned signals at the position of the current binned pixel at different times; and
the first temporal differentiator is configured to perform temporal difference operation on a first temporally differential binned signal at the position of the current binned pixel at the current time and a first temporally differential binned signal at the position of the current binned pixel at the previous time to obtain a temporal difference value of the binned pixel; and analog-to-digital signal conversion is performed by the first temporal quantizer during the binning and temporal difference processes.

11. The vision sensor chip of claim 9, wherein the temporal difference pathway comprises a second temporal differentiator, a second temporal quantizer, and a second temporally differential binner;
the second temporal differentiator is configured to determine a temporal difference value of each of the pixels; the temporal difference value of each of the pixels being obtained by performing a temporal difference operation on an electrical signal at a position of a current pixel at a current time and an electrical signal at the position of the current pixel at a previous time; and
the second temporally differential binner is configured to bin temporal difference values of the plurality of pixels to obtain a temporal difference value of the binned pixel; and analog-to-digital signal conversion is performed by the second temporal quantizer during the binning and temporal difference processes.

12. The vision sensor chip of claim 9, wherein the spatial difference pathway comprises a first spatially differential binner, a first spatial differentiator, and a first spatial quantizer;
the first spatially differential binner is configured to bin electrical signals of the plurality of the pixels to obtain first spatially differential binned signals at a position of a current binned pixel at a current time; and
the first spatial differentiator is configured to perform spatial difference operation on a first spatially differential binned signal at the position of the current binned pixel at the current time and a first spatially differential binned signal at a position of a spatially associated binned pixel at the current time to obtain a spatial difference value of the binned pixel; and analog-to-digital signal conversion is performed by the first spatial quantizer during the binning and spatial difference processes.

13. The vision sensor chip of claim 9, wherein the spatial difference pathway comprises a second spatial differentiator, a second spatial quantizer, and a second spatially differential binner;
the second spatial differentiator is configured to determine a spatial difference value of each of the pixels; the spatial difference value of each of the pixels is obtained by performing spatial difference operation on an electrical signal at a position of a current pixel at a current time and an electrical signal at the position of the spatially associated binned pixel at the current time;
the second spatially differential binner is configured to bin spatial difference values of the plurality of pixels to obtain a spatial difference value of the binned pixel; and analog-to-digital signal conversion is performed by the second spatial quantizer during the binning and spatial difference processes.

14. The vision sensor chip of claim 1, wherein the pixel array is provided at a top wafer, the temporal difference pathway and the spatial difference pathway are provided at a same bottom wafer, and the top wafer and the bottom wafer are connected through a 3D stacking mode.

15. The vision sensor chip of claim 1, wherein digital electrical signals of the plurality of pixels are quantized and read out in a multi-valued mode.

16. A vision sensor chip, comprising a pixel array composed of pixels;
wherein for each pixel, the pixel is provided with an intensity pathway, a temporal difference pathway and a spatial difference pathway corresponding to each pixel;
the intensity pathway is configured to output a quantized value of an output value of a photoreceptive subunit inside the pixel at a current time;
the temporal difference pathway is configured to output a temporal difference value of the pixel;
the spatial difference pathway is configured to output a spatial difference value of the pixel;
the temporal difference value is a result obtained by performing difference and quantization operations on output values of a photoreceptive subunit within the pixel at a current time and at a previous time;
the spatial difference value is a result obtained by performing difference and quantization operations on an output value of the photoreceptive subunit at the current time and an output value of the target photoreceptive subunit at the current time; and
a pixel where the target photoreceptive subunit is located is any pixel among the pixel array other than the pixel.

17. The vision sensor chip of claim 16, wherein the intensity pathway comprises the photoreceptive subunit, a first unit and an intensity quantizer provided inside the pixel, or comprises the photoreceptive subunit, a differential storage subunit provided inside the pixel, a frequency-division strober and an intensity quantizer provided inside the pixel;
the temporal difference pathway comprises the photoreceptive subunit, the differential storage subunit, and a temporal differentiator and quantizer;
the spatial difference pathway comprises the photoreceptive subunit, a differential storage subunit, and a spatial differentiator and quantizer;
wherein the temporal differentiator and quantizer is provided inside the pixel, or is provided outside the pixel and shared by the pixel and other pixels located in a same column;
the spatial differentiator and quantizer is provided inside the pixel, or is provided outside the pixel and shared by the pixel and other pixels located in a same column;
the intensity quantizer is provided inside the pixel, or is provided outside the pixel and shared by the pixel and other pixels located in a same column;
the photoreceptive subunit is configured to convert intensity of light incident at the pixel at the current time into an electrical signal and output the electrical signal;
the differential storage subunit is configured to write the output value of the photoreceptive subunit at the current time; the differential storage subunit comprising a first storage node and a second storage node, and being configured to write the output value of the photoreceptive subunit at the current time into the second storage node or the first storage node in case that the output value of the photoreceptive subunit at the previous time is stored in the first storage node or the second storage node;
the first unit is configured to send, in case that the photoreceptive subunit uses the rolling shutter, the output value of the photoreceptive subunit at the current time into an intensity quantizer;
and buffer and output, in case that the photoreceptive subunit does not use the rolling shutter, the current output value of the photoreceptive subunit at the current time;
the frequency-division strober is configured to perform low-frequency sampling on the current output value of the photoreceptive subunit written by the differential storage subunit;
the intensity quantizer is configured to quantize and output an output value of the first unit;
the temporal differentiator and quantizer is configured to calculate and output the temporal difference value; and
the spatial differentiator and quantizer is configured to calculate and output the spatial difference value based on the output value of the target photoreceptive subunit at the current time.

18. The vision sensor chip of claim 16, wherein an output of the intensity pathway is a grayscale value or a color value;
in case that the output of the intensity pathway is the color value, an externally programmable demosaicer is embedded within the temporal differentiator and quantizer or the spatial differentiator and quantizer and is configured to determine output values of all color pathways of the pixel based on color values output from intensity pathways inside the pixel and surrounding pixels before the temporal difference value or the spatial difference value is calculated.

19. The vision sensor chip of claim 16, wherein each pixel of the pixel array is provided with one trigger pulse generator; or
all pixels in the pixel array are collectively connected to one trigger pulse generator; or
the pixel array is partitioned into a plurality of sub-regions and all pixels in each sub-region are collectively connected to one trigger pulse generator;
wherein the trigger pulse generator is configured to generate a trigger signal at a fixed time interval, or at adaptive, programmable, and variable intervals to control a start exposure time and an exposure duration of a corresponding photoreceptive subunit.

20. The vision sensor chip of claim 19, wherein pixels connected to a same trigger pulse generator perform synchronous exposure, and pixels connected to different trigger pulse generators perform either synchronous or asynchronous exposure.

21. The vision sensor chip of claim 19, wherein an exposure mode for each pixel of the pixel array is a global shutter or a rolling shutter.

22. The vision sensor chip of claim 16, wherein the pixel array comprises a plurality of multiplexed pixels and a plurality of single pixels, each of the plurality of multiplexed pixels is a pixel multiplexing two elements selected from intensity, temporal difference and spatial difference; and each of the plurality of single pixels is a pixel with an element different from the two elements of the multiplexed pixels.

23. The vision sensor chip of claim 22, wherein the multiplexed pixels are pixels multiplexing temporal difference and spatial difference, and the single pixels are intensity pixels; the intensity pathway corresponds to the intensity pixels, while the temporal difference pathway and the spatial difference pathway correspond to the pixels multiplexing temporal difference and spatial difference, respectively.

24. The vision sensor chip of claim 16, wherein an output color type of a pathway corresponding to the pixel is a color value in case that the pixel is provided with a color filter and an output color type of a pathway corresponding to the pixel is a grayscale value in case that the pixel is not provided with a color filter.

25. The vision sensor chip of claim 16, wherein the pixel array comprises an intensity pixel corresponding to the intensity pathway, a temporal difference pixel corresponding to the temporal difference pathway and a spatial difference pixel corresponding to the spatial difference pathway.

26. The vision sensor chip of claim 16, wherein a binning technology is configured to bin signals of a plurality of pixels within a range of a binned pixel into a single signal and output the single signal;
the intensity pathway is configured to determine a quantized value of an electrical signal converted from intensity of incident light of a binned pixel;
the temporal difference pathway is configured to perform temporal difference, binning, and quantization operations in a charge domain, an analog domain, or a digital domain on a signal at a position of a current binned pixel at a current time and a signal at the position of the current binned pixel at the previous time to obtain a temporal difference value of the binned pixel; a signal of the binned pixel being a binned signal of the plurality of pixels within the range of the binned pixel; and
the spatial difference pathway is configured to perform spatial difference, binning, and quantization operations in the charge domain, the analog domain, or the digital domain on the signal at the position of the current binned pixel at the current time and the signal at a position of a spatially associated binned pixel at the current time to obtain a spatial difference value of the binned pixel; the spatially associated binned pixel referring to any one or more binned pixels within the pixel array other than the current binned pixel.

27. The vision sensor chip of claim 26, wherein the intensity pathway comprises a first intensity binner and a first intensity quantizer;
the first intensity binner is configured to bin analog signals of the plurality of pixels at the position of the current binned pixel at the current time to obtain a first intensity binned signal; and
the first intensity quantizer is configured to perform analog-to-digital conversion on the first intensity binned signal to obtain a quantized value of an electrical signal converted from intensity of incident light of the binned pixel.

28. The vision sensor chip of claim 26, wherein the intensity pathway comprises a second intensity quantizer and a second intensity binner;
the second intensity quantizer is configured to perform analog-to-digital conversion on analog signals of the plurality of pixels at the position of the current binned pixel at the current time to obtain a quantized value of an electrical signal converted from intensity of incident light at each of the pixels; and
the second intensity binner is configured to bin quantized values of intensities of incident light at the plurality of pixels to obtain a quantized value of the electrical signal converted from intensity of incident light of the binned pixel.

29. The vision sensor chip of claim 26, wherein the temporal difference pathway comprises a first temporally differential binner, a first temporal differentiator, and a first temporal quantizer;
the first temporally differential binner is configured to bin electrical signals of the plurality of the pixels to obtain first temporally differential binned signals at the position of the current binned pixel at different times; and
the first temporal differentiator is configured to perform temporal difference operation on a first temporally differential binned signal at the position of the current binned pixel at the current time and a first temporally differential binned signal at the position of the current binned pixel at the previous time to obtain a temporal difference value of the binned pixel; and analog-to-digital signal conversion is performed by the first temporal quantizer during the binning and temporal difference processes.

30. The vision sensor chip of claim 26, wherein the temporal difference pathway comprises a second temporal differentiator, a second temporal quantizer, and a second temporally differential binner;
the second temporal differentiator is configured to determine a temporal difference value of each of the pixels; the temporal difference value of each of the pixels being obtained by performing a temporal difference operation on an electrical signal at a position of a current pixel at a current time and an electrical signal at the position of the current pixel at a previous time; and
the second temporally differential binner is configured to bin temporal difference values of the plurality of pixels to obtain a temporal difference value of the binned pixel; and analog-to-digital signal conversion is performed by the second temporal quantizer during the binning and temporal difference processes.

31. The vision sensor chip of claim 26, wherein the spatial difference pathway comprises a first spatially differential binner, a first spatial differentiator, and a first spatial quantizer;
the first spatially differential binner is configured to bin electrical signals of the plurality of the pixels to obtain first spatially differential binned signals at a position of a current binned pixel at a current time; and
the first spatial differentiator is configured to perform spatial difference operation on a first spatially differential binned signal at the position of the current binned pixel at the current time and a first spatially differential binned signal at a position of a spatially associated binned pixel at the current time to obtain a spatial difference value of the binned pixel; and analog-to-digital signal conversion is performed by the first spatial quantizer during the binning and spatial difference processes.

32. The vision sensor chip of claim 26, wherein the spatial difference pathway comprises a second spatial differentiator, a second spatial quantizer, and a second spatially differential binner;
the second spatial differentiator is configured to determine a spatial difference value of each of the pixels; the spatial difference value of each of the pixels being obtained by performing spatial difference operation on an electrical signal at a position of a current pixel at a current time and an electrical signal at a position of a spatially associated binned pixel at the current time; and
the second spatially differential binner is configured to bin spatial difference values of the plurality of pixels to obtain a spatial difference value of the binned pixel; and analog-to-digital signal conversion is performed by the second spatial quantizer during the binning and spatial difference processes.

33. The vision sensor chip of claim 16, wherein the pixel array is provided at a top wafer, the temporal difference pathway and the spatial difference pathway are provided at a same bottom wafer, and the top wafer and the bottom wafer are connected through a 3D stacking mode.

34. The vision sensor chip of claim 16, wherein digital electrical signals of the plurality of pixels are quantized and read out in a multi-valued mode.

35. An imaging system, comprising the vision sensor chip of claim 1.

36. An imaging system, comprising the vision sensor chip of claim 16.
